(19) United States
(12) Patent Application Publication
(10) Pub. No.: US 2012/0303376 A1
(43) Pub. Date: Nov. 29, 2012

(54) INFORMATION SELECTING APPARATUS AND METHOD, AND COMPUTER PROGRAM

(75) Inventors: Ichiro SHISHIDO, Kanagawa-ken (JP); Konosuke MATSUSHITA, Kanagawa-ken (JP)

(73) Assignee: JVC KENWOOD CORPORATION, Kanagawa (JP)

(21) Appl. No.: 13/474,784

(22) Filed: May 18, 2012

(30) Foreign Application Priority Data
May 24, 2011 (JP) 2011-115594

(51) Int. Cl. G06Q 30/02

(52) U.S. Cl. 705/1.1

(57) ABSTRACT

Identifiers are of items or categories assigned to the respective items. A price influence degree of each of identifiers associated with a base identifier is calculated from price information of the identifier through the use of a price influence function. A selection index of each of the identifiers associated with the base identifier is calculated according to a rule such that the calculated selection index will increase as a degree of association with the base identifier is greater and the calculated price influence degree is greater. Identifiers each great in calculated selection index are preferentially selected from the identifiers associated with the base identifier. Items or categories having identifiers equal to the selected identifiers may be recommended to a user.

### CROSS-REFERENCE TO RELATED APPLICATIONS

This application claims priority from Japanese patent application number 2011-115594, filed on May 24, 2011, the disclosure of which is hereby incorporated by reference.

### BACKGROUND OF THE INVENTION

1. Field of the Invention

This invention relates to information selecting apparatus, method, and computer program for selecting an item or items recommended to a user which are in a network system providing items.

2. Description of the Related Art

In recent years, as digital technologies and network technologies have progressed, there have been more cases where items such as digital contents and goods are distributed or sold by use of a network. Accordingly, there are increased needs for technologies of selecting an item or items useful to a user from many items, and recommending the selected items to the user. A technology has been disclosed which recommends an item or items to a user through the use of information about evaluation of items by the user and information about use of the items by the user.

Japanese patent application publication number 2011-048667 discloses that a range of the prices of goods recommended to a user is set on the basis of information about the range of the prices of goods purchased by the user in the past, and thereby goods having great possibilities of being purchased by the user are effectively recommended. By recommending, to a user, goods having prices in a range higher than the range of the prices of goods purchased by the user in the past by a prescribed value, an attempt to increase the sales is made. By recommending, to a user, goods having prices in a range lower than the range of the prices of goods purchased by the user in the past by a prescribed value, the user is made to sense that the recommended goods are relatively inexpensive.

It is good for a seller that the sales increase by recommending goods in a high price range. Basically, a user prefers low-price goods provided that other conditions are the same. Thus, recommending high-price goods involves the risk that the recommended goods will be refused by a user and user's will to purchase will be reduced.

Whether a user feels an item to be expensive or inexpensive depends on not only the price of the item but also the characteristics thereof. Accordingly, there occurs a case where a high-price item does not reduce user's will to purchase. If a lot of such items can be in recommendation information, it can be expected that there will be more frequent opportunities of selling high-price items and the sales will be increased without making a user sense that recommended items are relatively expensive.

### SUMMARY OF THE INVENTION

Accordingly, it is an object of this invention to provide an apparatus, a method, and a computer program for making recommendation information which contains a greater number of high-price items and which does not reduce user's will to purchase.

A first aspect of this invention provides an information selecting apparatus comprising a price information store section storing identifiers and price information while making the identifiers and the price information in correspondence, the identifiers being of items or categories assigned to the respective items, the price information being about the items or the categories; an association set store section storing identifiers of items or categories associated with a base identifier which is a base item or a base category together with association degrees representing strengths of association with the base item or the base category; a price influence degree calculating section obtaining price information of each of identifiers associated with the base identifier from the price information store section, and calculating a price influence degree of each of the identifiers associated with the base identifier from the obtained price information through the use of a price influence function monotonically increasing in at least a partial interval and having no monotonically decreasing interval; and an information selecting section calculating a selection index of each of the identifiers associated with the base identifier according to a rule such that the calculated selection index will increase as the association degree is greater and the price influence degree is greater, and preferentially selecting identifiers with great values in calculated selection index from the identifiers associated with the base identifier.

A second aspect of this invention is based on the first aspect thereof, and provides an information selecting apparatus further comprising a use price information calculating section calculating, for each of use subject identifiers of users or terminal devices used by the users, use price information based on price information of items provided to the user relating to the use subject identifier, the price influence degree calculating section varying the price influence function in accordance with use price information of a use subject identifier in calculating the price influence degree, wherein the information selecting section selects identifiers with respect to said use subject identifier by using the calculated price influence degree.

A third aspect of this invention is based on the second aspect thereof, and provides an information selecting apparatus wherein the use price information calculating section calculates a price level value as the use price information, the price level value being a value using a sum value of prices of items provided to a user relating to the use subject identifier or a representative value of the prices of items provided to the user relating to the use subject identifier, and wherein the price influence degree calculating section varies the price influence function in a manner such that a difference between a maximum output value and a minimum output value or a magnification of the maximum output value relative to the minimum output value will increase as the price level value is greater.

A fourth aspect of this invention is based on the second aspect thereof, and provides an information selecting apparatus wherein the use price information calculating section calculates a price level value as the use price information, the price level value being a value using a sum value of prices of items provided to a user relating to the use subject identifier or a representative value of the prices of items provided to the user relating to the use subject identifier, and wherein the price influence degree calculating section varies the price influence function in a manner such that an input value to obtain a prescribed output value will increase as the price level value is greater.

A fifth aspect of this invention is based on the second aspect thereof, and provides an information selecting apparatus wherein the use price information calculating section calculates a price level value as the use price information, the price level value being a value using a sum value of prices of items provided to a user relating to the use subject identifier or a representative value of the prices of items provided to the user relating to the use subject identifier, and wherein the price influence degree calculating section varies the price influence function in a manner such that an output value for a minimum input value will decrease as the price level value is greater.

A sixth aspect of this invention is based on the second aspect thereof, and provides an information selecting apparatus wherein the use price information calculating section calculates a price dispersion value as the use price information, the price dispersion value representing a degree of variations in prices of items provided to a user relating to the use subject identifier or a sum value of the prices of items provided to the user relating to the use subject identifier, and wherein the price influence degree calculating section varies the price influence function in a manner such that a width of the interval of the monotonic increase will increase as the price dispersion value is greater, a manner such that a difference between a maximum output value and a minimum output value will increase as the price dispersion value is greater, a manner such that a magnification of the maximum output value relative to the minimum output value will increase as the price dispersion value is greater, or a manner such that an input value to obtain a prescribed output value will increase as the price dispersion value is greater.

A seventh aspect of this invention is based on the second aspect thereof, and provides an information selecting apparatus wherein the use price information calculating section calculates the use price information on the basis of prices of items provided to a user relating to the use subject identifier and prices of items provided to a user or users relating to a use subject identifier or identifiers different from said use subject identifier.

An eighth aspect of this invention is based on the second aspect thereof, and provides an information selecting apparatus further comprising an item class information store section storing the identifiers of the items or the categories and item classes while making the identifiers and the item classes in correspondence, wherein the use price information calculating section calculates the use price information for each of the item classes with respect to each of the use subject identifiers, and wherein the price influence degree calculating section identifies an item class corresponding to one of the identifiers associated with the base identifier by referring to the item class information store section and varies the price influence function in accordance with use price information calculated for the identified item class with respect to the use subject identifier relating to the base identifier.

A ninth aspect of this invention is based on the first aspect thereof, and provides an information selecting apparatus wherein the price information store section stores identifiers of normal items, identifiers of composite items, price information of the normal items, and price information of the composite items in correspondence, and each of the composite items consists of plural normal items, and wherein the information selecting section calculates the selection index so that the calculated selection index will be greater for a composite item than a normal item even in cases where the composite item and the normal item are equal in degree of association with the base identifier and price information of the composite item and price information of the normal item are equal.

A tenth aspect of this invention is based on the first aspect thereof, and provides an information selecting apparatus wherein the information selecting section selects, from the identifiers associated with the base identifier, identifiers corresponding to selection indexes equal to or greater than a first prescribed value or selects, from the identifiers associated with the base identifier, a number of identifiers in order of selection index from the greatest, said number being equal to or less than a second prescribed value, and outputs information about the selected identifiers in addition to information about the order of selection index.

An eleventh aspect of this invention is based on the first aspect thereof, and provides an information selecting apparatus further comprising a use history store section storing use histories which record, for each of use subject identifiers of users or terminal devices used by the users, identifiers of items provided to a user relating to the use subject identifier or categories of the items provided to the user relating to the use subject identifier; and an association degree calculating section calculating a degree of association between the base identifier and each of other identifiers on the basis of the use histories, extracting identifiers corresponding to calculated association degrees equal to or greater than a third prescribed value or a number of identifiers in order of calculated association degree from the greatest, said number being equal to or less than a fourth prescribed value, and labeling the extracted identifiers as the identifiers associated with the base identifier.

A twelfth aspect of this invention is based on the first aspect thereof, and provides an information selecting apparatus further comprising an attribute information store section storing attribute information in which the identifiers of the items or the categories and attributes of the items or the categories are made in correspondence; and an association degree calculating section calculating a degree of association between the base identifier and each of other identifiers on the basis of the attribute information, extracting identifiers corresponding to calculated association degrees equal to or greater than a fifth prescribed value or a number of identifiers in order of calculated association degree from the greatest, said number being equal to or less than a sixth prescribed value, and labeling the extracted identifiers as the identifiers associated with the base identifier.

A thirteenth aspect of this invention is based on the first aspect thereof, and provides an information selecting apparatus further comprising a receiving section receiving control data concerning a price condition from an external, wherein the price influence degree calculating section varies the price influence function in response to the received control data.

A fourteenth aspect of this invention is based on the first aspect thereof, and provides an information selecting apparatus wherein the price influence degree calculating section varies the price influence function in response to the price information of the base identifier.

A fifteenth aspect of this invention provides a method of selecting information which comprises the steps of storing identifiers and price information while making the identifiers and the price information in correspondence, the identifiers being of items or categories assigned to the respective items, the price information being about the items or the categories; storing identifiers of items or categories associated with a base identifier which is a base item or a base category together with association degrees representing strengths of association with the base item or the base category; obtaining price information of each of identifiers associated with the base identifier from the price information store section, and calculating a price influence degree of each of the identifiers associated with the base identifier from the obtained price information through the use of a price influence function monotonically increasing in at least a partial interval and having no monotonically decreasing interval; and calculating a selection index of each of the identifiers associated with the base identifier according to a rule such that the calculated selection index will increase as the association degree is greater and the price influence degree is greater, and preferentially selecting identifiers with great values in calculated selection index from the identifiers associated with the base identifier.

A sixteenth aspect of this invention is based on the fifteenth aspect thereof, and provides a method further comprising the step of calculating, for each of use subject identifiers of users or terminal devices used by the users, use price information based on price information of items provided to the user relating to the use subject identifier, the price influence degree calculating step varying the price influence function in accordance with use price information of a use subject identifier in calculating the price influence degree, wherein the information selecting step selects identifiers with respect to said use subject identifier by using the calculated price influence degree.

A seventeenth aspect of this invention provides a computer program for enabling a computer to function as a price information store section storing identifiers and price information while making the identifiers and the price information in correspondence, the identifiers being of items or categories assigned to the respective items, the price information being about the items or the categories; an association set store section storing identifiers of items or categories associated with a base identifier which is a base item or a base category together with association degrees representing strengths of association with the base item or the base category; a price influence degree calculating section obtaining price information of each of identifiers associated with the base identifier from the price information store section, and calculating a price influence degree of each of the identifiers associated with the base identifier from the obtained price information through the use of a price influence function monotonically increasing in at least a partial interval and having no monotonically decreasing interval; and an information selecting section calculating a selection index of each of the identifiers associated with the base identifier according to a rule such that the calculated selection index will increase as the association degree is greater and the price influence degree is greater, and preferentially selecting identifiers with great values in calculated selection index from the identifiers associated with the base identifier.

An eighteenth aspect of this invention is based on the seventeenth aspect thereof, and provides a computer program which enables the computer to further function as a use price information calculating section calculating, for each of use subject identifiers of users or terminal devices used by the users, use price information based on price information of items provided to the user relating to the use subject identifier, the price influence degree calculating section varying the price influence function in accordance with use price information of a use subject identifier in calculating the price influence degree, wherein the information selecting section selects identifiers with respect to said use subject identifier by using the calculated price influence degree.

This invention has the following advantage. It is possible to make recommendation information which contains a comparatively great number of high-price items and which does not reduce user's will to purchase.

### BRIEF DESCRIPTION OF THE DRAWINGS

FIG. 1 is a block diagram showing the structure of the whole of a network system according to a first embodiment of this invention.

FIG. 2 is a block diagram showing another structure of the network system in the first embodiment of this invention.

FIG. 3 is a block diagram showing the structure of an information selecting device in the network system of FIG. 1 or FIG. 2.

FIG. 4(a) is a diagram of an example of an item information table stored in an item attribute store section in FIG. 3.

FIG. 4(b) is a diagram of an example of a category information table stored in the item attribute store section in FIG. 3.

FIG. 5(a) is a diagram of a first example of an item use history table stored in a use history store section in FIG. 3.

FIG. 5(b) is a diagram of a second example of the item use history table stored in the use history store section in FIG. 3.

FIG. 5(c) is a diagram of a third example of the item use history table stored in the use history store section in FIG. 3.

FIG. 5(d) is a diagram of an example of a category use history table stored in the use history store section in FIG. 3.

FIG. 6(a) is a diagram of an example of an item price information table stored in a price information store section in FIG. 3.

FIG. 6(b) is a diagram of an example of a category price information table stored in the price information store section in FIG. 3.

FIG. 7(a) is a diagram of an example of an item-item recommendation information table stored in a recommendation information store section in FIG. 3.

FIG. 7(b) is a diagram of an example of an item-category recommendation information table stored in the recommendation information store section in FIG. 3.

FIG. 7(c) is a diagram of an example of a category-item recommendation information table stored in the recommendation information store section in FIG. 3.

FIG. 7(d) is a diagram of an example of a category-category recommendation information table stored in the recommendation information store section in FIG. 3.

FIG. 8 is a diagram of an example of an association degree table stored in an association set store section in FIG. 3.

FIG. 9 is a block diagram showing the structure of an item providing server in the network system of FIG. 1 or FIG. 2.

FIG. 10 is a block diagram showing the structure of a terminal device in the network system of FIG. 1 or FIG. 2.

FIG. 11 is a flowchart of operation of the whole of the network system in FIG. 1 or FIG. 2.

FIG. 12(a) is a diagram of a first example of an indicated picture based on response data from the item providing server.

FIG. 12(b) is a diagram of a second example of the indicated picture based on the response data from the item providing server.

FIG. 13(a) is a diagram of an example of a picture indicating a recommendation list.

FIG. 13(b) is a diagram of an example of a picture indicating another recommendation list.

FIG. 14 is a flowchart of operation of the information selecting device for making recommendation information.

FIG. 15 is a flowchart of an association set making process corresponding to an item-item recommendation form and an item-category recommendation form.

FIG. 16 is a flowchart of an association set making process corresponding to a category-item recommendation form and a category-category recommendation form.

FIG. 17 is a flowchart of another association set making process corresponding to the item-item recommendation form and the item-category recommendation form.

FIG. 18 is a flowchart of another association set making process corresponding to the category-item recommendation form and the category-category recommendation form.

FIG. 19(a) is a diagram showing the characteristic of a first example of a price influence function F(x) using price information as an input X and using a price influence degree as an output Y.

FIG. 19(b) is a diagram showing the characteristic of a second example of the price influence function F(x).

FIG. 19(c) is a diagram showing the characteristic of a third example of the price influence function F(x).

FIG. 20(a) is a diagram showing the characteristic of a fourth example of the price influence function F(x).

FIG. 20(b) is a diagram showing the characteristic of a fifth example of the price influence function F(x).

FIG. 20(c) is a diagram showing the characteristic of a sixth example of the price influence function F(x).

FIG. 21(a) is a diagram of the contents of first data stored in the association set store section in FIG. 3.

FIG. 21(b) is a diagram of the contents of price information stored in the price information store section in FIG. 3.

FIG. 21(c) is a diagram of the contents of second data stored in the association set store section in FIG. 3.

FIG. 22 is a block diagram showing the structure of an information selecting device in a network system according to a second embodiment of this invention.

FIG. 23(a) is a diagram of a first example of an indicated picture based on response data from an item providing server in the network system of the second embodiment of this invention.

FIG. 23(b) is a diagram of a second example of the indicated picture based on the response data from the item providing server in the network system of the second embodiment of this invention.

FIG. 24(a) is a diagram of a first GUI (Graphical User Interface) picture which allows a user to input data for adjusting price influence degrees.

FIG. 24(b) is a diagram of a second GUI (Graphical User Interface) picture which allows a user to input data for adjusting price influence degrees.

FIG. 24(c) is a diagram of a third GUI (Graphical User Interface) picture which allows a user to input data for adjusting price influence degrees.

FIG. 25(a) is a diagram showing variations in the characteristic of a first example of the price influence function F(X).

FIG. 25(b) is a diagram showing variations in the characteristic of a second example of the price influence function F(X).

FIG. 25(c) is a diagram showing variations in the characteristic of a third example of the price influence function F(X).

FIG. 26(a) is a diagram of a first recommendation list picture with an indication of a designated price influence degree.

FIG. 26(b) is a diagram of a second recommendation list picture with an indication of a designated price influence degree.

FIG. 27 is a block diagram showing the structure of an information selecting device in a network system according to a third second embodiment of this invention.

FIG. 28(a) is a diagram of an example of a use price information table stored in a use price information store section in FIG. 27.

FIG. 28(b) is a diagram of an example of another use price information table stored in the use price information store section in FIG. 27.

FIG. 29(a) is a diagram of the characteristic of a model function for the price influence function F(X).

FIGS. 29(b) and 29(c) are diagrams showing variations in the characteristic of a first example of the price influence function F(X) derived from the model function in FIG. 29(a).

FIG. 30 is a diagram showing variations in the characteristic of a second example of the price influence function F(X) derived from another model function.

FIG. 31(a) is a diagram of an example of a composite item information table stored in an item attribute store section in a network system according to a fourth embodiment of this invention.

FIG. 31(b) is a diagram of an example of an inter-item correspondence table stored in the item attribute store section in the network system of the fourth embodiment of this invention.

FIG. 32 is a diagram of an example of a composite item price information table stored in a price information store section in the network system of the fourth embodiment of this invention.

### DETAILED DESCRIPTION OF THE INVENTION

### First Embodiment

A network system in a first embodiment of this invention will be described with reference to drawings.

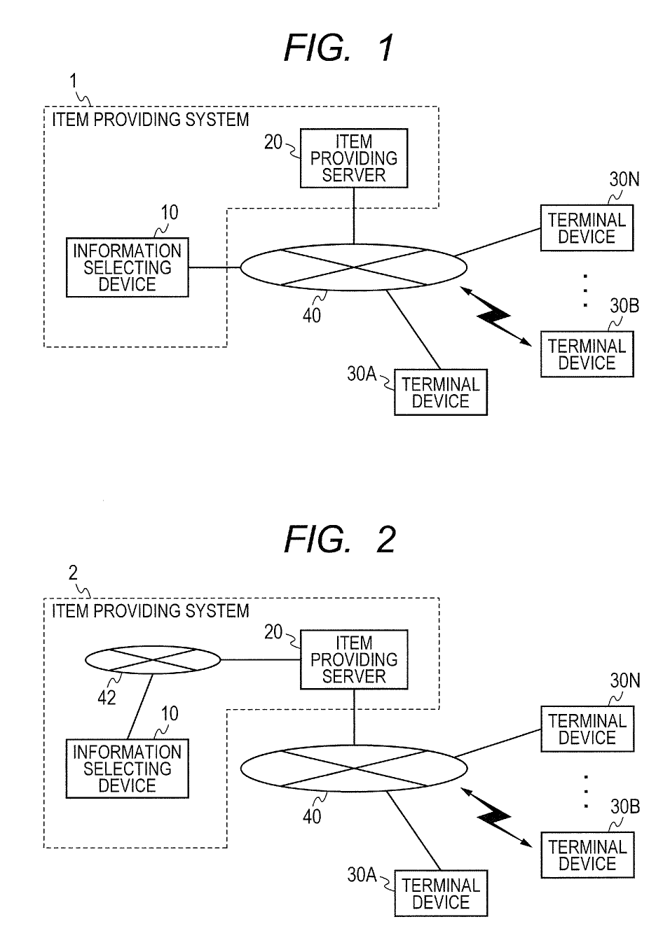

FIG. 1 is a block diagram showing the structure of the whole of the network system in the first embodiment of this invention. As shown in FIG. 1, the network system is designed so that an information selecting device 10, an item providing server 20, and one or more terminal devices 30 (30A, 30B, . . . 30N in the drawing) are connected by a network 40. The information selecting device 10 operates to select an information piece or pieces about, for example, an item or items. The information selecting device 10 and the item providing server 20 form an item providing system 1 offering service such as item providing service for a user using a terminal device 30. The network 40 may be a wide area network such as the Internet. The connection between the terminal devices 30 and the network 40 is on a wired basis or a wireless basis.

FIG. 2 shows a network system which may replace that in FIG. 1. In the network system of FIG. 2, an item providing server 20 and one or more terminal devices 30 (30A, 30B, . . . 30N) are connected to a network 40, and an information selecting device 10 is connected to the item providing server 20 via a network 42 separate from the network 40. In this case, the information selecting device 10 and the item providing server 20 that are connected by the network 42 form an item providing system 2. The network 42 may be, for example, a LAN (local area network). In view of maintaining security, it is preferable to limit a direct access to the information selecting device 10 from each of the terminal devices 30.

The network system may have one of various structures not limited to those in FIGS. 1 and 2. For example, the information selecting device 10 and the item providing server 20 may be formed by a common device. Each of the information selecting device 10 and the item providing server 20 may be formed by a plurality of devices.

A description will be made below as to an exemplary case where the network system has the structure in FIG. 1.

The items are objects to be provided to a user. The items are various goods, services (for example, network services), or digital contents of, for example, text, audio, music, or video. The items may be information pieces about persons, real estates, or financial goods or commodities. The items may be material or immaterial. One or more categories being information for classifying the items are assigned to each of the items. Each item may be without a category or categories.

FIG. 3 is a block diagram showing the structure of the information selecting device 10. As shown in FIG. 3, the information selecting device 10 includes an item attribute store section 101, a use history store section 102, a price information store section 103, an association degree calculating section 104, an association set store section 105, a price influence degree calculating section 106, an information selecting section 107, a recommendation information store section 108, a sending and receiving section 109, and a control section 110. An indication device (a display device) 120 and an input device 130 are connected to the information selecting device 10. The indication device 120 serves to indicate necessary information to a manager about the information selecting device 10. The input device 130 is, for example, a keyboard or a mouse operated by the manager.

The information selecting device 10 may be formed by a general computer including a CPU, a RAM, a ROM, an HDD (hard disk drive), a network interface, and others. The general computer executes a program of implementing processes as mentioned later, and thereby functions as the information selecting device 10.

The information selecting device 10 may be formed by a plurality of computers. For example, to disperse load, computers are assigned to one processing block of the information selecting device 10 and thereby dispersedly processing is implemented. According to another example, one processing block of the information selecting device 10 is implemented by one computer while another processing block thereof is implemented by another computer, so that dispersedly processing can be carried out.

The item attribute store section 101 stores an item information table 101A and a category information table 101B. Information relating to items is recorded in the item information table 101A. Information relating to categories is recorded in the category information table 101B.

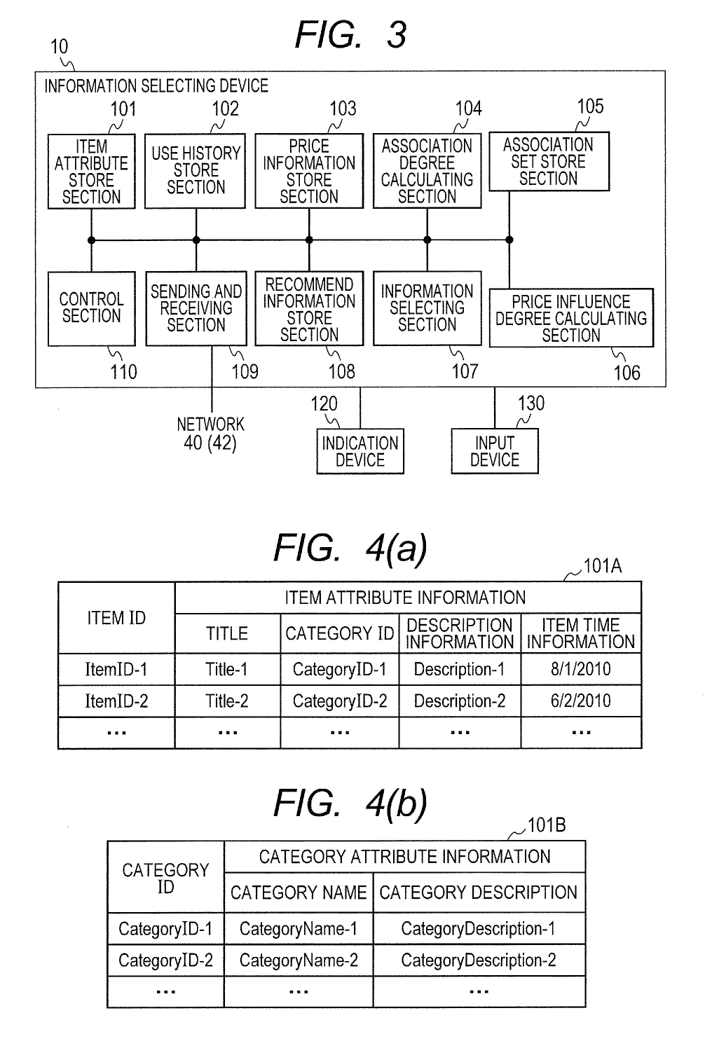

FIG. 4(a) shows an example of the item information table 101A. As shown in FIG. 4(a), the item information table 101A makes item identifiers (item IDs) and item attribute information in correspondence. The item attribute information is composed of “titles”, “category identifiers (category IDs)”, “description information”, “item time information”, and others of items.

FIG. 4(b) shows an example of the category information table 101B. As shown in FIG. 4(b), the category information table 101B makes category identifiers (category IDs) and category attribute information in correspondence. The category attribute information is composed of “category names”, “category descriptions”, and others. The item information in the item information table 101A and the category information in the category information table 101B can be related with each other via the category IDs in the two tables.

Here, the categories are information in which items are classified according to prescribed criteria. One or more categories are set for one item. The categories can be, for example, “creators” of the items. The creators are makers, directors, producers, writers, composers, lyric writers, players, performers, and others.

In the case where the items are music contents, the categories can be genre information such as “rock”, “jazz”, “classic”, and “folk”. In the case where the items are movies, the categories can be genre information such as “SF”, “action”, “comedy”, “animation”, and “suspense”. The categories can be classification information using the countries or regions of the creators such as “Japan”, “USA”, and “UK”. The categories may be information representing the atmospheres or moods of the items such as “healing”, “exciting”, and “dramatic”.

The description information in the item attribute information represents, for example, the outlines or summaries, and descriptions of background of the production of the items. The item time information represents times at which the items were made. The item time information may use times at which the items were registered in the item providing server 20 or times at which providing the items were started. In the present embodiment of this invention, the dates such as “Jan. 1, 2010” are used as the unit for the times. Another unit may be used. For example, the dates and times such as those up to second unit such as “Jan. 1, 2010, 10-hour 15-minute 20-second” may be used. The dates and times such as those up to millisecond unit may be used. The dates up to month unit such as “January in 2010” may be used. The dates up to quarter unit such as “2010, 1Q” may be used. The dates in year unit such as “2010” may be used. The dates in unit greater than year unit such as “during 10 years from 2000” may be used.

In the item attribute information in the item information table 101A, a plurality of attribute items of a same type may be present for one item. For example, five categories being “creator-1”, “creator-2”, “creator-3”, “genre-1”, and “genre-2” may be set for one item. The item attribute information and the category attribute information cited here are examples, and they are not limited to the above. For example, the item attribute information may use attribute items such as “size” and “color”.

The information selecting device 10 may be designed to be able to obtain item information and category information from an item store section 202 (mentioned later) of the item providing server 20 if necessary. In this case, the item attribute store section 101 can be omitted.

The sending and receiving section 109 performs a process of sending and receiving data to and from the item providing server 20 or a terminal device 30 via the network 40 (further via the network 42 in the structure in FIG. 2).

The control section 110 performs various processes for implementing the control of the whole of the information selecting device 10. For example, as will be mentioned later, the control section 110 receives a use request from the item providing server 20 or a terminal device 30 via the sending and receiving section 109, and stores a user ID (user identifier) and an item ID contained in the use request into the use history store section 102 as use history information while making them in correspondence.

The use history store section 102 stores an item use history table 102A in which item use history information for a user is recorded. The item use is implemented by the fact that the item providing server 20 provides an item in response to a use request from a user. In the present embodiment of this invention, a user is identified by using a user ID. In the case where cellular phones are used as the terminal devices 30, terminal identifies (terminal IDs) which can be obtained at the time of connection with the terminal devices 30 may be used instead of user IDs. In the case where personal computers are used as the terminal devices 30, web browsers and the terminal devices 30 may be identified by using technologies such as Cookie in place of user IDs. User IDs and terminal IDs will also be referred to as use subject IDs hereafter.

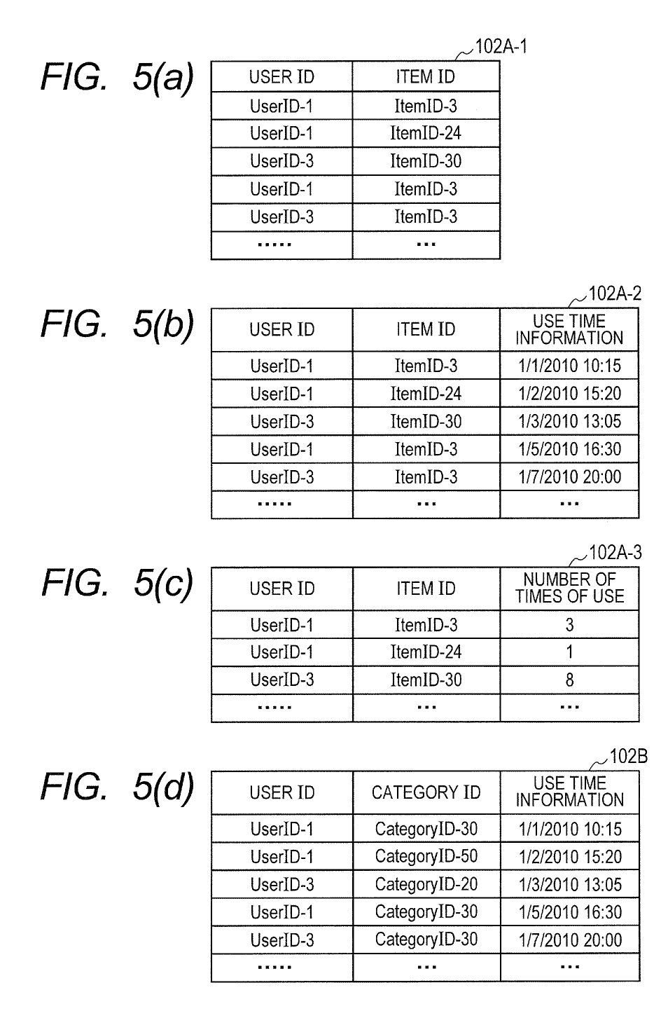

The item use history table 102A may use various store forms as a store form for use history information. For example, as shown in FIG. 5(a), in an item user history table 102A-1, user IDs (use subject IDs) and item IDs are stored while being related with each other. One use request corresponds to one row in the table of FIG. 5(a). With reference to FIG. 5(a), both the first row and the fourth row in the table indicate a combination of “UserID-1” and “ItemID-3”. As understood from this fact, table row data is added and stored for each use request even in the case where a same combination of a user ID and an item ID recurs. Thus, the number of times of use of each item identified by an item ID, and the number of users who have used each item, that is, the number of user IDs related to each item can be easily counted by another processing section. In the case where one use request contains a plurality of item IDs, different table rows are assigned to these item IDs respectively and they are stored.

FIG. 5(b) shows an item use history table 102A-2 concerning a store form designed so that user IDs, item IDs, and use time information are stored while being related with each other. Similar to the form of FIG. 5(a), one use request corresponds to one row in the table of FIG. 5(b). In the case where a use request contains use time information, the use time information is extracted therefrom before being stored as use time information. In the case where a use request does not contain use time information, the time of the reception of the use request by the information selecting device 10 is detected by using a clock in the control section 110 and the detected time is stored as use time information.

The format of the use time information uses day and time units up to second unit such as “Jan. 1, 2010, 10-hour 15-minute 20-second”. The dates and times such as those up to millisecond unit may be used. The dates such as those up to day unit may be used. The dates up to month unit may be used. The dates in year unit may be used. Other day and time formats may be used. The value of evaluation of an item by a user (the numerical value indicative of the degree at which the user likes or dislikes the item: for example, like=3, neither like nor dislike=2, dislike=1) may be contained in a use request, and the user ID, the item ID, the use time information, and the evaluation value may be stored in the item use history table 102A-2 while being related with each other.

FIG. 5(c) shows an item use history table 102A-3 concerning a store form designed so that use time information is omitted, and user IDs, item IDs, and the numbers of times of use are related with each other. In the case where the association degree calculating section 104 does not utilize use time information as mentioned later, the necessary memory capacity can be reduced by using the item use history table 102A-3. In the case where a use request contains the value of evaluation of an item by a user, a user ID, an item ID, the number of times of use, and the newest evaluation value may be stored in the item use history table 102A-3 while being related with each other.

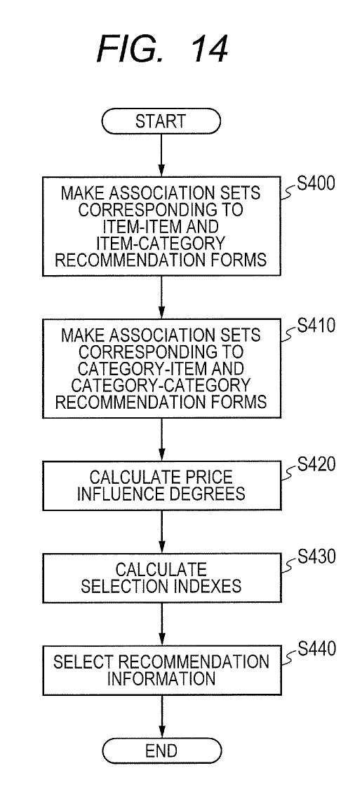

The use history store section 102 may store a category use history table 102B in addition to the item use history table 102A. The category use history table 102B has a structure such as shown in FIG. 5(d). The category use history table 102B relates user IDs and category IDs with each other. In this case, regarding a use request from a user, the control section 110 refers to the item information table 101A in the item attribute store section 101 and thereby identifies a category ID corresponding to an item ID in the use request, and stores the identified category ID into the category use history table 102B. As will be mentioned later, in the case where the category use history table 102B is stored at the time (a step S410 in FIG. 14) of making an association set corresponding to a category-category recommendation form and a category-item recommendation form, the processing can efficiently be done.

The price information store section 103 stores an item price information table 103A and a category price information table 103B. Price information of items is recorded in the item price information table 103A. Price information of categories is recorded in the category price information table 103B.

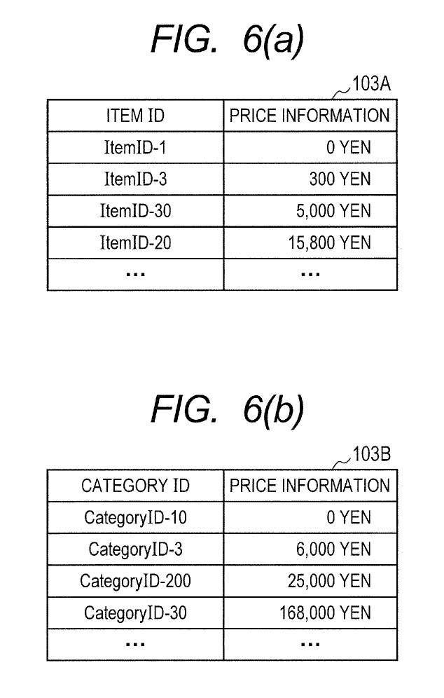

FIG. 6(a) shows an example of the item price information table 103A. As shown in FIG. 6(a), the item price information table 103A stores item IDs and price information while relating them with each other. The price information of an item represents a price of the item. The price may be on a base different from actual currency such as yen, dollar, or Euro. For example, the price may be the value of peculiar point service which can be used only in the item providing service in the present embodiment of this invention. As understood from the example in FIG. 6(a), a free item corresponding to price information of “0 yen” may be present. As shown in FIG. 6(a), item IDs may be stored in order of increasing price. Item IDs may be stored in order of decreasing price. Item IDs may be stored in order of them.

FIG. 6(b) shows an example of the category price information table 103B. As shown in FIG. 6(b), the category price information table 103B stores category IDs and price information while relating them with each other. The price information of a category may denote the representative value or the total value of the prices of items belonging to the category. The representative value is, for example, the mean, the median, the mode, the quartile, the maximum, or the minimum of the prices of the items belonging to the category.

In the category price information table 103B in FIG. 6(b), the total value of the prices of the items belonging to a category is labeled as price information of the category. As understood from FIG. 6(b), a category with a price of “0 yen” (all items in the category are free) may be present. Category IDs are stored in order of increasing price. Category IDs may be stored in order of decreasing price. Price information may be recorded in the item attribute store section 101 so as to omit the price information store section 103.

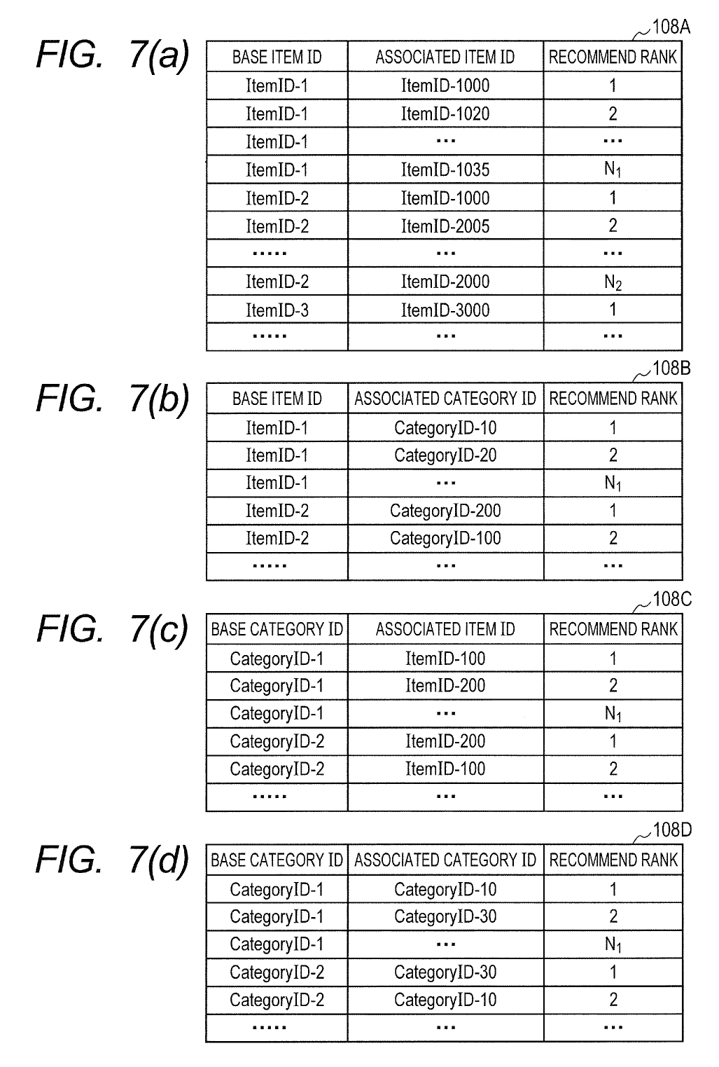

The recommendation information store section 108 stores a recommendation information table in which recommendation information selected by the information selecting section 107 is recorded. The recommendation information makes a certain ID (referred to as a base ID hereafter) and one or more other IDs (referred to as associated IDs hereafter) associated therewith in correspondence. An item ID or a category ID can be used as a base ID. An item ID or a category ID can be used as an associated ID. Specifically, the recommendation information store section 108 stores recommendation information tables of four types such as shown in FIGS. 7(a)-7(b) as combinations of base IDs and associated IDs.

FIG. 7(a) shows an example of an item-item recommendation information table 108A in which base IDs are item IDs (base item IDs) and associated IDs are item IDs (associated item IDs), and they are stored while recommendation ranks are made to correspond thereto. A base item ID corresponds to an item ID contained in a recommendation request (mentioned later) being a trigger for outputting recommendation information. An associated item ID is the ID of an item associated with the base item. Such a type of recommendation from item to item will be referred to as an item-item recommendation form hereafter.

In the item-item recommendation information table 108A, one or more associated item IDs are made in correspondence with one base item ID. N1 associated item IDs corresponding to a base item ID “ItemID-1” are stored, and N2 associated item IDs corresponding to a base item ID “ItemID-2” are stored. Here, the numbers N1 and N2 are equal or different. Thus, the number of associated item IDs per base item ID may be the same for all base item IDs, or may vary from base item ID to base item ID.

The recommendation ranks indicate ranks concerning recommendation of associated items for each base item ID, and the priority rank is higher and more preferential presentation to a user is done as the number representative of a recommendation rank decreases here. In FIG. 7(a), for each base ID (base item ID), associated IDs (associated item IDs) are stored in order of lowering recommendation rank. In the case where associated IDs are stored while being made in correspondence with recommendation ranks, they may be stored in an appropriate order.

Recommendation degrees may be stored in place of recommendation ranks. The recommendation degrees are such that the priority rank is higher and more preferential presentation to a user is done as the numerical value representative of a recommendation degree increases. Recommendation ranks may be omitted from each recommendation information table. In this case, in each recommendation information table, it is good that associated IDs for each base ID are stored in order of lowering or raising recommendation rank. Thus, the order in which associated IDs are stored (stored positions) may be designed to have information about recommendation ranks of associated IDs for a certain base ID. Alternatively, recorded associated IDs may be handled as being with the same rank, or recommendation ranks may be given at random to them when each recommendation information table is read out.

FIG. 7(b) shows an example of an item-category recommendation information table 108B in which base IDs are item IDs (base item IDs) and associated IDs are category IDs (associated category IDs), and they are stored while recommendation ranks are made to correspond thereto. This can be used in, for example, the case where creators (item creators) highly related to an item contained in a use request are provided as recommendation information.

Here, highly related creators may contain not only “creator-1” being a creator of a certain item (item A) but also indirectly highly related creators such as “creator-2” alike in style to “creator-1”, “creator-3” overlapping “creator-1” in user layer, and “creator-4” in the case where users frequently using the item A frequently use items of “creator-4”. The relation (association) between an item and a category can use not only direct relation such that the item belongs to the category but also indirect relation such as mentioned above.

The recommendation ranks have meanings similar to those in the item-item recommendation information table 108A. The recommendation ranks may be omitted from the item-category recommendation information table 108B. Such a type of recommendation from item to category will be referred to as an item-category recommendation form hereafter.

FIG. 7(c) shows an example of a category-item recommendation information table 108C in which base IDs are category IDs (base category IDs) and associated IDs are item IDs (associated item IDs), and they are stored while recommendation ranks are made to correspond thereto. This can be used in, for example, the case where items highly related to a creator contained in a use request are provided as recommendation information. As above mentioned, an indirect relation can be used as a relation between a category and an item. The recommendation ranks have meanings similar to those in the item-item recommendation information table 108A. The recommendation ranks may be omitted from the category-item recommendation information table 108C. Such a type of recommendation from category to item will be referred to as a category-item recommendation form hereafter.

FIG. 7(d) shows an example of a category-category recommendation information table 108D in which base IDs are category IDs (base category IDs) and associated IDs are category IDs (associated category IDs) also, and they are stored while recommendation ranks are made to correspond thereto. This can be used in, for example, the case where creators highly related to a creator contained in a use request are provided as recommendation information. Here, highly related creators are, for example, “creator-2” alike in style to “creator-1”, “creator-3” overlapping “creator-1” in user layer, and “creator-4” in the case where many users use not only items of “creator-1” but also items of “creator-4”. The recommendation ranks have meanings similar to those in the item-item recommendation information table 108A. The recommendation ranks may be omitted from the category-category recommendation information table 108D. Such a type of recommendation from category to category will be referred to as a category-category recommendation form hereafter.

In the following, a description will be given while the case where all the item-item recommendation form, the item-category recommendation form, the category-item recommendation form, and the category-category recommendation form are implemented is taken as an example. Only one or more of these forms may be implemented. In this case, it is good that only a recommendation information table or tables necessary for one or more of the forms are stored.

The association degree calculating section 104 calculates association degrees of four types corresponding to the item-item recommendation form, the item-category recommendation form, the category-item recommendation form, and the category-category recommendation form by using data stored in the item attribute store section 101 or/and the use history store section 102, and thereby makes an association set before storing it into the association set store section 105.

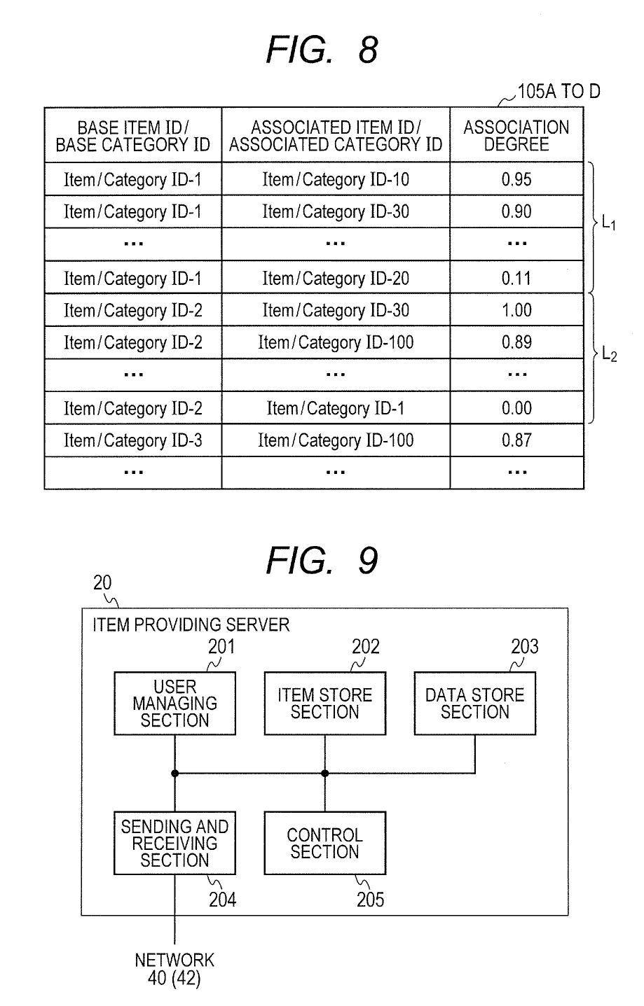

The association set store section 105 stores association degree tables 105A-105D in which base IDs, associated IDs, and association degrees are made in correspondence with each other. FIG. 8 shows an example of one of the association degree tables 105A-105D. A set of IDs associated with a base ID stored in the association degree tables 105A-105D is referred to as an association set for the base ID.

As mentioned above, a base ID is an item ID or a category ID, and an associated ID is an item ID or a category ID. There are store forms of four types in accordance with patterns of combination of a base ID and an associated ID, and they are shown in FIG. 8 after being simplified.

In the following, the degrees of association between base item IDs and associated item IDs are recorded in the association degree table 105A, and the degrees of association between base item IDs and associated category IDs are recorded in the association degree table 105B. Furthermore, the degrees of association between base category IDs and associated item IDs are recorded in the association degree table 105C, and the degrees of association between base category IDs and associated category IDs are recorded in the association degree table 105D.

In the example of FIG. 8, L1 associated IDs corresponding to a base ID “Item/Category ID-1”, and L2 associated IDs corresponding to a base ID “Item/Category ID-2” are stored. Here, the numbers L1 and L2 are equal or different. Thus, the number of associated IDs per base ID may be the same for all base IDs, or may vary from base ID to base ID. All combinations of base IDs and associated IDs having the degrees of association calculated by the association degree calculating section 104 may be stored. Alternatively, only associated IDs having high degrees of association with a certain base ID may be stored as an association set. The memory capacity of the association set store section 105 can be reduced by storing only one or ones of IDs. As shown in FIG. 8, associated IDs may be stored in order of decreasing association degree for each base ID.

Basically, the number of elements (the number of associated IDs) of an association set is plural. There may be an association set having only one element. It is necessary that the number of elements of at least one association set is equal to 2 or more. Association sets and association degrees calculated by a device different from the information selecting device 10 may be recorded in the association degree tables 105A-105D. In this case, the association degree calculating section 104 can be omitted.

The price influence degree calculating section 106 calculates a price influence degree being a degree of influence of price information (price) of each associated ID in an association set on a recommendation result while referring to the price information store section 103 and the association set store section 105.

The information selecting section 107 calculates selection indexes from the price influence degrees calculated by the price influence degree calculating section 106 and the association degrees in the association degree tables 105A-105D of the association set store section 105, and selects associated IDs for each base ID in the association degree tables 105A-105D on the basis of the calculated selection indexes and stores a combination of the selected associated IDs and the base ID into the recommendation information tables 108A-108D of the recommendation information store section 108 as recommendation information.

FIG. 9 is a block diagram showing the structure of the item providing server 20. The item providing server 20 is a device for providing an item and information about the item in response to a request from a terminal device 30. As shown in FIG. 9, the item providing server 20 includes a user managing section 201, an item store section 202, a data store section 203, a sending and receiving section 204, and a control section 205.

The item providing server 20 may be formed by a general computer including a CPU, a RAM, a ROM, an HDD (hard disk drive), a network interface, and others. The general computer executes a program for performing below-mentioned processes, and thereby serves as the item providing server 20. The program is stored in, for example, the ROM, the HDD, or the RAM.

The sending and receiving section 204 performs a process of sending and receiving data to and from the information selecting section 10 and the terminal devices 30 via the network 40 (further via the network 42 in the case of the structure in FIG. 2). The control section 205 performs the control of the whole of the item providing server 20.

The user managing section 201 stores user IDs for identifying users who use the terminal devices 30 or use subject IDs being terminal IDs for identifying the terminal devices 30 used by the users.

The item providing server 20 performs an entrance process and others, for example, before starting a user to use an item, and thereby stores a use subject ID for which the entrance process has been completed into the user managing section 201. If necessary, user attribute information such as a login name, a password, a name, a birthday, a contact address, and a method of settlement of an account may be stored in the user managing section 201 in such a manner as to be in correspondence with a use subject ID.

The item store section 202 stores information about items provided by the item providing server 20. The item store section 202 stores information similar to that in the item attribute store section 101 in the information selecting device 10. In the case where items are digital contents or others different from tangible goods and can be distributed to the terminal devices 30 via the network 40, item IDs and item bodies (data of digital contents or others) are stored in addition to data in the item attribute store section 101 while being made in correspondence.

The control section 205 may send data from the item store section 202 to the information selecting device 10 via the sending and receiving section 204 and store the data into the item attribute store section 101 each time information in the item store section 202 is updated or on the basis of a prescribed schedule. Conversely, the control section 205 may receive data from the item attribute store section 101 in the information selecting device 10 via the sending and receiving section 204 before storing the received data into the item store section 202. The information selecting device 10 may be designed to send a message of requesting item attribute information to the item providing server 20. In this case, the control section 205 reads out data accorded with the message from the item store section 202, and sends the read-out data to the information selecting device 10 via the sending and receiving section 204.

The data store section 203 can store data of various types. For example, data in the recommendation information store section 108 of the information selecting device 10 can be copied before the copied data is stored into the data store section 203. In this case, since a terminal device 30 can receive recommendation information from the item providing server 20, the processing load on the information selecting device 10 can be reduced. Data similar to that in the use history store section 102 of the information selecting device 10 may be stored in the data store section 203. In this case, the information selecting device 10 may be designed to be able to refer to data in the data store section 203 so that the use history store section 102 can be omitted from the information selecting device 10.

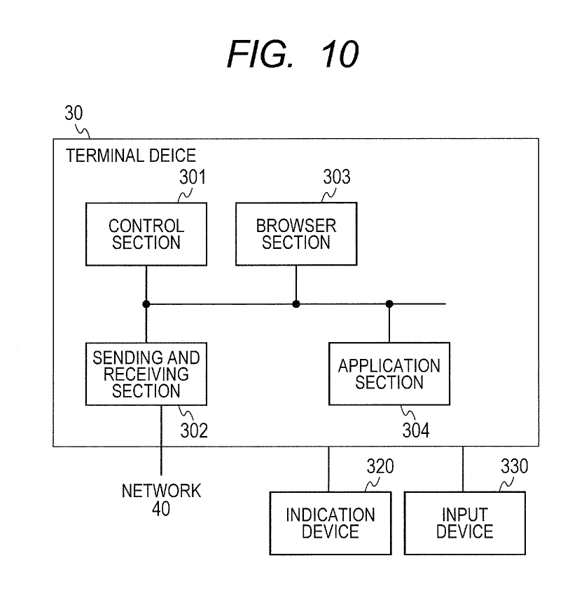

FIG. 10 is a block diagram showing the structure of a terminal device 30. The terminal device 30 is used by a user. As shown in FIG. 10, the terminal device 30 includes a control section 301, a sending and receiving section 302, a browser section 303, and an application section 304. The terminal device 30 may use a general computer including a CPU, a RAM, a ROM, an HDD (hard disk drive), a network interface, and others. The general computer executes a program for performing below-mentioned processes, and thereby serves as the terminal device 30. The terminal device 30 can be formed by, for example, a portable terminal device or a cellular phone having a Web browser function and others.

A program such as a Web browser for accessing a Web page and indicating information about it is installed on the terminal device 30, and thereby the browser section 303 is implemented. The application section 304 is implemented by executing various application programs.

In the case where a computer is used as a terminal device 30, an indication device 320 such as a display and an input device 330 for accepting operation commands from a user are connected thereto. The input device 330 is, for example, a keyboard, a mouse, a track ball, or a remote control device. In the case where a cellular phone or a portable terminal device is used as a terminal device 30, an indication device and an input device are contained therein. In the following, a description will be given of the case where the indication device 320 and the input device 330 are connected to the terminal device 30.

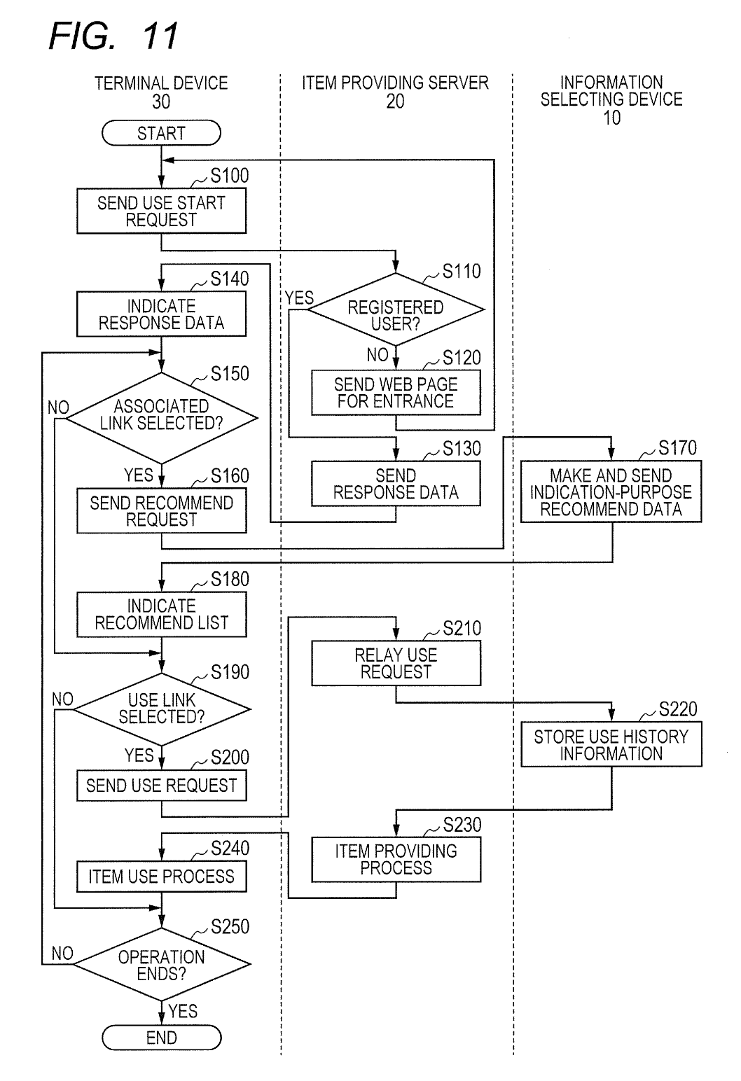

Basic operation of the whole of the network system will be explained with reference to FIG. 11. First, in a step S100, a terminal device 30 accesses a URL (Uniform Resource Locator) of the item providing server 20 through the use of the browser section 303. Specifically, the terminal device 30 sends the item providing server 20 a request (a use start request) for a prescribed Web page provided by the item providing server 20.

In the case where a personal computer or another device is used as a terminal device 30, a user using the terminal device 30 is forced to input a preset login name (a preset user ID) and a present password, and the inputted login name and the inputted password are sent while being contained in a use start request. In the case where data that can identify a user using the terminal device 30 is sent while being contained in a use start request, sending a login name and a password can be omitted. In the case where a login name and a password are sent while being contained in a use start request, it is good that HTML (Hyper Text Markup Language) data or others for accepting an inputted login name and an inputted password are sent from the item providing server 20 to the terminal device 30 before the step S100.

In the case where a cellular phone or another device is used as a terminal device 30, it is good that a terminal ID peculiar to the terminal device 30 is sent while being contained in a use start request. In this case, sending a login name and a password can be omitted.

In a step S110 following the step S100, the control section 205 in the item providing server 20 receives the use start request from the terminal device 30 via the sending and receiving section 204, and determines whether or not it is a user who has already been registered by referring to the user managing section 201. Specifically, in the case where a use start request contains a login name and a password, the control section 205 collates them with login names and passwords in the user managing section 201. In the case where a use start request contains a terminal ID, the control section 205 determines whether or not the terminal ID is equal to one of use subject IDs in the user managing section 201. If it is a user who has already been registered (Yes), an advance to a step S140 is made. If not (No), an advance to a step S120 is made.

In the step S120, the control section 205 in the item providing server 20 sends the terminal device 30 a Web page (HTML) for performing an entrance process via the sending and receiving section 204. An entrance process is performed as mentioned below although not shown in FIG. 11. A user using the terminal device 30 performs operation of, for example, inputting necessary information into the Web page for the entrance process through the use of the input device 330, and sending the inputted information to the item providing server 20. The item providing server 20 stores the incoming information into the user managing section 201. After the entrance process has been completed, the terminal device 30 can send a use start request again.

In the step S130, the control section 205 in the item providing server 20 makes response data of a Web page corresponding to the use start request while referring to the item store section 202. The response data contains information for introducing at least one item or/and at least one category. The control section 205 sends the response data to the terminal device 30 via the sending and receiving section 204. The response data is composed of HTML data, image data, video data, audio data, and other data. In some cases, the response data is divided into plural portions, and the portions are sequentially sent to the terminal device 30. The response data contains information for indicating items (or categories) associated with a certain item (or category) to the user, and information for making the user use an item. Information for identifying the user or the terminal device 30 may be added to the response data by using a technology such as Cookie.

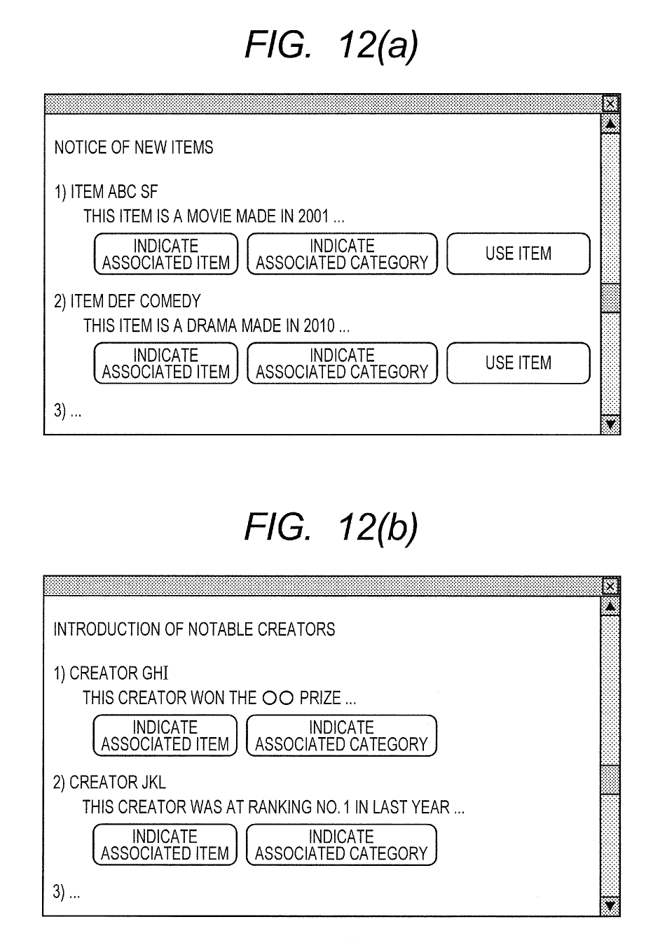

In a step S140 following the step S130, the terminal device 30 receives the response data from the item providing server 20, and indicates its information on the indication device 320. FIG. 12(a) shows a first example of an indicated picture which occurs in the case where information for introducing items is contained in the response data. The first example is of an indicated picture for introducing newly arrived items which have recently started to be provided by the item providing server 20. Information for introducing items such as shown in FIG. 12(a) can be sent to the terminal device 30 at various timings.

In FIG. 12(a), “item ABC” is the title of the first item, and “SF” is the category name of the first item. An indication of “this item is a movie made in 2001 . . . ” is description information of the first item. For each item, a link (associated item link) and a button for indicating item information associated with the item, a link (associated category link) and a button for indicating category information associated with the item, and a link (use link) and a button for using the item are indicated. Similar indications are made for the second and later items. The associated item link and the associated category link will also be referred to as the associated links hereafter.

Each associated item link in FIG. 12(a) is made in correspondence with the “associated item indication” button, and is a link for indicating recommendation information in the above-mentioned item-item recommendation form. Each associated category link in FIG. 12(a) is made in correspondence with the “associated category indication” button, and is a link for indicating recommendation information in the above-mentioned item-category recommendation form. The user can select an associated link or a use link by operation such as click using the input device 330. The response data contains the item IDs of the respective items or the category IDs of the respective categories although they are not indicated in the indicated picture, and the item ID of an item becoming an object to be selected is made in correspondence with each of the associated item links and the use links. The category ID of a category becoming an object to be selected is made in correspondence with each of the associated category links.

FIG. 12(b) shows a second example of an indicated picture which occurs in the case where information for introducing categories is contained in the response data. The second example is of an indicated picture for introducing notable creators selected by the manager of the item providing server 20.

In FIG. 12(b), “creator GHI” is the name (category name) of the first creator, and an indication of “this creator won the ∘∘ prize . . . ” is description information of the first creator. For each category (creator), a link (associated item link) and a button for indicating item information associated with the category, and a link (associated category link) and a button for indicating category information associated with the category are indicated.

Each associated item link in FIG. 12(b) is made in correspondence with the “associated item indication” button, and is a link for indicating recommendation information in the category-item recommendation form. Each associated category link in FIG. 12(b) is made in correspondence with the “associated category indication” button, and is a link for indicating recommendation information in the category-category recommendation form. Similar indications are made for the second and later categories.

With reference back to FIG. 11, the step S140 is followed by a step S150. In the step S150, the terminal device 30 determines whether or not an associated link (an associated item link or an associated category link) has been selected by the user via the input device 330. If an associated link is designated (Yes), an advance to a step S160 is made. If it is not designated (No), an advance to a step S190 is made.

In the step S160, the terminal device 30 sends a request (recommendation request) to the URL corresponding to the associated link. Regarding the embodiment of this invention, a description is given of the case where the associated link corresponds to a prescribed URL of the information selecting device 10. The associated link may be made in correspondence with a prescribed URL of the item providing server 20. The recommendation request contains the ID (request base ID) of the category or the item selected in the indicated picture of FIG. 12(a) or FIG. 12(b), and link type information representing whether it is an associated item link or an associated category link.

A request base ID in an indicated picture for introducing items such as that in FIG. 12(a) is an item ID. A request base ID in an indicated picture for introducing categories such as that in FIG. 12(b) is a category ID. The recommendation request may be designed to further contain information about the number of pieces of necessary recommendation information (the number of recommended items or categories), and the use subject ID (the terminal ID or the user ID of the user using the terminal device 30). The use subject ID corresponds to a use subject identifier relating to the base identifier in appended claims (claims indicated later).

In a step S170 following the step S160, the control section 110 of the information selecting device 10 receives the recommendation request via the sending and receiving section 109, and makes indication-purpose recommendation data corresponding to the request base ID contained therein before sending the recommendation data to the terminal device 30. At this time, the control section 110 performs at least one of processes of four types corresponding to an item-item recommendation form, an item-category recommendation form, a category-item recommendation form, and a category-category recommendation form mentioned below.

Regarding the item-item recommendation form, the control section 110 identifies a base item ID equal to the request base ID while referring to the item-item recommendation information table 108A in the recommendation information store section 108 that is shown in FIG. 7(a). The control section 110 reads out associated item IDs and recommendation ranks corresponding to the identified base item ID from the item-item recommendation information table 108A. Furthermore, the control section 110 reads out item attribute information corresponding to the associated item IDs from the item information table 101A in the item attribute store section 101. Then, the control section 110 makes indication-purpose recommendation data in which the associated item IDs, the recommendation ranks, and the item attribute information are in correspondence.

For example, in the case where the request base ID is “ItemID-1” in the example of FIG. 7(a), the associated item IDs “ItemID-1000”, “ItemID-1020”, . . . and “ItemID-1035” corresponding to the base item ID equal to the request base ID, and the recommendation ranks “1”, “2”, . . . and “N1” are read out. All the associated item IDs corresponding to the identified base item ID are read out. Alternatively, only a prescribed number of associated item IDs may be read out in order of lowering recommendation rank. In the case where the number of pieces of the recommendation information is designated in the recommendation request, only the designated number of associated item IDs are read out in order of lowering recommendation rank.

At this time, the following process may be done. The use subject ID is added to the recommendation request in the sending of the recommendation request (the step S160). An item ID used by the use subject ID in the past (an after-use item ID) is identified while the item use history table 102A in the use history store section 102 is referred to. The after-use item ID is read out, and it is excluded from objects. By doing such a process, highly accurate recommendation is made possible in item providing service having a character such that a user purchases a same item only once. For example, it suits to service such that digital contents purchased once can be repetitively used (played back).

The control section 110 reads out item attribute information and category attribute information corresponding to the read-out associated item IDs while referring to the item attribute store section 101. The item attribute information is, for example, titles and description information. The category attribute information is, for example, category names. The control section 110 combines the associated item IDs, the item attribute information, the category attribute information, and the recommendation ranks to make indication-purpose recommendation data.

Regarding the item-category recommendation form, the control section 110 identifies a base item ID equal to the request base ID while referring to the item-category recommendation information table 108B in the recommendation information store section 108 that is shown in FIG. 7(b). The control section 110 reads out associated category IDs and recommendation ranks corresponding to the identified base item ID from the item-category recommendation information table 108B. At this time, all the associated category IDs corresponding to the identified base item ID are read out. Alternatively, only a prescribed number of associated category IDs may be read out in order of lowering recommendation rank. Furthermore, the control section 110 reads out category attribute information corresponding to the associated category IDs from the item attribute store section 101. Then, the control section 110 makes indication-purpose recommendation data in which the associated category IDs, the recommendation ranks, and the category attribute information are in correspondence.

At this time, the indication-purpose recommendation data may be made under the condition where every category used by the user in the past is excluded. Specifically, the use subject ID is added to the recommendation request in the sending of the recommendation request (the step S160). A category ID concerning an item used by the use subject ID in the past (an after-use category ID) is identified while the item information table 101A and the item use history table 102A in the use history store section 102 are referred to. In the case where the category use history table 102B is used, the category use history table 102B is referred to.

When the associated category IDs are read out from the item-category recommendation information table 108B, a process of excluding the after-use category ID is performed. By performing such a process, highly accurate recommendation is made possible in item providing service having a character such that a user purchases a same item only once.

Regarding the category-item recommendation form, the control section 110 identifies a base category ID equal to the request base ID while referring to the category-item recommendation information table 108C in the recommendation information store section 108 that is shown in FIG. 7(c). The control section 110 reads out associated item IDs and recommendation ranks corresponding to the identified base category ID from the category-item recommendation information table 108C. At this time, all the associated item IDs corresponding to the identified base category ID are read out. Alternatively, only a prescribed number of associated item IDs may be read out in order of lowering recommendation rank.

Furthermore, the control section 110 reads out item attribute information corresponding to the associated item IDs from the item information table 101A. Then, the control section 110 makes indication-purpose recommendation data in which the associated item IDs, the recommendation ranks, and the item attribute information are in correspondence. At this time, the indication-purpose recommendation data may be made under the condition where every item used by the user in the past is excluded.

Regarding the category-category recommendation form, the control section 110 identifies a base category ID equal to the request base ID while referring to the category-category recommendation information table 108D in the recommendation information store section 108 that is shown in FIG. 7(d). The control section 110 reads out associated category IDs and recommendation ranks corresponding to the identified base category ID from the category-category recommendation information table 108D. At this time, all the associated category IDs corresponding to the identified base category ID are read out. Alternatively, only a prescribed number of associated category IDs may be read out in order of lowering recommendation rank. Furthermore, the control section 110 reads out category attribute information (category name and category description information) corresponding to the associated category IDs from the category information table 101B. Then, the control section 110 makes indication-purpose recommendation data in which the associated category IDs, the recommendation ranks, and the category attribute information are in correspondence. At this time, the indication-purpose recommendation data may be made under the condition where every category used by the user in the past is excluded.

The request base ID and attribute information such as a title corresponding to the request base ID may be contained in the indication-purpose recommendation data in the above-mentioned item-item recommendation form, item-category recommendation form, category-item recommendation form, and category-category recommendation form.

In the case where the recommendation information table corresponding to the type of the recommendation request does not store recommendation ranks while the order in which associated IDs are stored has information about recommendation ranks, it is good to decide the order of associated IDs in the indication-purpose recommendation data in accordance with the store order. For example, it is good that the first associated item ID in the store order is located at the first place in the indication-purpose recommendation data, and the second associated item ID in the store order is located at the second place in the indication-purpose recommendation data. Random recommendation ranks may be made and given when indication-purpose recommendation data is made. The order of associated IDs in indication-purpose recommendation data may be decided at random.

With reference back to FIG. 11, in a step S180 following the step S170, the terminal device 30 receives the indication-purpose recommendation data from the information selecting device 10 and indicates the received data on the indication device 320 as a recommendation list.

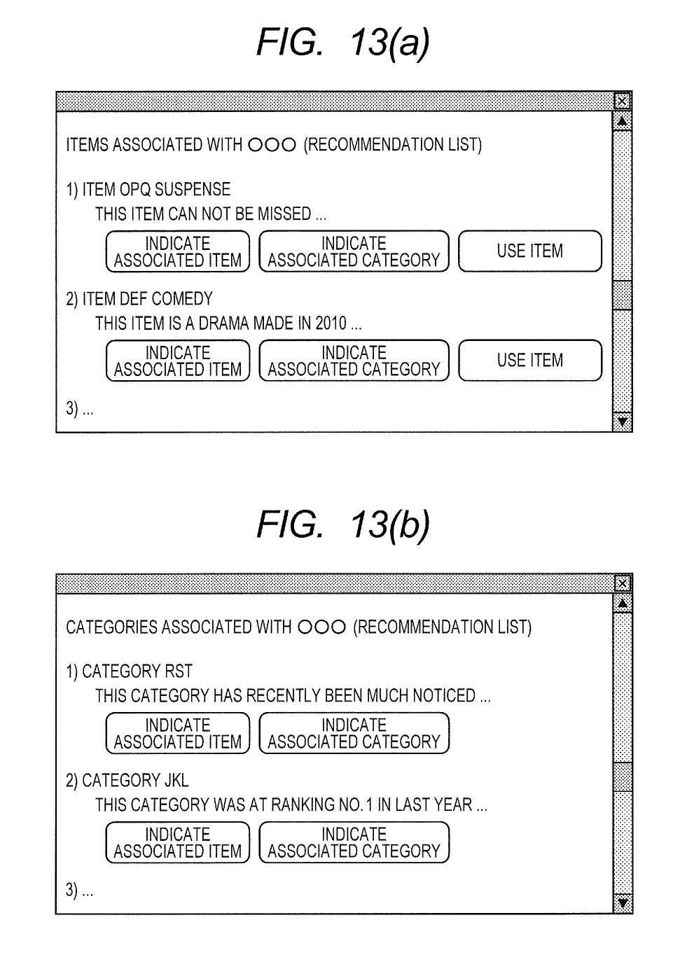

FIG. 13(a) is an example of a picture indicating a recommendation list of associated items for 000 which occurs in the case where a process corresponding to the item-item recommendation form and the category-item recommendation form is performed. Letters corresponding to the request base ID are indicated in “∘∘∘”, and the title of an item is indicated there in the case of the item-item recommendation form and a category name is indicated there in the case of the category-item recommendation form.

The order in which items are indicated is decided according to recommendation rank, and an item with a higher recommendation rank is indicated at a place more easily noticed by the user. For example, in the case where pieces of information of respective items are arranged along an up-down direction as shown in FIG. 13(a), it is good that an item with a higher recommendation rank is indicated at an upper place in the indicated picture. In the case where pieces of information of respective items are arranged along a left-right direction, it is good that an item with a higher recommendation rank is indicated at a more left place in the indicated picture. In FIG. 13(a), “item OPQ” is the title of the first item (the item with the first recommendation rank) and “suspense” is a category name for the first item, and an indication of “this item can not be missed . . . ” is description information about the first item. Similar to the indication example of FIG. 12(a), an associated item indication button made in correspondence with an associated item link, an associated category indication button made in correspondence with an associated category link, and an item use button made in correspondence with a use link are indicated for each item. Similar indications are made for the second and later items.

FIG. 13(b) is an example of a picture indicating a recommendation list of associated categories for xxx which occurs in the case where a process corresponding to the item-category recommendation form and the category-category recommendation form is performed in the process of making and sending indication-purpose recommendation data (the step S170).

The order in which items are indicated is decided according to recommendation rank. Letters corresponding to the request base ID are indicated in “xxx”, and the title of an item is indicated there in the case of the item-category recommendation form and a category name is indicated there in the case of the category-category recommendation form. In FIG. 13(b), “category RST” is the category name of the first category (the category with the first recommendation rank), and an indication of “this category has recently been much noticed . . . ” is description information about the first category. Similar to the indication example of FIG. 12(b), an associated item indication button made in correspondence with an associated item link, and an associated category indication button made in correspondence with an associated category link are indicated for each category. Similar indications are made for the second and later categories.

With reference back to FIG. 11, in the step S190 following the step S150 or the step S180, the terminal device 30 determines whether or not a use link has been selected by the user via the input device 330. The use link can typically be a request to purchase an item, and various requests may be contained therein. The various requests are, for example, a request to play back the item, a request to preview the item, a request to indicate detailed information about the item, and a request to register evaluation information (an evaluation value) with respect to the item. If a use link has been selected (Yes), an advance to a step S200 is made. If not (No), an advance to a step S250 is made.

In the step S200, the terminal device 30 sends a request (use request) to the URL corresponding to the use link. Regarding the present embodiment of this invention, a description will be given of the case where the use link corresponds to a prescribed URL of the item providing server 20. The terminal device 30 may send the use request directly to the information selecting device 10 in addition to the item providing server 20.

Each use link is given the item ID or IDs of an item or items being objects to be selected. The use request contains the item ID of the item selected by the user (the use base item ID), and the use subject ID for identifying the user or the terminal device 30. In the case where a user uses plural items at a time, the item IDs of plural items may be contained in one use request or plural use requests may be sent.

In a step S210 following the step S200, the sending and receiving section 204 in the item providing server 20 receives the use request from the terminal device 30 and sends it to the information selecting device 10 to relay the use request. At this time, the control section 205 in the item providing server 20 may extract information about the use base item ID and the use subject ID from the use request, and store the extracted information into the data store section 203 as use information.

In a step S220 subsequent to the step S210, the control section 110 in the information selecting device 10 receives the use request via the sending and receiving section 109, and stores it into the use history store section 102 as use history information. Then, the control section 110 sends a message to the item providing server 20 via the sending and receiving section 109. The message represents that storing the use history information has been completed.

In a step S230 following the step S220, the control section 205 in the item providing server 20 receives the store completion message from the information selecting device 10 via the sending and receiving section 204, and thereafter performs a process of providing an item to the terminal device 30. For example, in the case where the item being an object to be provided is digital contents, the control section 205 reads out, from the item store section 202, an item body corresponding to the item ID in the use request. Then, the control section 205 sends the read-out item body to the terminal device 30 via the sending and receiving section 204. In the case where the item is a good, the control section 205 implements, for example, a delivery process for sending information of a delivery request to a system of a delivery business enterprise. At this time, the control section 205 implements, for example, an accounting process if necessary. When the detailed information about the item is requested, the control section 205 reads out description information and other information from the item store section 202 and sends the read-out information to the terminal device 30.

In a step S240 subsequent to the step S230, the terminal device 30 performs a process relating to the use of the item provided by the item providing server 20. For example, when the item is digital contents, the terminal device 30 performs playing back or indicating the item. When the item is a good, the terminal device 30 indicates, for example, a message saying that a delivery process has been accepted on the screen.

In the step S250 following the step S240 or the step S190, the terminal device 30 determines whether an operation ending command such as user's command to quit the browser is present or absent. If an operation ending commend is present (Yes), the process by the terminal device 30 is ended. If an operation ending command is absent (No), a return to the step S150 is made and the process is continued.

In the present embodiment of this invention, the recommendation request is sent from the terminal device 30 to the information selecting device 10 in the step S160. Other methods may be used instead. For example, the terminal device 30 may send the recommendation request to the item providing server 20, and the item providing server 20 may relay the recommendation request to the information selecting device 10. According to another example, at an appropriate timing, the control section 110 in the information selecting device 10 sends recommendation data from the recommendation information store section 108 to the item providing server 20 via the sending and receiving section 109, and the control section 205 in the item providing server 20 receives the recommendation data via the sending and receiving section 204 and stores the received recommendation data into the data store section 203. Then, in the step S160, the terminal device 30 sends the recommendation request to the item providing server 20. As a process corresponding to the step S170, the control section 205 in the item providing server 20 reads out recommendation data from the data store section 203 to make indication-purpose recommendation data before sending the indication-purpose recommendation data to the terminal device 30. In this case, it is possible to reduce a processing load on the information selecting device 10 which is involved in making and sending indication-purpose recommendation data.

In the present embodiment of this invention, the item providing server 20 relays the use request from the terminal device 30 to the information selecting device 10 in the step S210. Other methods may be used instead. For example, at the same time as the sending of the use request in the step S200 or at an appropriate timing, the terminal device 30 may send the use request directly to the information selecting device 10.

In the step S220, the information selecting device 10 may make indication-purpose recommendation data in a method similar to the step S170 in addition to storing the use history information. In this case, the indication-purpose recommendation data corresponds to the use base item ID in the use request, and the information selecting device 10 sends the indication-purpose recommendation data to the item providing server 20. In the step S230, the item providing server 20 may send the indication-purpose recommendation data to the terminal device 30 in addition to performing the item providing process. In this case, each time the terminal device 30 sends a use request, the terminal device 30 receives recommendation information corresponding to the item ID in the use request.

In item providing service such that a terminal ID of a cellular phone or another device can be used and a special user registering process is unnecessary, when a use subject ID can be contained in a use request sent in the step S200, it is possible to omit the registered user confirmation process in the step S110 and the sending of data necessary for the entrance process in the step S120.

Processing operation of the information selecting device 10 will be described below. First, an explanation will be given of operation of the information selecting device 10 to make recommendation information with reference to FIG. 14.

At a prescribed timing, the control section 110 in the information selecting device 10 issues commands to processing sections of the information selecting device 10, and thereby starts a process of making recommendation information. One of the following timings of three types can be used as the timing of making recommendation information.

The first timing of making recommendation information is prescribed date and time or a prescribed time interval. For example, the first timing is “6 o'clock in every morning and 6 o'clock in every afternoon”, “10:30 in the morning of every Monday”, “time intervals of 12 hours”, or “time intervals of 24 hours”. The first timing may be “6 o'clock in the morning of Monday to Friday and 6 o'clock in the morning and 6 o'clock in the afternoon of Saturday and Sunday”, or “time intervals of 3 hours on Monday to Friday, time intervals of 6 hours on Saturday, and time intervals of 12 hours on Sunday”. Thus, the first timing may correspond to a variable time interval. The first timing may correspond to a time interval depending on season. For example, the first timing may correspond to a short time interval in summer and a long time interval in winter. The use of the first timing can reduce a processing load on the information selecting device 10 as compared with the use of another timing. Especially, in the case where recommendation information is made during a time range for which only a small number of recommendation requests occur, it is possible to effectively reduce a processing load on the information selecting device 10.

The second timing of making recommendation information corresponds to a prescribed number of times the information selecting device 10 receives a recommendation request from a terminal device 30 that is made by the recommendation request sending process (the step S160 in FIG. 11) in the terminal device 30. In this case, recommendation information is made, and thereafter the process of making and sending indication-purpose recommendation data (the step S170) is performed. By adjusting the prescribed number of times, it is possible to adjust a balance between the magnitude of a processing load on the information selecting device 10 and the newness of recommendation information. For example, in the case where the prescribed number of times is set to once so that recommendation information is made each time a recommendation request is received, the newest recommendation information can be provided although a processing load on the information selecting device 10 becomes great.

The third timing of making recommendation information corresponds to a prescribed number of times the information selecting device 10 receives a use request from a terminal device 30 that is made by the use request sending process (the step S200) in the terminal device 30, and that is relayed by the item providing server 20 (the step S210). By adjusting the prescribed number of times, it is possible to adjust a balance between the magnitude of a processing load on the information selecting device 10 and the newness of recommendation information. For example, in the case where the prescribed number of times is set to once so that recommendation information is made each time a use request is received, the newest recommendation information can be provided although a processing load on the information selecting device 10 becomes great.

In the following description, a set of base IDs being objects with respect to making recommendation information will be referred to as a recommendation base set. Basically, in the case where recommendation information is made at the first timing, the number of elements of a recommendation base set is great. In the case where recommendation information is made at the second or third timing, the number of elements of a recommendation base set is basically 1 and is sometimes 2 or more.

With reference to FIG. 14, in the first step S400, the association degree calculating section 104 receiving a command from the control section 110 calculates association degrees of two types corresponding to the item-item recommendation form and the item-category recommendation form. The association degree calculating section 104 makes an association set on the basis of the calculated association degrees, and stores the association set into the association set store section 105.

In a step S410 following the step S400, the association degree calculating section 104 receiving a command from the control section 110 calculates association degrees of two types corresponding to the category-item recommendation form and the category-category recommendation form. The association degree calculating section 104 makes an association set on the basis of the calculated association degrees, and stores the association set into the association set store section 105.

In a step S420 subsequent to the step S410, the price influence degree calculating section 106 receiving a command from the control section 110 calculates price influence degrees representing the degrees of influence of the prices of items and categories on a recommendation result while referring to the price information store section 103.

In a step S430 following the step S420, the information selecting section 107 receiving a command from the control section 110 calculates selection indexes from the association degrees calculated in the steps S400-S410 and the price influence degrees calculated in the step S420.

In a step S440 subsequent to the step S430, the information selecting section 107 selects at least one item or at least one category on the basis of the selection indexes, and stores information about the selected item or category into the recommendation information store section 108. Then, the information selecting section 107 notifies the control section 110 that the recommendation information making operation has been completed.

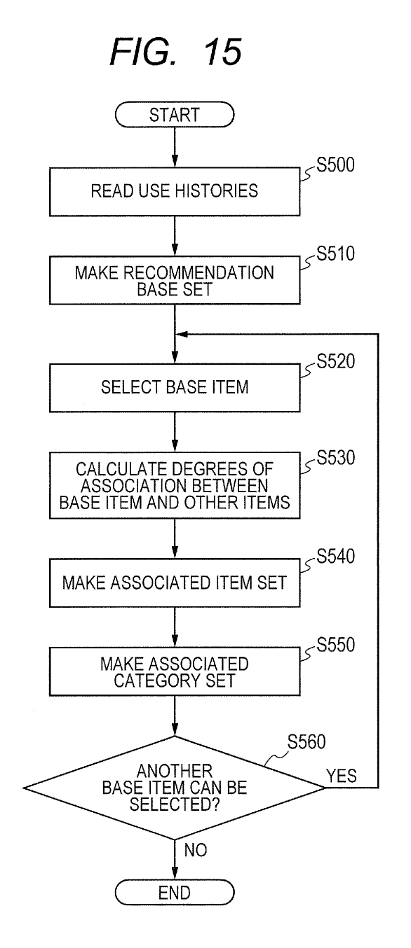

The association set making process (the step S400) corresponding to the item-item recommendation form and the item-category recommendation form will be explained with reference to FIG. 15.

In the first step S500 of FIG. 15, the association degree calculating section 104 reads out use histories from the item use history table 102A in the use history store section 102. Preferably, all the use histories may be read out. Alternatively, only use histories satisfying a prescribed condition may be read out. According to an example of the read-out, use time information is recorded as shown in the item use history table 102A-2 of FIG. 5(b), and only use histories satisfying a condition that use time information thereof is in a prescribed range are read out. A first example of such a condition is that the use time is in the last 4 months. A second example thereof is that the difference between the use time and the present time is between 3 days and 30 days.

For each item, at most a prescribed number of use histories may be read out in order of use time from the newest. For example, in the case where the prescribed number is 20, regarding an item which has been used 20 times or more, 20 use histories are read out in order of use time from the newest. On the other hand, regarding an item which has been used less than 20 times, all use histories are read out. In this case, it is possible to efficiently make an association set for items which are low in use frequency and which have not been used recently.

Then, the association degree calculating section 104 makes a set “σ” of items (item IDs) contained in the use histories read out in the step S500. In the following description, the number of items (the number of different item IDs) contained in the use histories read out in the step S500 is denoted by Ms, and the number of users (the number of different user IDs) is denoted by Us.

In a step S510 following the step S500, the association degree calculating section 104 makes a recommendation base set K1. As mentioned above, in the case where recommendation information is made at the second timing, when an item ID (a request base ID) is contained in the recommendation request, it is placed into the recommendation base set K1. In the case where a category ID is contained in the recommendation request instead of an item ID, nothing is placed into the recommendation base set K1 so that the recommendation base set K1 will be an empty set.

In the case where recommendation information is made at the third timing, a use base item ID in the use request is placed into the recommendation base set K1. Normally, a use request contains one item ID. Sometimes, a use request contains plural item IDs. When plural item IDs are contained in the use request, all of them are placed into the recommendation base set K1.

In the case where recommendation information is made at the first timing, the item set “σ” made in the step S500 is labeled as a recommendation base set K1. In this case, an associated item set will be made for each of the item IDs in the use histories satisfying the prescribed condition. Other processing sections such as the information selecting section 107 and the control section 110 can refer to the recommendation base set K1 made here.

The step S510 is followed by a step S520. In the step S520, the association degree calculating section 104 selects an unprocessed item from the recommendation base set K1 made in the step S510. The selected item is an object to be processed, and is labeled as a base item “x”.

In a step S530 following the step S520, the association degree calculating section 104 calculates the degree of association between the base item “x” and each “y” of other items in the item set “σ” (yεσ, x≠y) by using the use histories read out in the step S500.

Specifically, the association degree calculating section 104 calculates the number of users who have used both the item “x” and the item “y” that is expressed as |I[x]∩I[y]|, where I[x] denotes a set of users who have used the item “x” and I[y] denotes a set of users who have used the item “y”. The calculated user number may be used as an association degree. The number of users who have used at least one of the item “x” and the item “y” is expressed as |I[x]∪I[y]|. The association degree calculating section 104 may calculate the degree of association (W[x][y]) between the item “x” and the item “y” by using a Jaccard coefficient according to the following equation (1).

$$W [ x ] [ y ] = \frac{\vert I [ x ] ⋂ I [ y ] \vert}{\vert I [ x ] ⋃ I [ y ] \vert} \qquad ( 1 )$$

In the case where information about the number of times of use and information about the evaluation (the evaluation values) of items by the user can be obtained from the use histories read out in the step S500, each association degree may be calculated by using a cosine measure or a Peason product-moment correlation coefficient. For example, the number of times a user “u” used the item “x” or the value of evaluation of the item “x” by the user “u” is denoted by E[x][u]. The number of times the user “u” used the item “y” or the value of evaluation of the item “y” by the user “u” is denoted by E[y][u]. The association degree calculating section 104 may calculate the degree of association (W[x][y]) between the item “x” and the item “y” by using a cosine measure according to the following equation (2).

$$W [ x ] [ y ] = \frac{{\sum }_{u = 1}^{Us} E [ x ] [ u ] \times E [ y ] [ u ]}{\sqrt{{\sum }_{u = 1}^{Us} {E [ x ] [ u ]}^{2}} \sqrt{{\sum }_{u = 1}^{Us} {E [ y ] [ u ]}^{2}}} \qquad ( 2 )$$

where Us denotes the number of users (the number of different user IDs) in the use histories read out in the step S500.

Alternatively, the association degree calculating section 104 may calculate the degree of association (W[x][y]) between the item “x” and the item “y” by using a Peason product-moment correlation coefficient according to the following equation (3).

$$W [ x ] [ y ] = \frac{{\sum }_{u ∈ Ic [ x ] [ y ]} ( E [ x ] [ u ] - Ea [ x ] ) ( E [ y ] [ u ] - Ea [ y ] )}{\sqrt{{\sum }_{u ∈ Ic [ x ] [ y ]} {( E [ x ] [ u ] - Ea [ x ] )}^{2}} \sqrt{{\sum }_{u ∈ Ic [ x ] [ y ]} {( E [ x ] [ u ] - Ea [ y ] )}^{2}}} \qquad ( 3 )$$

where Ic[x] [y] denotes a set of users who have used or appreciated both the item “x” and the item “y”, and Ea[x] denotes a mean number of times users in the set Ic[x] [y] used the item “x” and Ea[y] denotes a mean number of times users in the set Ic[x][y] used the item “y”. The association degree calculating section 104 may calculate the association degree W[x][y] by using a Euclidean distance or another distance.

In the case where use time information is stored in the use history store section 102, for the calculation of the value E[x] [u] and the other values, a weight given to a use history newer in use time may be greater than that given to an older use history.

A matrix may be made. Specifically, the value E[x][u], that is, the number of times the user “u” used the item “x” or the value of evaluation of the item “x” by the user “u”, is repetitively calculated while the item “x” and the user “u” are updated like x=1˜M and u=1˜Us. The calculated values are used as elements constituting the matrix. A multivariate analysis such as a principal component analysis or a quantification method type 3 is applied to the matrix to reduce the dimensionality and thereby obtain a vector or vectors. The association degree may be calculated from the vector or vectors by using a cosine measure or a Euclidean distance. Other methods of obtaining an index representing the association between two items may be used.

In a step S540 following the step S530, the association degree calculating section 104 makes an associated item set Ω[x] for the base item “x”, and stores the associated item set Ω[x] into the association set store section 105. The associated item set Ω[x] is an association set in which all associated IDs (associated IDs) are item IDs.

A first method of making an associated item set is to place all the items, for which the degrees of association with the base item “x” have been calculated in the step S530, into the associated item set Ω[x]. This method is suited to the case where an outputted recommendation result is desired to have associated items as many as possible.

A second method of making an associated item set is selecting items highly associated with the base item “x”, and placing only the selected items into the associated item set Ω[x]. Specifically, items differing from the base item “x” and having the degrees of association with the base item “x” which are equal to or greater than a threshold value are selected from the item set “σ”. Other items may be selected in order of decreasing degree of association with the base item “x” provided that the number of selected items will not exceed a prescribed value. For example, in the case where the number of items for which the degrees of association with the base item “x” have been calculated is less than the prescribed number, all of these items are selected. Otherwise, the prescribed number of items are selected in order of association degree from the greatest.

Among items differing from the base item “x” and having the degrees of association with the base item “x” which are equal to or greater than a prescribed value, items may be selected in order of association degree from the greatest. In this case, the number of selected items is limited to within a range equal to or less than a prescribed number. The selected items are combined to form an associated item set Ω[x]. The threshold value for the association degrees may be adjusted on a base-item by base-item basis so that the number of elements of the associated item set Ω[x] will be equal to or greater than a prescribed number. The second method enables a necessary memory capacity of the association set store section 105 to be reduced and allows efficient implementation of the processes in the steps S420-S440.

Then, the association degree calculating section 104 stores the item ID of the base item “x”, each item ID in the associated item set Ω[x], and the association degree into the association degree table 105A of the association set store section 105 while making them in correspondence. Specifically, the association degree calculating section 104 makes the item ID of the base item “x” correspond to the base item ID in the association degree table 105A shown in FIG. 8, and makes the item IDs in the associated item set Ω[x] correspond to the associated item IDs in the association degree table 105A respectively.

In a step S550 following the step S540, the association degree calculating section 104 makes an associated category set φ[x] for the base item “x”, and stores the associated category set φ[x] into the association set store section 105. The associated category set φ[x] is an association set in which all associated IDs (associated IDs) are category IDs.

Specifically, the association degree calculating section 104 uses the associated item set Ω[x] made in the step S540 and thereby makes an associated category set φ[x] while referring to the item information table 101A in FIG. 4(a).

In a first method of making an associated category set φ[x], the category IDs corresponding to the elements of the associated item set Ω[x] are identified, and the number of elements is counted for each of the identified category IDs and the counted element number is labeled as the degree of association between the item “x” and the category. Category IDs corresponding to element numbers equal to or greater than a prescribed number are placed into the associated category set φ[x]. The prescribed number may be “1”. In this case, all the identified category IDs are placed into the associated category set φ[x].

In a second method of making an associated category set φ[x], the category IDs corresponding to the elements of the associated item set Ω[x] are identified, and the total value of the association degrees corresponding to the elements of the associated item set Ω[x] is calculated for each of the identified category IDs and the calculated total value is labeled as the degree of association between the item “x” and the category. Category IDs corresponding to total values equal to or greater than a prescribed value are selected and placed into the associated category set φ[x]. For example, in the case where the associated item set has three elements (associated items) A, B, and C with association degrees of “1.0”, “0.8”, and “0.4” respectively and the element A corresponds to the category 1 while the elements B and C correspond to the category 2, it is good that the degree of association between the base item and the category 1 is set to “1.0” while the degree of association between the base item and the category 2 is set to “1.2 (0.8+0.4)”.

In the case where plural category IDs correspond to a certain element, the total value is calculated while the association degrees for the respective elements are used as they are. Alternatively, the total value may be calculated by using values resulting from dividing the association degrees for the respective elements by the number of the category IDs. For example, in the case where the degree of association between the base item and the element A (the associated item A) is “1.0” and the category 1 and the category 3 correspond to the element A, the degree of association between the base item and the category 1 regarding the element A is set to “1.0” or “0.5 (1.0÷2).

The prescribed value for the total values may be so small that all the identified category IDs will be placed into the associated category set φ[x]. Category IDs, the number of which is equal to or less than a prescribed number, may be selected in order of decreasing total value before the selected category IDs are placed into the associated category set φ[x]. Categories corresponding to the item “x” in the item information table 101A may be excluded from the associated category set φ[x] so that only categories relatively great in unpredictability will be placed into recommendation results. On the other hand, in the case where there is a possibility that the absence of obvious categories from recommendation results may cause the user to have a feeling of wrongness, they may be not excluded.

Then, the association degree calculating section 104 stores the item ID of the base item “x”, each category ID in the associated category set φ[x], and the association degree into the association degree table 105B of the association set store section 105 while making them in correspondence. Specifically, the association degree calculating section 104 implements storing them while making the item ID of the base item “x” correspond to the base item ID in the association degree table 105B shown in FIG. 8, and making the category IDs in the associated category set φ[x] correspond to the associated category IDs in the association degree table 105B respectively.

In a step S560 following the step S550, the association degree calculating section 104 determines whether or not another base item can be selected. It is determined to be “Yes” when an unprocessed item is present in the recommendation base set K1 made in the step S510. On the other hand, it is determined to be “No” when an unprocessed item is absent. In the case of “Yes”, a return to the step S520 is done and the process is repeated. In the case of “No”, the association degree calculating process is ended.

As a result, for each of the base IDs in the recommendation base set K1 made in the step S510, the association degree tables 105A and 105B of the association set store section 105 store the association sets corresponding to the item-item recommendation form and the item-category recommendation form.

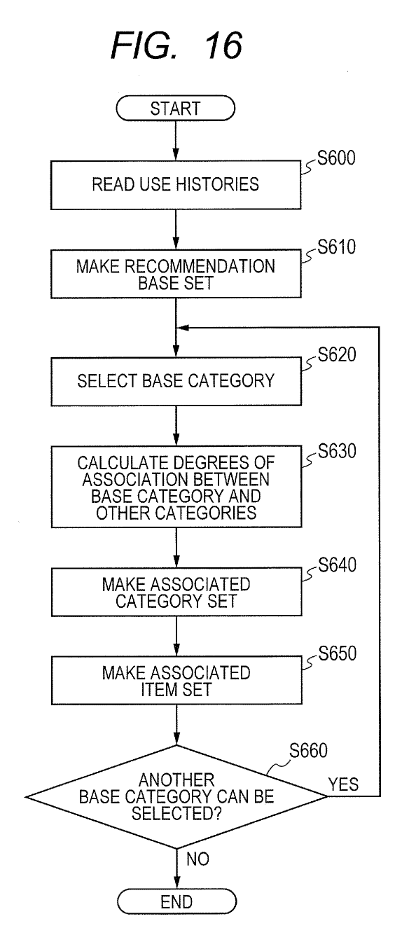

The association set making process (the step S410) corresponding to the category-item recommendation form and the category-category recommendation form will be explained with reference to FIG. 16.

In the first step S600 of FIG. 16, the association degree calculating section 104 reads out use histories as in the step S500. The association degree calculating section 104 may use the use histories read out in the step S500 as they are. Alternatively, the association degree calculating section 104 reads out use histories from the item use history table 102A in the use history store section 102 according to another condition. Then, the association degree calculating section 104 identifies category IDs corresponding to item IDs in the read-out use histories while referring to the item information table 101A. Subsequently, the association degree calculating section 104 makes a category set “ρ” being a set of the identified category IDs. In the case where the use history store section 102 stores the category use history table 102B of FIG. 5(d) in which user IDs and category IDs are made in direct correspondence, it is unnecessary to refer to the item information table 101A so that the process can efficiently be performed.

In a step S610 following the step S600, the association degree calculating section 104 makes a recommendation base set K2. In the case where recommendation information is made at the second timing, when a category ID (a request base ID) is contained in the recommendation request, it is placed into the recommendation base set K2. In the case where an item ID is contained in the recommendation request instead of a category ID, nothing is placed into the recommendation base set K2 so that the recommendation base set K2 will be an empty set.

In the case where recommendation information is made at the third timing, a category ID corresponding to a use base item ID in the use request is identified while the item information table 101A is referred to. Then, the identified category ID is placed into the recommendation base set K2.

In the case of the second timing, the recommendation base set K2 normally has one category ID. The recommendation base set K2 may contain a plurality of category IDs.

In the case where recommendation information is made at the first timing, the category set “ρ” made in the step S600 is labeled as a recommendation base set K2. Other processing sections such as the information selecting section 107 and the control section 110 can refer to the recommendation base set K1 made here.

The step S610 is followed by a step S620. In the step S620, the association degree calculating section 104 selects an unprocessed category from the recommendation base set K2 made in the step S610. The selected category is an object to be processed, and is labeled as a base category “p”.

In a step S630 following the step S620, the association degree calculating section 104 calculates the degree of association between the base category “p” and each “q” of other categories in the category set “ρ” (qερ, p≠q) by using the use histories read out in the step S600. Specifically, “x” and “y” in the step S530 are replaced by “p” and “q” respectively and the number of users and the number of times of use for each item are replaced by the number of users and the number of times of use for each category, and thereby various calculation methods can be used as in the step S530. In the case where the value of evaluation of each item by a user can be obtained, categories corresponding to the item are identified and a mean value of the evaluation values is calculated for each of the identified categories. In this case, the calculated mean value is used for the association degree calculation.

In a step S640 following the step S630, the association degree calculating section 104 makes an associated category set Π[p] for the base category “p”, and stores the associated category set Π[p] into the association set store section 105. The associated category set Π[p] is an association set in which all associated IDs (associated IDs) are category IDs. Specifically, “item” in the step S540 is replaced by “category”, and a process similar to that in the step S540 is performed. In a method similar to the first or second method mentioned regarding the step S540, an associated category set Π[p] is made, and the recording is done while the base category “p” is made in correspondence with the base category ID of the association degree table 105C of FIG. 8 and the category IDs in the associated category set Π[p] are made in correspondence with the associated category IDs in the association degree table 105C respectively.

In a step S650 following the step S640, the association degree calculating section 104 makes an associated item set Δ[p] for the base category “p”, and stores the associated item set Δ[p] into the association set store section 105. Specifically, the association degree calculating section 104 uses the use histories read out in the step S600 and the associated category set Π[p] made in the step S640 and thereby makes an associated item set Δ[p] while referring to the item information table 101A.

In a first method of making an associated item set Δ[p], all item IDs corresponding to each of the elements of the associated category set Π[p] are identified, and the number of elements is counted for each of the identified item IDs and the counted element number is labeled as the degree of association between the category “p” and the item. Item IDs corresponding to element numbers equal to or greater than a prescribed number are placed into the associated item set Δ[p]. The prescribed number may be “1”. In this case, all the identified item IDs are placed into the associated item set Δ[p].

In a second method of making an associated item set Δ[p], all item IDs corresponding to each of the elements of the associated category set Π[p] are identified, and the total value of the association degrees corresponding to the elements of the associated category set Π[p] or the total value of values resulting from dividing the association degrees by the number of the item IDs is calculated for each of the identified item IDs and the calculated total value is labeled as the degree of association between the category “p” and the item. For example, in the case where the associated category set has two elements A and B with association degrees of “1.0” and “0.9” respectively and the element A corresponds to the item 1 while the element B corresponds to the item 1 and the item 2, it is good that the degree of association between the base category and the item 1 is set to “1.9 (1.0+0.9)” or “1.3 (1.0+0.9÷3).

Then, item IDs corresponding to total values equal to or greater than a prescribed value are selected and placed into the associated item set Δ[p]. The prescribed value may be so small that all the identified item IDs will be placed into the associated item set Δ[p]. Item IDs, the number of which is equal to or less than a prescribed number, may be selected in order of decreasing total value before the selected item IDs are placed into the associated item set Δ[p]. Items corresponding to the base category “p” in the item information table 101A may be excluded from the associated item set Δ[p]. Alternatively, they may be not excluded.

Then, the association degree calculating section 104 stores the category ID of the base category “p”, each item ID in the associated item set Δ[p], and the association degree into the association set store section 105 while making them in correspondence. Specifically, the association degree calculating section 104 implements storing them while making the category ID of the base category “p” correspond to the base category ID in the association degree table 105D shown in FIG. 8, and making the item IDs in the associated item set Δ[p] correspond to the associated item IDs in the association degree table 105D respectively.

In a step S660 following the step S650, the association degree calculating section 104 determines whether or not another base category can be selected. It is determined to be “Yes” when an unprocessed category is present in the recommendation base set K2 made in the step S610. On the other hand, it is determined to be “No” when an unprocessed category is absent. In the case of “Yes”, a return to the step S620 is done and the process is repeated. In the case of “No”, the association degree calculating process is ended.

As a result, for each of the base IDs in the recommendation base set K2 made in the step S610, the association degree tables 105C and 105D of the association set store section 105 store the association sets corresponding to the category-item recommendation form and the category-category recommendation form.

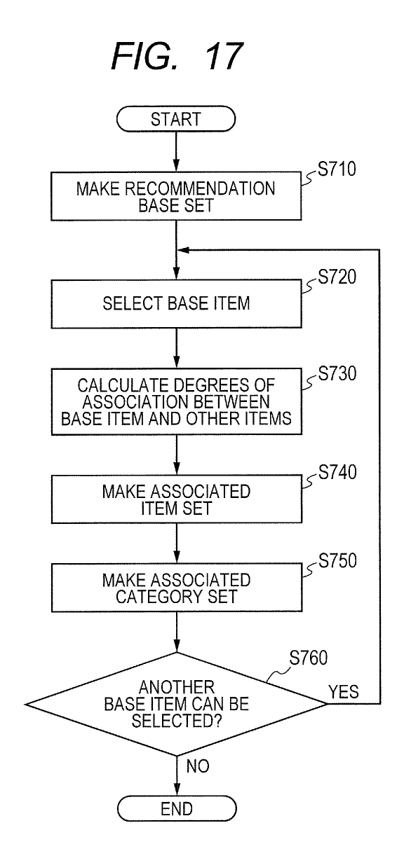

With reference to FIG. 17, a description will be given of an example of a modification of the association set making process (the step S400) corresponding to the item-item recommendation form and the item-category recommendation form. This example uses data in the item information table 101A instead of use histories in the use history store section 102. Thus, when this example is used, it is possible to omit the use request relaying process (the step S210) by the item providing server 20, the use history storing process (the step S220) by the information selecting device 10, and the use history store section 102. Preferably, in the item information table 101A of the item attribute store section 101, items as many as possible correspond to plural categories.

In the first step S710 of FIG. 17, the association degree calculating section 104 makes a recommendation base set K1. In the case where recommendation information is made at the second timing, when an item ID (a request base ID) is contained in the recommendation request, it is placed into the recommendation base set K1. In the case where a category ID is contained in the recommendation request instead of an item ID, nothing is placed into the recommendation base set K1 so that the recommendation base set K1 will be an empty set. Normally, a use request contains one item ID. Sometimes, a use request contains plural item IDs. When plural item IDs are contained in the use request, all of them are placed into the recommendation base set K1.

In the case where recommendation information is made at the first timing, a set Λ of all items (item IDs) in the item information table 101A is labeled as a recommendation base set K1.

The step S710 is followed by a step S720. In the step S720, the association degree calculating section 104 selects an unprocessed item from the recommendation base set K1 made in the step S710. The selected item is an object to be processed, and is labeled as a base item “x”.

In a step S730 following the step S720, the association degree calculating section 104 calculates the degree of association between the base item “x” and each “y” of other items in the item set Λ (yεΛ, x≠y). Specifically, the association degree calculating section 104 calculates the number of common categories for the item “x” and the item “y” that is expressed as |H[x]∩H[y]|, where H[x] denotes a set of categories for the item “x” and H[y] denotes a set of categories for the item “y”. The calculated common category number may be used as an association degree. The number of categories corresponding to at least one of the item “x” and the item “y” is expressed as |H[x]∪H[y]|. The association degree calculating section 104 may calculate the degree of association (W[x][y]) between the item “x” and the item “y” by using a Jaccard coefficient according to the following equation (4).

$$W [ x ] [ y ] = \frac{\vert H [ x ] ⋂ H [ y ] \vert}{\vert H [ x ] ⋃ H [ y ] \vert} \qquad ( 4 )$$

Other methods may be used as long as they obtain indexes each indicating the similarity between two items. Information about the prices of items may be recorded in the item information table 101A. In this case, an association degree may be calculated so as to reflect the difference in price information between the item “x” and the item “y”.

In a step S740 following the step S730, the association degree calculating section 104 makes an associated item set Ω[x] for the base item “x”, and stores the associated item set Ω[x] into the association set store section 105. Preferably, the association degree calculating section 104 makes the associated item set Ω[x] by using a method similar to that in the step S540.

In a step S750 subsequent to the step S740, the association degree calculating section 104 makes an associated category set φ[x] for the base item “x”, and stores the associated category set φ[x] into the association set store section 105. Preferably, the association degree calculating section 104 makes the associated category set φ[x] by using a method similar to that in the step S550.

In a step S760 following the step S750, the association degree calculating section 104 determines whether or not another base item can be selected. It is determined to be “Yes” when an unprocessed item is present in the recommendation base set K1 made in the step S710. On the other hand, it is determined to be “No” when an unprocessed item is absent. In the case of “Yes”, a return to the step S720 is done and the process is repeated. In the case of “No”, the association degree calculating process is ended.

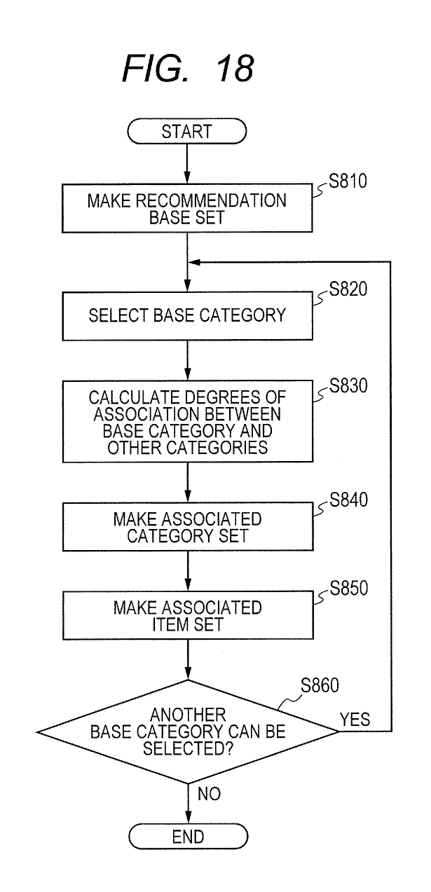

With reference to FIG. 18, a description will be given of an example of a modification of the association set making process (the step S410) corresponding to the category-item recommendation form and the category-category recommendation form. This example uses data in the item information table 101A instead of use histories in the use history store section 102. Thus, when this example is used, it is possible to omit the use request relaying process (the step S210) by the item providing server 20, the use history storing process (the step S220) by the information selecting device 10, and the use history store section 102. Preferably, in the item information table 101A of the item attribute store section 101, items as many as possible correspond to plural categories.

In the first step S810 of FIG. 18, the association degree calculating section 104 makes a recommendation base set K2. In the case where recommendation information is made at the second timing, when a category ID (a request base ID) is contained in the recommendation request, it is placed into the recommendation base set K2. In the case where an item ID is contained in the recommendation request instead of a category ID, nothing is placed into the recommendation base set K2 so that the recommendation base set K2 will be an empty set. Normally, a use request contains one category ID. Sometimes, a use request contains plural category IDs. When plural category IDs are contained in the use request, all of them are placed into the recommendation base set K2.

In the case where recommendation information is made at the first timing, a set “μ” of all categories (category IDs) in the item information table 101A is labeled as a recommendation base set K2.

The step S810 is followed by a step S820. In the step S820, the association degree calculating section 104 selects an unprocessed category from the recommendation base set K2 made in the step S810. The selected category is an object to be processed, and is labeled as a base category “p”.

In a step S830 following the step S820, the association degree calculating section 104 calculates the degree of association between the base category “p” and each “q” of other categories in the category set “μ” (qεμ, p≠q). Specifically, the association degree calculating section 104 calculates the number of common items corresponding to the category “p” and the category “q” that is expressed as |J[p]n∩J[q]|, where J[p] denotes a set of items corresponding to the category “p” and J[q] denotes a set of items corresponding to the category “q”. The calculated common item number may be used as an association degree. The number of items corresponding to at least one of the category “p” and the category “q” is expressed as |J[p]∪J[q]|. The association degree calculating section 104 may calculate the degree of association (W[p][q]) between the category “p” and the category “q” by using a Jaccard coefficient according to the following equation (5).

$$W [ p ] [ q ] = \frac{\vert J [ p ] ⋂ J [ q ] \vert}{\vert J [ p ] ⋃ J [ q ] \vert} \qquad ( 5 )$$

Other methods may be used as long as they obtain indexes each indicating the similarity between two categories.

In a step S840 following the step S830, the association degree calculating section 104 makes an associated category set Π[p] for the base category “p”, and stores the associated category set Π[p] into the association set store section 105. Preferably, the association degree calculating section 104 makes the associated category set Π[p] by using a method similar to that in the step S640.

In a step S850 subsequent to the step S840, the association degree calculating section 104 makes an associated item set Δ[p] for the base category “p”, and stores the associated item set Δ[p] into the association set store section 105. Preferably, the association degree calculating section 104 makes the associated item set Δ[p] by using a method similar to that in the step S650.

In a step S860 following the step S850, the association degree calculating section 104 determines whether or not another base category can be selected. It is determined to be “Yes” when an unprocessed category is present in the recommendation base set K2 made in the step S610. On the other hand, it is determined to be “No” when an unprocessed category is absent. In the case of “Yes”, a return to the step S820 is done and the process is repeated. In the case of “No”, the association degree calculating process is ended.

In each of the above-mentioned association degree calculating steps, a normalization process may be performed so that the maximum value or the total value of association degrees will be equal to, for example, “1”.

A detailed description will be given of the price influence degree calculating process in the step S420. As previously mentioned, in the steps S400 and S410, the association sets are stored into the association set store section 105. During the price influence degree calculating process, the control section 110 reads out the association sets (associated IDs) from the association set store section 105, and feeds the price influence degree calculating section 106 with price information corresponding to each associated ID and commands the price influence degree calculating section 106 to calculate a price influence degree while referring to the price information store section 103.

For example, when the associated ID is an item ID “ItemID-3”, the control section 110 refers to the item price information table 103A of FIG. 6(a) and feeds the price influence degree calculating section 106 with price information of “300 yen” assigned to the item ID “ItemID-3”. For example, when the associated ID is a category ID “CategoryID-3”, the control section 110 refers to the category price information table 103B of FIG. 6(b) and feeds the price influence degree calculating section 106 with price information of “6000 yen” assigned to the category ID “CategoryID-3”.

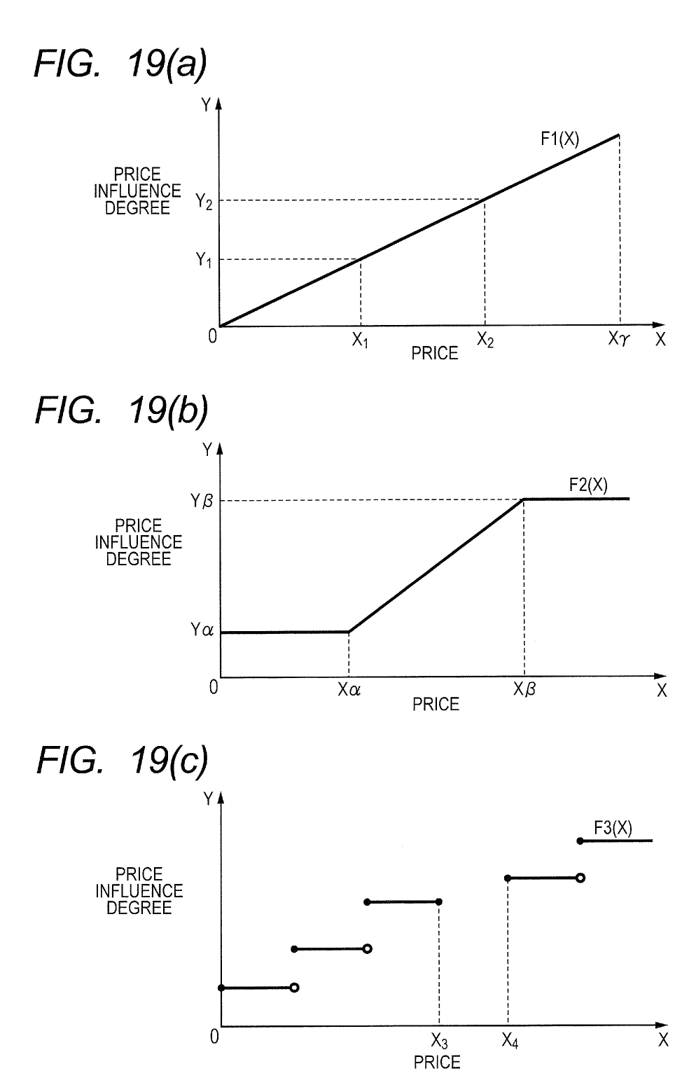

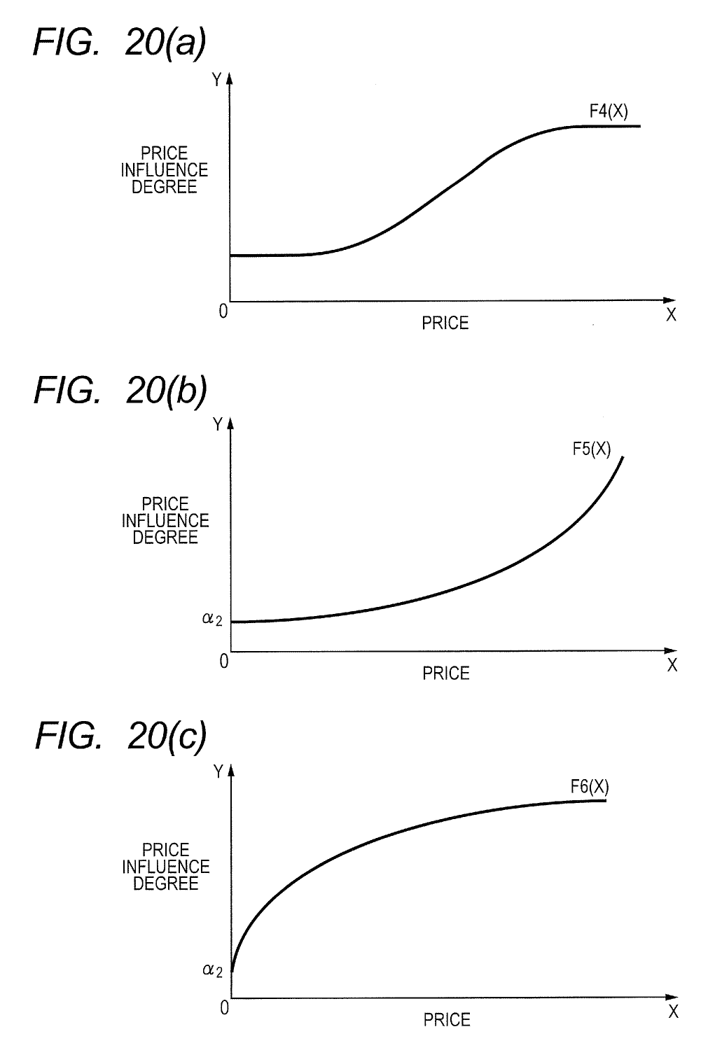

The price influence degree calculating section 106 has an internal memory area storing data representative of a price influence function F(X) designed so that its input X is assigned to price information (a price) and its output Y is assigned to a price influence degree for deciding the degree of influence of the price information on a recommendation result. The function F(X) means a correspondence rule. The function F(X) has a monotonically increasing interval for which the output Y increases as the input X increases. The function F(X) has a characteristic such that the output Y never decreases as the input X increases throughout the entire interval. Thus, the function F(X) has no monotonically decreasing interval. The function F(X) is of one of various shapes. Examples of the function F(X) are shown in FIGS. 19(a), 19(b), 19(c), 20(a), 20(b), and 20(c) while being denoted by F1(X), F2(X), F3(X), F4(X), F5(X), and F6(X) respectively.

The function F1(X) in FIG. 19(a) is designed so that Y1<Y2 always stands good for an input of X1<X2 throughout the function definition range (0≦X≦Xγ). Thus, the function F1(X) is of a monotonically increasing type. The character Xγ denotes the upper limit of the price information in the price information store section 103. In this way, the upper limit of the input to the function F(X) may be set depending on the price information in the price information store section 103. The upper limit of the input to the function F(X) may be not set especially. When such a linear function having a monotonically increasing characteristic throughout the entire interval is used, the process is made relatively simple and a processing load on the information selecting device 10 can be reduced. In the case where a function such that Y=0 when X=0 like the function F1(X) is used, free items and categories having prices of “0” can easily be excluded from recommendation results as will be mentioned later.

The function F1(X) in FIG. 19(a) is linear. The linear function may be replaced by a nonlinear function. Price influence degrees can be calculated more finely and accurately by using a nonlinear function.

According to the function F2(X) in FIG. 19(b), the output Y is constant as Y=Yα for 0≦x≦Xα and the output Y monotonically increases for Xα<X<Xβ, and the output Y is constant as Y=Yβ for Xβ≦X. Thus, the function F2(X) has a monotonically increasing characteristic for a partial interval, and has no monotonically decreasing interval. Here, the monotonically decreasing interval means an interval for which an output of Y2>Y1 is obtained for an input of X1<X2.

Regarding the function F2(X), there is only one monotonically increasing interval. The function F2(X) may be replaced by a function with a plurality of monotonically increasing intervals. The function F2(X) may be modified so that the constant output interval extending leftward of the monotonically increasing interval will be removed and the monotonically increasing interval will be extended to an interval of 0≦X≦Xβ. The function F2(X) may be modified so that the constant output interval extending rightward of the monotonically increasing interval will be removed and the monotonically increasing interval will be extended to an interval of Xα<X. The value Yα may be “0”.

When a function with a combination of a monotonically increasing interval and at least one constant output interval such as the function F2(X), the degree of freedom of calculating every price influence degree can be made great. For example, when the value Yα is set to a somewhat great value, items and categories having low prices can easily be in a recommendation result.

The function F3(X) in FIG. 19(c) has a step-like discrete characteristic. Thus, the function F(X) used by the price influence degree calculating section 106 may differ from a continuous function. In FIG. 19(c), a black circle at an end of a line segment means the inclusion of the value thereat, and a white circle means the exclusion of the value. For example, in the absence of price information corresponding to an interval of X3<X<X4 from the price information store section 103, the interval of X3<X<X4 may be undefined for the function F3(X) as shown in FIG. 19(c). Two or more different values are given to the output Y.

When a discrete function like the function F3(X) is used, the process is made relatively simple and a processing load on the information selecting device 10 can be reduced. A function with a lot of constant output intervals is suited to the case where every price influence degree is desired to be relatively insensitive to a fine difference between prices.

The function F4(X) in FIG. 20(a) is of a smooth nonlinear type. The function F4(X) has a characteristic such that the gradient (differential coefficient) peaks when the input X is in an intermediate portion of the entire interval, and becomes smaller as the input X is closer to one of the opposite ends of the entire interval. For example, the function F4(X) uses a logistic function. When a smooth function like the function F4(X) is used, a price influence degree is prevented from abruptly varying.

The function F5(X) in FIG. 20(b) and the function F6(X) in FIG. 20(c) use a function F(x) given as follows.

F[x]=α₁×x^{γ}+α₂ (6)

where “α₁” is a constant greater than 0 and “α₂” is a constant equal to or greater than 0, and “γ” is a constant greater than 0. The value “α₂” is 0 or positive.

When γ>1, the function F[x] is a monotonically increasing function (a downwardly convex function) like the function F5(X) in which the gradient (differential coefficient) increases as the input X increases. The function F5(X) is suited to the case where more items (categories) having high prices are desired to be in a recommendation result.

When 0<γ<1, the function F[x] exhibits a monotonically increasing behavior (an upwardly convex function) like the function F6(X) in which the gradient (differential coefficient) decreases as the input X increases. The function F6(X) is suited to the case where some items (categories) having low prices are desired to be in a recommendation result.

The function F(X) may be a logarithmic function or an exponential function. The functions F1(X)-F6(X) are mere examples of the function F(X). The function F(X) may be any function in which the output Y monotonically increases as the input X increases for at least a partial interval, and there is no monotonically decreasing interval. According to the function F(X), an item (or a category) corresponding to great price information (a high price) has a greater price influence degree so that items (categories) having high prices can be preferentially in a recommendation result. The characteristic of the function F(X) may depend on whether the associated ID is an item ID or a category ID.

The characteristic of the function F(X) may depend on price information of each base ID. In this case, the control section 110 refers to the price information store section 103 and thereby feeds the price influence degree calculating section 106 with price information corresponding to each base ID, and the price influence degree calculating section 106 changes the characteristic of the price influence function F(X) in response to the fed price information on a base-ID by base-ID basis.

For example, in the case where the function F2(X) of FIG. 19(b) is used, it is good that the values Xα and Xβ are set to relatively great values when price information (the price) of each base ID is equal to or higher than a prescribed value, and are set to relatively small values when price information of each base ID is lower than the prescribed value.

For example, in the case where the function F5(X) of FIG. 20(b) is used, it is good that the degree of downward convex of the function F5(X) increases as price information (the price) of each base ID is higher. In the case where the function F6(X) of FIG. 20(c) is used, it is good that the degree of upward convex of the function F6(X) increases as price information of each base ID is lower.

In the case where such a method is used, more items (categories) having relatively high prices can be in a recommendation result when the price of the base item (category) is relatively high, and some items (categories) having relatively low prices can be in a recommendation result when the price of the base item (category) is relatively low. In the case where the price of the base item (category) is relatively high, there is only a low possibility that an unnatural impression may be made on the user even when many items (categories) having high prices are in a recommendation result. Thus, it is possible to recommend high-price items (categories) to the user while reducing the risk of decreasing the buying interest of the user.

In the price influence degree calculating section 106, the internal memory area may store data representative of the price influence function F(X) as a numerical formula. In this case, the price influence degree calculating section 106 calculates a price influence degree in accordance with the numerical formula each time it is given an input. In this case, a necessary memory capacity can be reduced, and price influence degrees can be calculated at a high accuracy (a high resolution).

An output Y for an input X may be calculated in advance according to the function F(X) while the input X is varied, and (X, Y) information of the results of the calculation may be prestored in the memory area. It is possible to use a LUT (Look-Up Table) in which the values of the output Y are stored in addresses in the memory area which correspond to the input X. In this case, since it is unnecessary to calculate a numerical formula during the term from the moment of the feed of the input X and to the moment of the outputting of the output Y, a process amount can be small and a response time can be short. Normalization may be done so that the values of price information degrees will be in a prescribed range (for example, equal to or greater than 0 and equal to or smaller than 1).

The selection index calculating process in the step S430 will be described below in detail. With respect to each of the associated IDs for which the price influence degrees have been calculated in the step S420, the information selecting section 107 receiving a command from the control section 110 calculates a selection index S from the association degree W and the price influence degree Y. The selection index S is a numerical value which increases as the association degree W increases, and which increases as the price influence degree increases. The selection index S is calculated in one of the following methods.

A first method of calculating a selection index S uses the following equation (7).

S[i][j]=βc×W[i][j]^{γa}×Y[j]^{γb} (7)

where W[i][j] denotes the degree of association between the base ID “i” and the associated ID “j”, and Y[j] denotes the price influence degree. In addition, “βc”, “γa”, and “γb” denote constants greater than 0. Thus, calculation is made as to the first exponentiation using the association degree W[i][j] as a base and using the constant “γa” as an exponent, and the second exponentiation using the price influence degree Y[j] as a base and using the constant “γb” as an exponent. A selection index S[i][j] is calculated by using the product of the constant “βc”, the first exponentiation, and the second exponentiation.

The first method causes associated IDs great in both association degree and price influence degree to be easily in a recommendation result. In the case where the function F1(X) in FIG. 19(a) or a similar function having a characteristic such that the price influence degree is 0 for price information of 0 (a price of 0) is used, the selection index is 0 for a free item having a price of 0 so that the free item can easily be excluded from the recommendation result. Associated IDs to be in the recommendation result can be changed by adjusting the constants “γa” and “γb”.

For example, an associated ID greater in association degree W[i][j] is more easily in the recommendation result by making the constant “γa” greater. An associated ID greater in price influence degree Y[j] is more easily in the recommendation result by making the constant “γb” greater. The setting of βc=γa=γb=1 may be done so that the product of the association degree and the price influence degree will be the selection index.

A second method of calculating a selection index S uses the following equation (8).

S[i][j]=βa×W[i][j]+βb×Y[j] (8)

where “βa” and “βb” denote constants or weighting coefficients greater than 0. Thus, calculation is made as to the first product of the association degree W[i][j] and the constant “βa”, and the second product of the price influence degree Y[j] and the constant “βb”. The sum of the first product and the second product is labeled as a selection index S[i][j]. The equation (8) means that the association degree and the price influence degree are weighted, and the results are summed.

The second method causes associated IDs great in both association degree and price influence degree to be easily contained in a recommendation result. As compared with the first method, the second method causes associated IDs great in association degree or price influence degree to be more easily contained in a recommendation result. Associated IDs to be in the recommendation result can be changed by adjusting the constants “βa” and “βb”.

For example, an associated ID greater in association degree W[i][j] is more easily in the recommendation result by making the constant “βa” greater. An associated ID greater in price influence degree Y[j] is more easily in the recommendation result by making the constant “βb” greater. The setting of βa=βb=1 may be done so that the sum of the association degree and the price influence degree will be the selection index.

A third method of calculating a selection index S uses the following equation (9).

S[i][j]=βd×log(W[i][j])+βe×log(Y[j]) (9)

where “βd” and “βe” denote constants or weighting coefficients greater than 0. Thus, calculation is made as to the first product of the constant “βd” and the logarithm of the association degree W[i][j], and the second product of the constant “βe” and the logarithm of the price influence degree Y[j]. The sum of the first product and the second product is labeled as a selection index S[i][j]. The equation (9) means that the logarithms of the association degree and the price influence degree are weighted, and the results are summed. Associated IDs to be in the recommendation result can be changed by adjusting the constants “βd” and “βe”. The setting of βd=βe=1 may be done so that the sum of the logarithms of the association degree and the price influence degree will be the selection index. The third method is suited to the case where the dynamic range of association degrees or price influence degrees is wide, or the dynamic range of association degrees and that of price influence degrees are greatly different.

The association degrees may be replaced by ranks of association degree so that a selection index will be greater as the rank is higher or the price influence degree is greater. It is good that similar to the recommendation information store section 108, data representative of ranks which are higher as association degrees are greater are stored in the association set store section 105 before these ranks are used.

A selection index may be calculated by using other information in addition to the association degree and the price influence degree. For example, the information selecting section 107 refers to the item attribute store section 101 and thereby reads out item time information T[j] of the associated ID “j”. Then, calculation is carried out so that a selection index will be greater as the read-out item time information T[j] is newer (as the difference between the processing time point and the item time information is smaller), and will be greater as the association degree W[i][j] is greater and the price influence degree Y[j] is greater.

The recommendation information selecting process in the step S440 will be explained in detail. In the step S440, the information selecting section 107 selects an associated ID or IDs from the association set on the basis of the selection indexes calculated in the step S430.

Specifically, the information selecting section 107 selects, from the association set, an associated ID or IDs corresponding to selection indexes S[i][j] equal to or greater than a prescribed value θ1. The information selecting section 107 may select a prescribed number η1 or a less number of associated IDs in order of selection index from the greatest. For example, in the case where the number of elements in the association set is smaller than the prescribed number η1, all the elements in the association set are selected. Otherwise, the prescribed number η1 associated IDs are selected in order of selection index from the greatest.

The information selecting section 107 may select, from associated IDs corresponding to selection indexes S[i][j] equal to or greater than a prescribed value θ2, a prescribed number η2 or a less number of associated IDs in order of selection index from the greatest. In this case, when the number of associated IDs corresponding to selection indexes S[i][j] equal to or greater than the prescribed value θ2 is smaller than the prescribed number η2, all of those associated IDs are selected. A prescribed value θ3 for selection indexes S[i] [j] may be set on a base-ID by base-ID basis so that a prescribed number η3 or a more number of associated IDs can be selected. In this case, associated IDs corresponding to selection indexes S[i] [j] equal to or greater than the prescribed value θ3 are selected.

A selection set (a set of selected associated IDs) may be designed as follows. In the case where recommendation information is made each time a recommendation request is received once at the second timing, when a use subject ID is in the recommendation request, items and categories which were used by one having the use subject ID are identified by referring to the use history store section 102. The identified items and categories are excluded from the selection set (the selected associated IDs). In the case where items and categories which were used are excluded in the step S440 in this way, a memory capacity of the recommendation information store section 108 can be saved for item providing service having a characteristic such that a user purchases a same item (category) only once. In the case where items and categories which were used are excluded in the step S440, the similar used-item/category excluding process may be omitted from the step S170. The used-item/category excluding processes may be performed in the step S170 and the step S440. In the case where there is a possibility that a new use history may be stored during the time interval from the moment of the execution of the step S440 to the moment of the execution of the step S170, it preferable to perform the used-item/category excluding processes in the step S170 and the step S440. In this case, recommendation accuracy can surely be improved.

Associated IDs are selected in this way. Recommendation ranks are given to the selected associated IDs respectively according to the selection indexes thereof. Specifically, a selected associated ID corresponding to a greater selection index is given a higher recommendation rank. Recommendation information tables 108A-108D in forms of FIGS. 7(a)-7(d) are stored in the recommendation information store section 108 while the base ID, the associated IDs, and the recommendation ranks are made in correspondence.

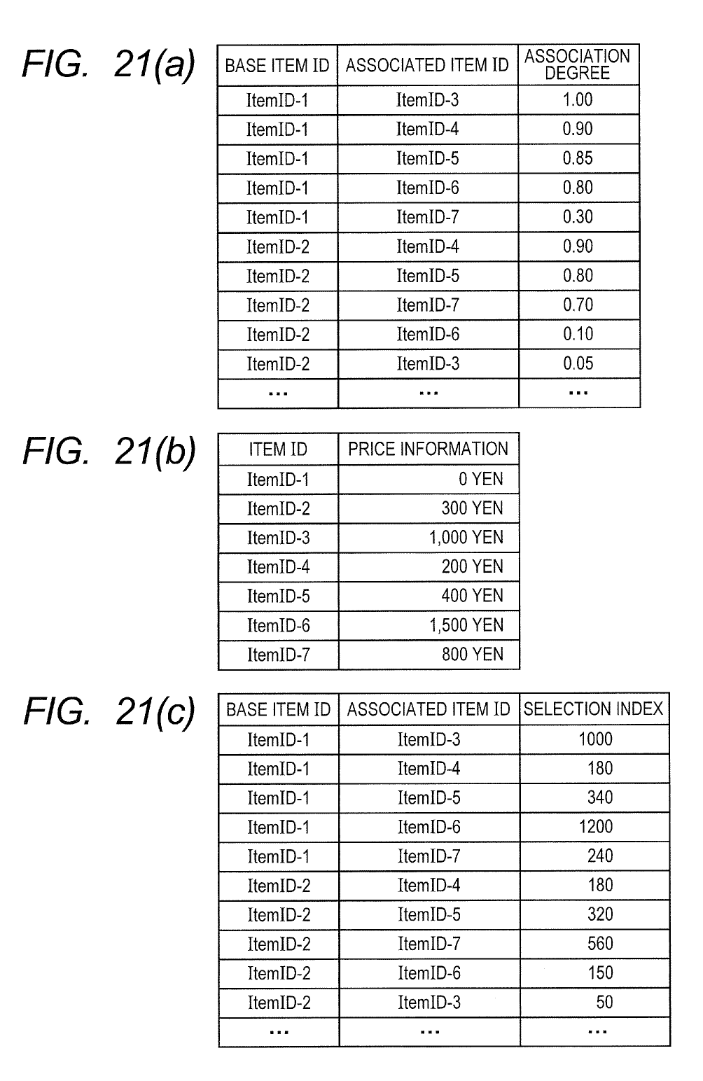

An example of the recommendation information will be explained below. The association set store section 105 stores data having contents shown in FIG. 21(a). It is assumed that base IDs and associated IDs are item IDs. As shown in FIG. 21(a), an association set for “ItemID-1” has five items “ItemID-3” to “ItemID-7”. An association set for “ItemID-2” has the same five items. It is assumed that the association degrees of the items in the association set for “ItemID-1” differ from those of the items in the association set for “ItemID-2”.

The price information store section 103 stores price information about 7 items “ItemID-1” to “ItemID-7” as shown in FIG. 21(b).

It is assumed that the price influence degree calculating section 106 uses the function F1(X) of FIG. 19(a) and the gradient of the function F1(X) is “1”. It is also assumed that the information selecting section 107 calculates each selection index by using the equation (7), and βc=γa=γb=1. It is further assumed that the information selecting section 107 selects 3 items in order of selection index from the greatest to make recommendation information.

Under the above-mentioned conditions, when items are selected according to association degree without using price information, recommended items for “ItemID-1” are “ItemID-3” with the first recommendation rank, “ItemID-4” with the second recommendation rank, and “ItemID-5” with the third recommendation rank as clear from FIG. 21(a). The prices of “ItemID-3”, “ItemID-4”, and “ItemID-5” are 1000 yen, 200 yen, and 400 yen, respectively.

The association set store section 105 stores data having contents shown in FIG. 21(c). Selection indexes calculated in the method of the present embodiment of this invention are as follows. Regarding “ItemID-3”, the selection index is as “1000×1.0=1000”. The selection indexes for other items are shown in FIG. 21(c). Three items are selected in order of selection index from the greatest. The selected items are “ItemID-6” with the first recommendation rank, “ItemID-3” with the second recommendation rank, and “ItemID-5” with the third recommendation rank. The prices of “ItemID-6”, “ItemID-3”, and “ItemID-5” are 1500 yen, 1000 yen, and 400 yen, respectively. As compared with the case of item selection responsive to association degree only, the method of the present embodiment of this invention can place a high-price item in the recommendation result.

When items are selected according to association degree without using price information, recommended items for “ItemID-2” are “ItemID-4” with the first recommendation rank, “ItemID-5” with the second recommendation rank, and “ItemID-7” with the third recommendation rank as clear from FIG. 21(a). The prices of “ItemID-4”, “ItemID-5”, and “ItemID-7” are 200 yen, 400 yen, and 800 yen, respectively.

Selection indexes calculated in the method of the present embodiment of this invention are as follows. Regarding “ItemID-4”, the selection index is as “200×0.9=180”. The selection indexes for other items are shown in FIG. 21(c). Three items are selected in order of selection index from the greatest. The selected items are “ItemID-7” with the first recommendation rank, “ItemID-5” with the second recommendation rank, and “ItemID-4” with the third recommendation rank. The prices of “ItemID-7”, “ItemID-5”, and “ItemID-4” are 800 yen, 400 yen, and 200 yen, respectively. In this case, although the sum of the prices of the selected items is equal to that resulting from item selection responsive to association degree only, an item having a higher price is given a higher recommendation rank and can easily be noticed by the user.

High-price “ItemID-6” and “ItemID-3” are in the recommendation result for “ItemID-1” but are absent from the recommendation result for “ItemID-2”. Thus, in the embodiment of this invention, a high-price item is recommended only when being high in the degree of association with the base item. Accordingly, an unnatural impression is hardly made on the user. As compared with a prior-art method, it is possible to reduce the risk of decreasing the buying interest of the user due to the recommendation of a high-price item. Therefore, it can be expected that the sales of the item providing service will increase.

In a prior-art method, since the prices of recommended items are limited to within a prescribed range (a prescribed price range), recommendation results are sometimes poor in variety and the number of recommended items per recommendation result is sometimes small. On the other hand, in the method of the present embodiment of this invention, the prices of recommended items for one base item are not limited to within a prescribed range and recommendation results are good in variety as understood from the following explanation. In the method of the present embodiment of this invention, the prices of the recommended items for “ItemID-1” are 1500 yen, 1000 yen, and 400 yen respectively, and a price of 800 yen is omitted.

As understood from the fact that the difference between the prices of the recommended items for “ItemID-1” and the prices of the recommended items for “ItemID-2” is relatively great, there occur more price variations between recommendation results for different base items. Thus, in the method of the present embodiment of this invention, the prices of recommended items are not limited to within a prescribed range and recommendation results are richer in variety than those obtained in the prior-art method. Even in the case where there is only a small number of recommended items having prices in the prescribed range, it is easier to provide recommendation information representative of a sufficient number of recommended items than the prior-art method. Thus, even in the case where recommendation information is repetitively provided to the same user for a long term, the user hardly gets tired of the recommendation information and may continuously use the recommendation information.

In the prior-art method, when the prices of many recommended items are in the prescribed range, it is difficult to accurately narrow the recommended items so that too many items will be recommended to the user. Basically, recommendation information should be provided in a manner such that many pieces of information are narrowed into pieces useful to the user. The indication device 320 connected to a terminal device 30 has a limited area for indicating recommendation information. It is important that recommendation information represents a sufficient number of items. In the method of the present embodiment of this invention, recommendation ranks for items are determined according to calculated selection indexes, and items with higher recommendation ranks are preferentially recommended to the user. Therefore, items can be accurately narrowed, and a sufficient number of items can be recommended to the user.

In the method of the present embodiment of this invention, a high-price item associated with a base item, a high-price category associated with the base item, a high-price item associated with a base category, and a high-price category associated with the base category can be recommended to the user. Since information in various recommendation forms can be provided to a user, convenience for the user can be improved and it can be expected that the sales of the item providing service will increase.

In the present embodiment of this invention, the information selecting device 10 calculates price influence degrees and selection indexes, and makes recommendation information. These processes or a part of these processes may be performed by a terminal device 30.

In this case, the application section 304 in a terminal device 30 is designed to perform processes corresponding to the price influence degree calculating section 106 and the information selecting section 107. For example, at an appropriate timing before the step S160, the application section 304 obtains data from the item information table 101A, the category information table 101B, the association degree tables 105A-105D, the item price information table 103A, and the category price information table 103B in the information selecting device 10 directly or via the item providing server 20. At this time, all data is obtained from each of these tables. Alternatively, only data associated with a request base ID may be obtained. Then, in the step S160, price influence degrees are calculated in the previously-mentioned procedure instead of sending a recommendation request. Selection indexes are calculated from the calculated price influence degrees and the obtained association degrees. Recommendation information is made in response to the calculated selection indexes. Specifically, it is good that the application section 304 performs processes corresponding to the steps S420, S430, S440, and S170. In this case, the application section 304 is formed with a data obtaining section, a price influence degree calculating section, and an information selecting section.

### Second Embodiment

A network system in a second embodiment of this invention will be described with reference to drawings. The network system in the second embodiment of this invention is similar to that in the first embodiment thereof except for design changes mentioned hereafter.

In the second embodiment of this invention, a part of processes by an information selecting device 10 may be performed by each terminal device 30. The second embodiment of this invention is designed so that a user who is using a terminal device 30 can adjust price influence degrees in accordance with user's preference (taste). An item providing server 20 and terminal devices 30 in the second embodiment of this invention may be similar to those in the first embodiment thereof.

FIG. 22 is a block diagram showing the structure of an information selecting device 10b in the second embodiment of this invention. The information selecting device 10b corresponds to the information selecting device 10 in the first embodiment of this invention. As shown in FIG. 22, the information selecting device 10b includes an item attribute store section 101, a use history store section 102, a price information store section 103, an association degree calculating section 104, an association set store section 105, a price influence degree calculating section 106b, an information selecting section 107b, a sending and receiving section 109, and a control section 110b. An indication device 120 and an input device 130 are connected to the information selecting device 10b. The indication device 120 serves to indicate necessary information to a manager about the information selecting device 10b. The input device 130 is, for example, a keyboard or a mouse operated by the manager.

The information selecting device 10b differs from the information selecting device 10 in that the recommendation information store section 108 is omitted and operation of the price influence degree calculating section 106b, the information selecting section 107b, and the control section 110b partially differs from that of the price influence degree calculating section 106, the information selecting section 107, and the control section 110.

The control section 110b starts recommendation information making operation at a prescribed timing as the control section 110 does. In the second embodiment of this invention, the recommendation information making operation is ended when the step S410 has been executed in FIG. 14. Processes corresponding to the step S420 and the later steps are performed when indication-purpose recommendation data is made in a below-mentioned step S170.

Operation of the whole of the network system in the second embodiment of this invention is similar to that in FIG. 11 regarding a relation among processing steps.

According to the second embodiment of this invention, in a step S130 (FIG. 11), a control section 205 in the item providing server 20 makes response data and sends the response data to a terminal device 30. The response data contains information for indicating an operation picture designed to allow the user to adjust price influence degrees.

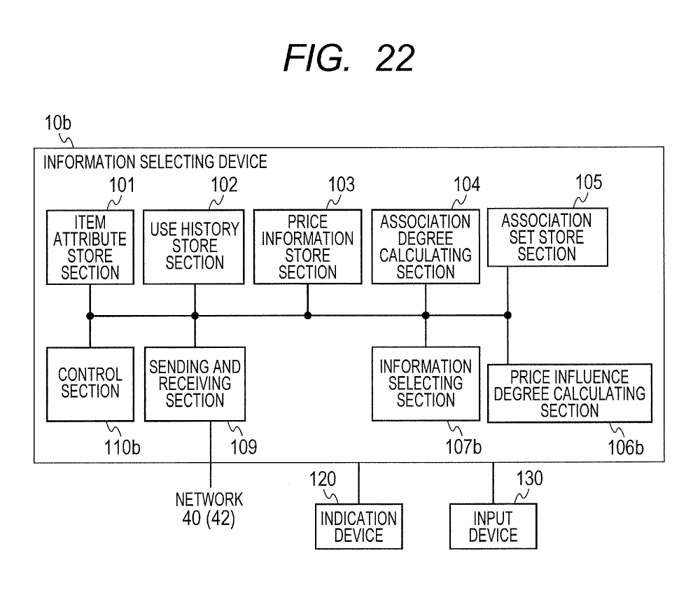

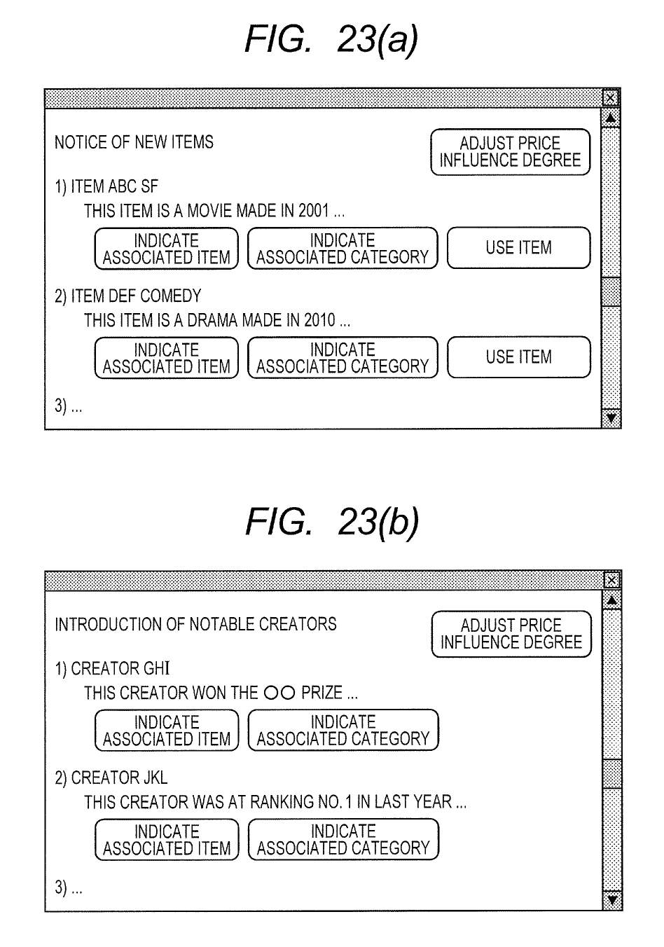

In a step S140 (FIG. 11), the terminal device 30 receives the response data from the item providing server 20, and indicates its information on the indication device 320. FIG. 23(a) shows a first example of the indicated picture. The indicated picture in FIG. 23(a) is similar to that in FIG. 12(a) except that a price influence degree adjusting button is indicated at a right upper portion of the indicated picture.

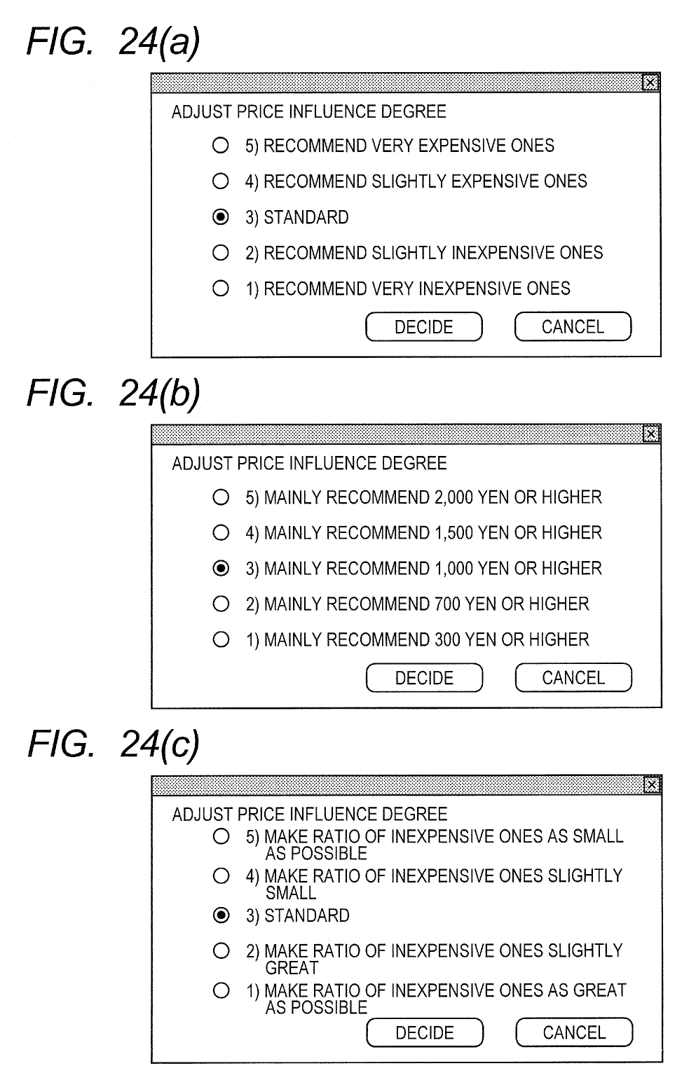

The price influence degree adjusting button is for indicating a GUI (Graphical User Interface) picture designed to allow the user to input data (price influence degree adjustment data) necessary for adjusting price influence degrees. Examples of the GUI picture are shown in FIGS. 24(a), 24(b), and 24(c). Picture changes or movements may be not made, and information in FIGS. 24(a), 24(b), and 24(c) may be contained in the indicated picture in FIG. 23(a).

The example in FIG. 24(a) is a picture designed to allow the user to designate the prices of items or categories to be in a recommendation result. In the picture of FIG. 24(a), circular radio buttons are indicated in correspondence with 5 options. Normally, “standard” denoted by the black circle is chosen. The user can freely choose another option in accordance with user's preference (taste). Numerals “1” to “5” at sides of the radio buttons are IDs for identifying the radio buttons respectively. The terminal device 30 can read the ID number of a radio button chosen by the user.

The example in FIG. 24(b) is a picture designed to allow the user to designate the prices of items or categories to be in a recommendation result. Specifically, the picture of FIG. 24(b) is to allow the user to designate an approximate upper limit on the prices of items or categories to be in a recommendation result.

The example in FIG. 24(c) is a picture designed to allow the user to designate a ratio in number of high-price items or categories to be in a recommendation result. The user can obtain recommendation information, which reflects user's preference about price, by selecting a radio button in one of the pictures of FIGS. 24(a), 24(b), and 24(c) and thereafter selecting an associated link (an associated item indication button or an associated category indication button) in one of the pictures of FIGS. 23(a) and 23(b). The pictures in FIGS. 24(a), 24(b), and 24(c) for operation of adjusting price influence degrees are merely examples. Price influence degrees may be adjusted in another way. For example, a GUI widget such as a slider may be indicated, and the prices of items or categories to be in a recommendation result may be designated by the user via the indicated GUI widget.

In a step S160 (FIG. 11), the terminal device 30 sends a recommendation request to the URL corresponding to the associated link. The recommendation request contains the ID (request base ID) of the category or the item selected in the indicated picture of FIG. 23(a) or FIG. 23(b), link type information representing whether it is an associated item link or an associated category link, and price influence degree adjustment data designated in one of the indicated pictures of FIGS. 24(a), 24(b), and 24(c). For example, the price influence degree adjustment data represents the ID number of a radio button designated by the user among the radio buttons in one of the indicated pictures of FIGS. 24(a), 24(b), and 24(c).

In a step S170 (FIG. 11), a control section of the information selecting device 10b receives the recommendation request via the sending and receiving section 109, and makes indication-purpose recommendation data corresponding to the request base ID contained therein before sending the recommendation data to the terminal device 30.

Specifically, in the step S170, processes corresponding to the steps S420-S440 in FIG. 14 are performed, and thereafter indication-purpose recommendation data is made. In the case where recommendation data is made at the second timing, processes corresponding to the steps S420-S440 are performed after an association set is made (after a step S410 in FIG. 14).

The price influence degree calculating process in the step S420 will be explained below in detail. The control section 110b identifies a base ID equal to the request base ID (the recommendation request) among base IDs in the association set store section 105. The control section 110b reads out an association set (an associated ID or IDs) corresponding to the identified base ID from the association set store section 105. In the presence of plural request base IDs, all association sets corresponding thereto are read out. The association set read out here is referred to as the set Ψ.

Then, the control section 110b obtains price information corresponding to each associated ID in the set Ψ while referring to the price information store section 103. The control section 110b feeds the price influence degree calculating section 106b with the obtained price information and the received price influence degree adjustment data.

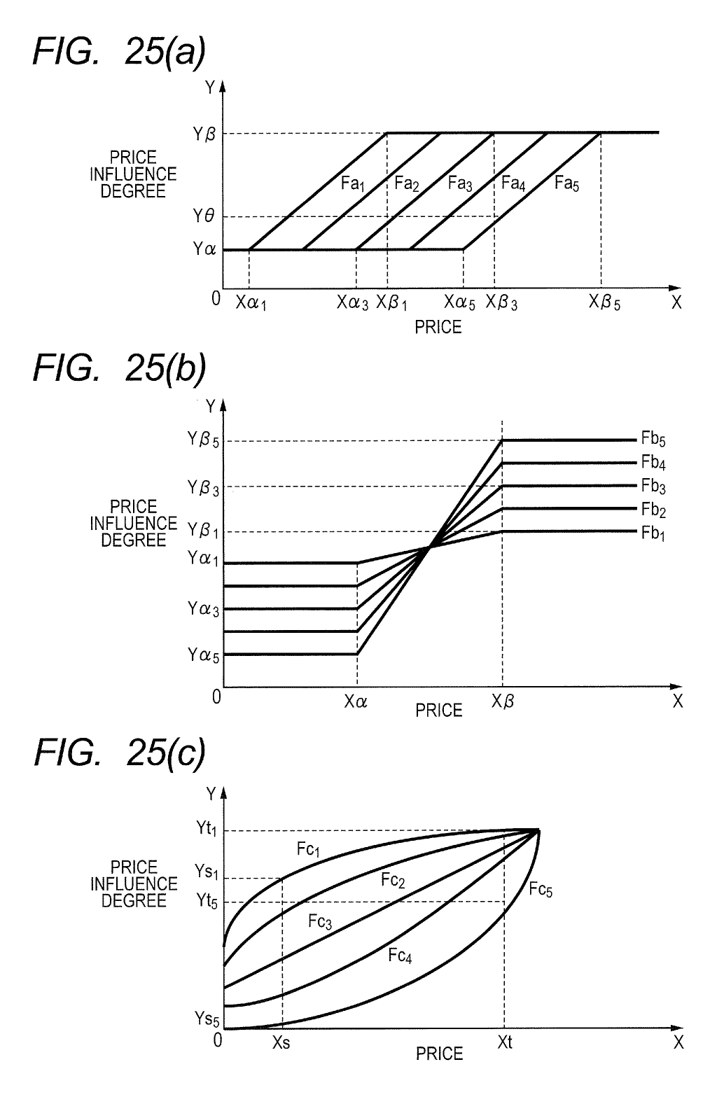

The price influence degree calculating section 106b varies the characteristic of the price influence function F(X) where the price information is used as an input X while the price influence degree is an output Y. The function F(X) means a correspondence rule. As in the first embodiment of this invention, the function F(X) has a monotonically increasing characteristic for a partial interval, and has no monotonically decreasing interval. The function F(X) may be one of the functions in FIGS. 19(a), 19(b), 19(c), 20(a), 20(b), and 20(c). Examples of variations in the characteristic of the price influence function F(X) are shown in FIGS. 25(a), 25(b), and 25(c).

Each function in FIG. 25(a) is similar to the function F2(X) in FIG. 19(b), and there is a combination of a monotonically increasing interval and constant output intervals. FIG. 25(a) shows five functions Fa1-Fa5 each having an inclined portion and flat portions sandwiching the inclined portion. In FIG. 25(a), Xα1-Xα5 denote boundary points (cutoff points) at which constant output intervals are followed by monotonically increasing intervals as the input X increases, and Xβ1-Xβ5 denote boundary points (saturation points) at which the monotonically increasing intervals are followed by constant output intervals as the input X increases. A cutoff point denoted by characters with a suffix of a greater number is greater in price value. A saturation point denoted by characters with a suffix of a greater number is greater in price value.

The characteristics of the functions Fa1-Fa5 are as follows. A function denoted by characters with a suffix of a smaller number tends to output a greater value in response to a small input. An input value for obtaining a prescribed output value (for example, a value Yθ in FIG. 25(a)) tends to be greater in a function denoted by characters with a suffix of a greater number. Thus, when a function denoted by characters with a suffix of a small number is used, a low-price item (category) can easily be in a recommendation result as compared with the case of use of a function denoted by characters with a suffix of a great number. In FIG. 25(a), all the minimum values of output from the functions Fa1-Fa5 are equal to a value Yα, while all the minimum values thereof are equal to a value Yβ. The minimum output value may vary on a function-by-function basis. The maximum output value may vary on a function-by-function basis.

The price influence degree calculating section 106b selects a function to be used from the functions Fa1-Fa5 in response to the price influence degree adjustment data. For example, when “1) recommend very low-price one” is chosen in the price influence degree adjusting picture of FIG. 24(a), the function Fa1 is selected. When “3) standard” is chosen, the function Fa3 is selected. When “5) recommend very high-price one” is chosen, the function Fa5 is selected. Thus, it is good to select a function denoted by characters with a suffix number equal to the ID number of a radio button in FIG. 24(a) which is designated by the user.

Here, “1) recommend very low-price one” does not mean that a recommendation result will be composed of very low-price items (categories) only, but means that a very low-price item or items (category or categories) may be in a recommendation result. The properties that a higher-price item (category) can more easily be in a recommendation result stands good for each of the five options in FIG. 24(a).

Price influence degree adjustment data designated in the price influence degree adjusting picture of FIG. 24(b) and the functions Fa1-Fa5 can be in correspondence. It is good that the value Yα of the functions Fa1-Fa5 is set relatively small, and an approximate lower limit on the prices of items (categories) to be in a recommendation result is made in correspondence with an input value Xα at the cutoff point of each of the functions Fa1-Fa5. For example, in the case of correspondence with the price influence degree adjusting picture of FIG. 24(b), it is good that the cutoff points of the functions Fa1, Fa2, Fa3, Fa4, and Fa5 are set as “Xα1=300 yen”, “Xα2=700 yen”, “Xα3=1000 yen”, “Xα4=1500 yen”, and “Xα5=2000 yen” respectively, and that a function denoted by characters with a suffix number equal to the ID number of a chosen radio button is selected. Each approximate lower limit may be made in correspondence with an input value at a suitable point in a monotonically increasing interval.

Price influence degree adjustment data designated in the price influence degree adjusting picture of FIG. 24(c) and the functions Fa1-Fa5 may be in correspondence. For example, when “1) make a ratio of low-price ones as small as possible” is chosen in the price influence degree adjusting picture of FIG. 24(c), the function Fa1 is selected. It is good to select a function denoted by characters with a suffix number equal to the ID number of a chosen radio button.

FIG. 25(b) shows five functions Fb1-Fb5 used in making the price influence degree adjustment data and the function F(X) in correspondence. Inputs Xα at cutoff points of the functions Fb1-Fb5 are the same while outputs Yαn thereof for the inputs Xα are different. Inputs Xβ at saturation points of the functions Fb1-Fb5 are the same while outputs Yβn thereof for the inputs Xβ are different. Gradients in monotonically increasing intervals in the functions Fb1-Fb5 are different. The gradient of the function Fb1 is the smallest, and that of the function Fb5 is the greatest.

Furthermore, the functions Fb1-Fb5 have the following characteristics. Regarding a function denoted by characters with a greater suffix number, the difference between the maximum output value and the minimum output value (the magnification of the maximum output value relative to the minimum output value) in a prescribed interval is greater. According to a function in which the difference between the maximum value Yβn and the minimum value Yαn or the magnification of the maximum value Yβn relative to the minimum value Yαn is greater, the difference in price influence degree between a low-price item (category) and a high-price item (category) is smaller. Thus, when a function denoted by characters with a small suffix number is used, a low-price item (category) is more easily in recommendation information as compared with the case of use of a function denoted by characters with a great suffix number.

In the case of the functions Fb1-Fb5, it is good to select a function denoted by characters with a suffix number equal to the ID number of a chosen radio button in FIG. 24(a), 24(b), or 24(c). The input Xα at the cutoff point may be varied on a function-by-function basis. The input Xβ at the saturation point may be varied on a function-by-function basis.

FIG. 25(c) shows five functions Fc1-Fc5 used in making the price influence degree adjustment data and the function F(X) in correspondence. The functions Fc1-Fc5 are of a smooth monotonically increasing type. The maximum output values of the functions Fc1-Fc5 are the same. Furthermore, the functions Fc1-Fc5 have the following characteristics. Regarding a function denoted by characters with a greater suffix number, the input value for obtaining a prescribed output value is greater. Regarding a function denoted by characters with a greater suffix, a smaller output value occurs when an input value is the smallest (X=0).

The gradient (differential coefficient) in the function Fc1 for a small input value (Xs) is remarkably greater than that for a large input value (Xt). On the other hand, the gradient (differential coefficient) in the function Fc5 for a small input value (Xs) is remarkably smaller than that for a large input value (Xt). Thus, the degree of upward convex in a function denoted by characters with a smaller suffix number is stronger. The degree of downward convex in a function denoted by characters with a greater suffix number is stronger. Regarding a function denoted by characters with a smaller suffix number, an output value for a small input value (Xs) is closer to the maximum value.

Thus, when a function denoted by characters with a small suffix number is used, a low-price item (category) is more easily in recommendation information as compared with the case of use of a function denoted by characters with a great suffix number. The minimum output value (the output value for X=0) is varied from function to function. The minimum output values in the functions Fc1-Fc5 may be the same. In the case of the functions Fc1-Fc5, it is good to select a function denoted by characters with a suffix number equal to the ID number of a chosen radio button in FIG. 24(a), 24(b), or 24(c).

The functions in FIGS. 25(a), 25(b), and 25(c) are merely examples. A set of functions each having a step-like discrete characteristic such as shown in FIG. 19(c) may be used. A set of smooth functions such as shown in FIG. 20(a), 20(b), or 20(c) may be used. The number of types of price influence degree adjustment data selectable by the user, and the number of types of functions corresponding thereto may be different from 5.

The price influence degree calculating section 106b has a memory area which prestores data representing equations of functions such as the functions Fa1-Fa5, Fb1-Fb5, or Fc1-Fc5. The price influence degree calculating section 106b selects one from the functions in response to the inputted price influence degree adjustment data. Each time an input X is given, the price influence degree calculating section 106b calculates a price influence degree for the input X according to the selected function. Only an equation of a standard function may be stored. In this case, each time an input X and price influence degree adjustment data are given, the price influence degree calculating section 106b makes another function on the basis of the standard function and then calculates a price influence degree for the input X according to the made function. An output Y for a varying input X may be calculated in advance regarding each of the functions before the writing of information about calculation results (X, Y) into the memory area. The characteristic of the price influence function may be set depending on price information of a base ID as in the first embodiment of this invention.

A step S430 (FIG. 14) for calculating selection indexes is approximately the same as that in the first embodiment of this invention. The control section 110b controls the information selecting section 107b to perform the calculation of selection indexes for the set P read out in the step S420 (FIG. 14).

In a step S440 (FIG. 14) for making recommendation information, the information selecting section 107b selects associated IDs from the set P on the basis of the selection indexes calculated in the step S430. Specifically, it is good to use one of the related methods in the first embodiment of this invention. The information selecting section 107b gives recommendation ranks to the selected associated IDs in accordance with the selection indexes thereof.

The step S440 is followed by a step S450 (not shown in FIG. 14). In the step S450, the control section 110b reads out category attribute information and item attribute information corresponding to the associated IDs selected in the step S440 while referring to the item attribute store section 101. The control section 110b makes indication-purpose recommendation data in which the associated item IDs (the associated category IDs), the recommendation ranks, and the item attribute information (the category attribute information) are made in correspondence. The control section 110b sends the indication-purpose recommendation data to the terminal device 30 via the sending and receiving section 109.

According to the first embodiment of this invention, in the step S170, the process is performed while the data in the recommendation information store section 108 is handled as an object to be processed. In the second embodiment of this invention, it is good that in the step S450, a process similar to that in the step S170 is performed while the associated IDs selected in the step S440 are handled as objects to be processed.

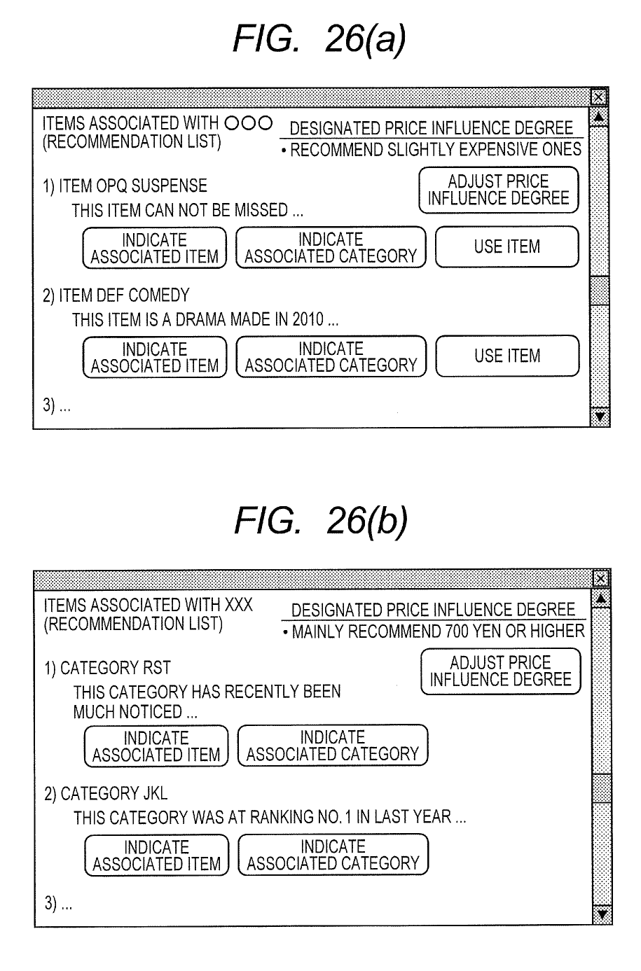

In a step S180 (FIG. 11), the terminal device 30 indicates a picture of a recommendation list in accordance with the indication-purpose recommendation data. The following data may be added to the indication-purpose recommendation data. The added data is designed to indicate a price influence degree adjusting button at a right upper portion of the recommendation list picture as shown in FIG. 26(a) or 26(b). The following data may be added to the indication-purpose recommendation data. The added data is designed to indicate a content (an option) of “designated price influence degree” designed by the user in the price influence degree adjusting operation in the step S140 in the recommendation list picture as shown in FIG. 26(a) or 26(b).

In the second embodiment of this invention, many high-price items and categories can be placed in recommendation information. The second embodiment of this invention provides advantages similar to those provided by the first embodiment thereof. In the second embodiment of this invention, a user who is using a terminal device 30 can adjust the degrees of influence of prices on a recommendation result in accordance with user's preference. Thus, the user easily agrees to and accepts recommendation information. Accordingly, it can be expected that item use based on recommendation information will be brisk and the sales of the item providing service will increase.

### Third Embodiment

A network system in a third embodiment of this invention will be described with reference to drawings. The network system in the third embodiment of this invention is similar to that in the first embodiment thereof except for design changes mentioned hereafter.

The third embodiment of this invention is designed so that the characteristic of a function for calculating price influence degrees can be varied on a user-by-user basis in response to the prices of items used in the past by users of terminal devices 30. An item providing server 20 and terminal devices 30 in the third embodiment of this invention may be similar to those in the first embodiment thereof.

FIG. 27 is a block diagram showing the structure of an information selecting device 10c in the third embodiment of this invention. The information selecting device 10c corresponds to the information selecting device 10 in the first embodiment of this invention. As shown in FIG. 27, the information selecting device 10c includes an item attribute store section 101, a use history store section 102, a price information store section 103, an association degree calculating section 104, an association set store section 105, a price influence degree calculating section 106c, an information selecting section 107c, a sending and receiving section 109, a control section 110c, a use price information calculating section 111, and a use price information store section 112. An indication device 120 and an input device 130 are connected to the information selecting device 10c. The indication device 120 serves to indicate necessary information to a manager about the information selecting device 10c. The input device 130 is, for example, a keyboard or a mouse operated by the manager.

The information selecting device 10c differs from the information selecting device 10 in that the recommendation information store section 108 is omitted, and the use price information calculating section 111 and the use price information store section 112 are added. Operation of the price influence degree calculating section 106c, the information selecting section 107c, and the control section 110c partially differs from that of the price influence degree calculating section 106, the information selecting section 107, and the control section 110.

The control section 110c starts recommendation information making operation at a prescribed timing as the control section 110 does. In the third embodiment of this invention, a step S410 in FIG. 14 is followed by a step S415 not shown, and the recommendation information making operation is ended when the step S415 has been executed. Processes corresponding to the step S420 and the later steps are performed when indication-purpose recommendation data is made in a below-mentioned step S170.

According to the third embodiment of this invention, in the step S415, the use price information calculating section 111 receiving a command from the control section 110c calculates, for each user, use price information being information about the prices of items which were used by the user while referring to the use history store section 102.

The use price information calculating section 111 reads out all use histories from the use history store section 102. Only use histories satisfying a prescribed condition may be read out in a way similar to the use history read-out process in the step S500 of FIG. 15.

For each of the users corresponding to the read-out use histories, the use price information calculating section 111 calculates use price information. For example, a price level value resulting from indexing the prices of items used in the past by the user or a price dispersion value resulting from indexing variations in the prices of items used in the past by the user can be used as use price information. The use price information calculating section 111 calculates one or more of first use price information to sixth use price information mentioned below.

The first use price information represents a first price level value equal to the total value (sum value) of the prices of items used by the user. In the case of calculation of the first price level value, the use price information calculating section 111 identifies items used by a certain use subject ID (a certain user) while referring to the read-out use histories. Then, the use price information calculating section 111 calculates the total value of the prices of the identified items while referring to the price information store section 103. Subsequently, the use price information calculating section 111 labels the calculated total value as the first price level value corresponding to the use subject ID. A user with a great first price level value can be guessed to be a user having a high purchasing power. The first price level value may be equal to the total value multiplied or divided by a prescribed value. For example, in the case where the number of digits of the total value is large, the first price level value may be equal to the total value divided by a prescribed value so as to be expressed by an easily handleable number of digits. Normalization may be done so that the maximum value of the first use price information will be “1”.

The second use price information represents a second price level value equal to a value (representative value) of the price per item used by the user. In the case of calculation of the second price level value, the use price information calculating section 111 identifies items used by a certain use subject ID (a certain user) while referring to the read-out use histories. Then, the use price information calculating section 111 derives a distribution of the prices of the identified items while referring to the price information store section 103. Subsequently, the use price information calculating section 111 calculates a representative value in the derived distribution, and labels the calculated representative value as the second price level value corresponding to the use subject ID. The representative value is, for example, the mean, the median, the mode, the quartile, the maximum, or the minimum. The representative value may be calculated in a method including a weighting process designed so that the identified items will be weighted depending on number of times of item use, for example, an identified item larger in number of times of its use will be given a greater weight. A user with a great second price level value can be guessed to be a user who likes high-price items and high-class items. The second price level value is suited to the case where the prices of items are distributed over a wide range.

The third use price information represents a third price level value equal to a representative value related to the total value of the prices of items used by the user for each prescribed time interval. The third price level value is based on the total value of the prices of items used by the user. The prescribed time interval is, for example, 1 day, 1 week, or 1 month. In the case of item providing service such that a plurality of items can be used (purchased) at one time, the representative value may relate to the total value of the prices of items used at one time rather than the total value of the prices of items used for each prescribed time interval.

In the case of calculation of the third price level value, the use price information calculating section 111 identifies items used by a certain use subject ID (a certain user) for each prescribed time interval while referring to the read-out use histories. Then, the use price information calculating section 111 calculates the total value of the prices of the identified items for each prescribed time interval while referring to the price information store section 103. Subsequently, the use price information calculating section 111 calculates a representative value of the calculated total values. The use price information calculating section 111 labels the calculated total value as the third price level value corresponding to the use subject ID. The representative value may be similar to that concerning the second price level value.

The third price level value is suited to judging the purchasing power of a user without being affected by the length of a time interval for which the user continues to use the item providing service. The third price level value is suited to the case where the prices of items are in a narrow range or the prices of many items are approximately similar.

The fourth use price information represents a first price variance value equal to a value representing the magnitude of variations (the variation degree) in the prices of items used by the user. In the case of calculation of the first price variance value, the use price information calculating section 111 identifies items used by a certain use subject ID (a certain user) while referring to the read-out use histories. Then, the use price information calculating section 111 derives a distribution of the prices of the identified items, and calculates a value representing the degree of item price variations from the derived distribution. The use price information calculating section 111 labels the calculated value as the first price variance value corresponding to the use subject ID. The variation degree representing value is, for example, the variance, the standard deviation, the range (the maximum minus minimum), or the quantile range (the third quantile minus the first quantile).

A user with a great first price variance value can be guessed to be a user who uses items having various prices. The first price variance value is suited to the case where the prices of items are distributed over a wide range.

The fifth use price information represents a second price variance value equal to a value representing the magnitude of time-domain variations (the variation degree) in the total value of the prices of items used by the user. The total value is, for example, that for each prescribed time interval. Specifically, in the case of calculation of the second price variance value, the use price information calculating section 111 identifies items used by a certain use subject ID (a certain user) for each prescribed time interval while referring to the read-out use histories. Then, the use price information calculating section 111 calculates the total value of the prices of the identified items for each prescribed time interval, and calculates a value representing the variation degree from the calculated total value. The use price information calculating section 111 labels the calculated variation degree representing value as the second price variance value corresponding to the use subject ID. The variation degree representing value is similar to that concerning the first price variance value. The total value per one-time use (purchase) may be calculated, and a value representing the variation degree thereof may be calculated before the calculated variation degree representing value will be labeled as the second price variance value.

The second price variance value is suited to the case where the prices of items are in a narrow range or the prices of many items are approximately similar. A user with a small second price variance value can be guessed to be a user who constantly and stably uses items.

In the above-mentioned methods, the first use price information to the fifth use price information are calculated by using items used by a certain use subject ID (a certain user), specifically use histories regarding the certain user only. The first use price information to the fifth use price information may be calculated by use histories regarding not only the certain user but also other users. Thus, the use price information for the certain user may be calculated on the basis of the prices of items used by the certain user and other users.

For example, in the case where the use histories read out from the use history store section 102 contain Nu use subject IDs, the use price information calculating section 111 calculates the total value Ps[u] (u=1˜Nu) of the prices of items for each of the Nu use subject IDs. Then, the use price information calculating section 111 calculates the mean Pa and the standard deviation Pb of the total values Ps[u]. Subsequently, the use price information calculating section 111 calculates a standard score S[u] for the user “u” according to the following equation (10).

$$S [ u ] = \frac{Ps [ u ] - Pa}{Pb} \qquad ( 10 )$$

The use price information calculating section 111 may calculate a deviation instead of the standard score S[u]. The calculated standard score or deviation is used as sixth use price information corresponding to the first use price information.

The sixth use price information represents the relative position at which the total value of the prices of items used by a certain user (user “u”) is located in a group of the total values regarding users. Concerning the second use price information to the fifth use price information, relative values in a group of users may be calculated.

The use price information calculating section 111 may calculate use price information for each of items classes with respect to a certain use subject ID. The item classes result from classifying items according to a prescribed criterion. In general, the item classes are generic to the categories. For example, in the case where the item providing service provides various contents, upper layer classes such as “music”, “movie”, and “book” are defined as item classes. Regarding items in the item class of “music”, genres such as “rock”, “jazz”, “classic”, and “folk” are defined as categories. Regarding items in the item class of “movie”, genres such as “SF”, “action”, “comedy”, “animation”, and “suspense” are defined as categories.

In this case, the item attribute store section 101 prestores item class information in which items (or categories) and item classes are made in correspondence. The use price information calculating section 111 identifies item classes of items used by the user while referring to the item class information. The use price information calculating section 111 calculates use price information for each of the identified item classes. For example, the use price information calculating section 111 calculates use price information for “music”, use price information for “movie”, and use price information for “book”. The categories may be used as the item classes.

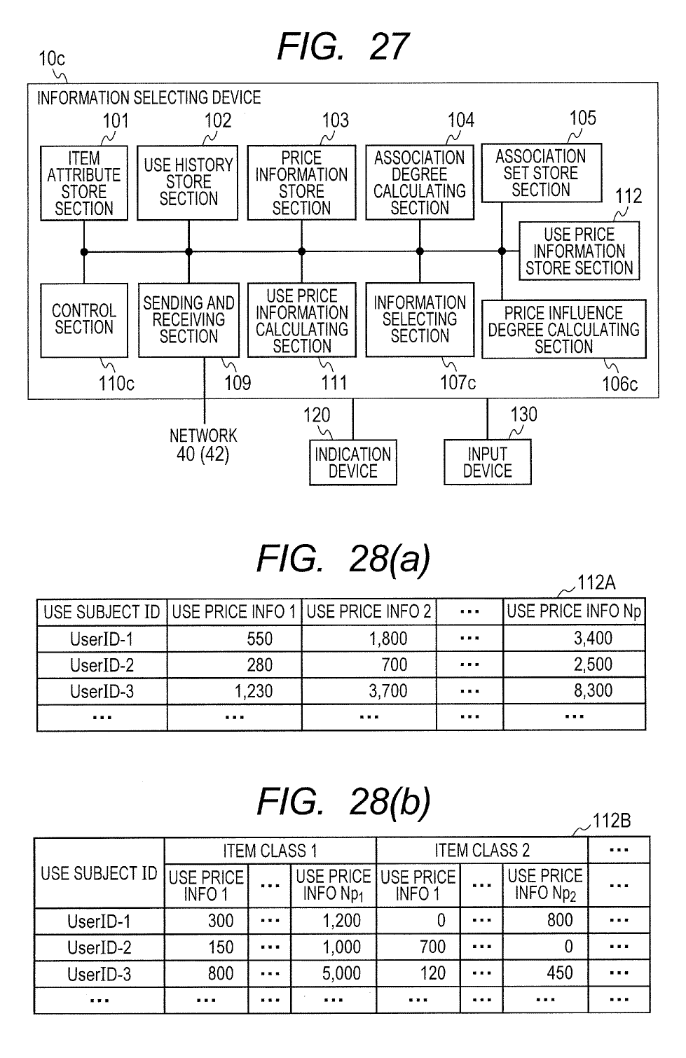

The use price information calculating section 111 stores the calculated use price information into the use price information store section 112. The use price information store section 112 stores the use subject IDs and the use price information in a form such as shown in FIG. 28(a) or 28(b) while making them in correspondence.

FIG. 28(a) shows a use price information table 112A of a store form used in the case where the item classes are not used. Plural types (Np types) of the use price information are stored therein. Only one type of the use price information may be stored therein.

FIG. 28(b) shows a use price information table 112B of a store form used in the case where the item classes are used. Np1 pieces of the use price information for the item class 1, and Np2 pieces of the use price information for the item class 2 are stored therein. It may be good that Np1≠Np2. In this case, the number of pieces of the stored use price information depends on item class.

The above description is of the processes performed in the step S415. These processes are implemented by the use price information calculating section 111.

Operation of the whole of the network system in the third embodiment of this invention is similar to that in FIG. 11 regarding a relation among processing steps. Steps S160 and S170 (FIG. 11) in the third embodiment of this invention are modified from those in the first embodiment thereof as will be made clear below.

In the step S160 (FIG. 11), a terminal device 30 sends a recommendation request to a URL corresponding to an associated link. In the third embodiment of this invention, a use subject ID must be in each recommendation request. The use subject ID corresponds to a use subject identifier relating to the base identifier in claim 2 indicated later.

In the step S170 (FIG. 11), the control section 110c of the information selecting device 10c receives the recommendation request via the sending and receiving section 109, and makes indication-purpose recommendation data corresponding to the request base ID contained therein before sending the recommendation data to the terminal device 30. The details of processes in the step S170 are as follows.

In the step S170, indication-purpose recommendation data is made in a step S450 (not shown) after processes corresponding to the steps S420-S440 in FIG. 14 are performed. In the case where recommendation information is made at the second timing, it is good that the steps S420-S440 are executed after use price information is calculated (after the step S415). The steps S430, S440, and S450 are the same as those in the second embodiment of this invention.

The details of a price influence degree calculating process in the step S420 are as follows. In the step S420, the control section 110c identifies a base ID equal to the request base ID (the recommendation request) among base IDs in the association set store section 105. The control section 110c reads out an association set (an associated ID or IDs) corresponding to the identified base ID from the association set store section 105. In the presence of plural request base IDs, all association sets corresponding thereto are read out. The association set read out here is referred to as the set Ψ.

Then, the control section 110c obtains price information corresponding to each associated ID in the set Ψ while referring to the price information store section 103. The control section 110c feeds the price influence degree calculating section 106c with the obtained price information and the use subject ID in the received use request. In the case where the use price information store section 112 stores the use price information table 112B in FIG. 28(b) which has the use price information for each of the item classes, the control section 110c identifies the item class corresponding to the associated ID while referring to the item information table 101A in the item attribute store section 101. The control section 110c notifies the identified item class to the price influence degree calculating section 106c.

The price influence degree calculating section 106c varies the characteristic of a price influence function F(X) in accordance with the fed use subject ID while referring to the use price information store section 112. Regarding the function F(X), the price information is used as an input X while the price influence degree is an output Y. The function F(X) means a correspondence rule. As in the first embodiment of this invention, the function F(X) has a monotonically increasing characteristic for a partial interval, and has no monotonically decreasing interval. The function F(X) may be one of the functions in FIGS. 19(a), 19(b), 19(c), 20(a), 20(b), and 20(c).

The price influence degree calculating section 106c reads out use price information corresponding to the fed use subject ID from the use price information store section 112. In the case where the use price information store section 112 stores the use price information table 112B in FIG. 28(b), the price influence degree calculating section 106c reads out use price information corresponding to both the fed use subject ID and the fed item class.

It is assumed that the use price information store section 112 stores one price level value L[u] for a user “u” and one price variance value V[u] for the user “u”, and they are read out before being used. Either the price level value L[u] or the price variance value V[u] may be used. The characteristic of the function F(X) may be decided by using three or more types of the use price information.

Methods of deciding the characteristic of the function F(X) will be explained below with reference to FIGS. 25(a), 25(b), and 25(c).

FIG. 25(a) shows five functions Fa1-Fa5. The characteristics of the functions Fa1-Fa5 are as follows. A function denoted by characters with a greater suffix number provides a prescribed output value in response to a greater input value. A function denoted by characters with a greater suffix number outputs a smaller value in response to a prescribed input value. Regarding each of the functions Fa1-Fa5, the output value is equal to a small constant Yα for the range of X≦Xα. Items (categories) corresponding to this range tend to be less contained in recommendation information. Regarding a function denoted by characters with a greater suffix number, the value Xα is greater. Regarding each of the functions Fa1-Fa5, the output value is equal to a large constant Yβ for the range of X≧Xβ. Items (categories) corresponding to this range tend to be more contained in recommendation information. Regarding a function denoted by characters with a greater suffix number, the value Xβ is greater.

The price influence degree calculating section 106c selects one from the functions Fa1-Fa5 in response to the price level value L[u] for the user “u”. Specifically, threshold values δ1, δ2, δ3, and δ4 (δ1<δ2<δ3<δ4) are prepared for the price level value L[u] in advance. When L[u]<δ1, the function Fa1 is selected. When δ1≦L[u]<δ2, the function Fa2 is selected. When δ2≦L[u]<δ3, the function Fa3 is selected. When δ3≦L[u]<δ4, the function Fa4 is selected. When δ4≦L[u], the function Fa5 is selected. Thus, a function denoted by characters with a greater suffix number is selected as the price level value L[u] is greater. Thereby, the characteristic of the price influence function F(X) is varied so that an input value to obtain a prescribed output value will increase as the price level value L[u] is greater.

Thus, the third embodiment of this invention has the following advantages. High-price items (categories) are more easily recommended to any user than low-price items (categories) if the association degrees are approximately equal. For a user corresponding to a small price level value, that is, a user having a low purchasing power or a user frequently using low-price items, low-price items (categories) are relatively easily contained in a recommendation result.

FIG. 25(b) shows five functions Fb1-Fb5. The characteristics of the functions Fb1-Fb5 are as follows. A function denoted by characters with a greater suffix number provides a greater difference between the maximum output value Yβ and the minimum output value Yα (a greater magnification of the maximum output value Yβ relative to the minimum output value Yα).

The price influence degree calculating section 106c selects one from the functions Fb1-Fb5 in response to the price level value L[u] for the user “u”. Specifically, threshold values δ1, δ2, δ3, and δ4 (δ<δ<δ3<δ4) are prepared for the price level value L[u] in advance. When L[u]<δ1, the function Fb1 is selected. When δ1≦L[u]<δ2, the function Fb2 is selected. When δ2≦L[u]<δ3, the function Fb3 is selected. When δ3≦L[u]<δ4, the function Fb4 is selected. When δ4≦L[u], the function Fb5 is selected. Thus, a function denoted by characters with a greater suffix number is selected as the price level value L[u] is greater. Thereby, the characteristic of the price influence function F(X) is varied so that the difference between the maximum output value and the minimum output value (the magnification of the maximum output value relative to the minimum output value) will increase as the price level value L[u] is greater. Thus, it is possible to provide the advantage that low-price items (categories) are relatively easily contained in a recommendation result for a user corresponding to a small price level value.

One may be selected from the functions Fb1-Fb5 in response to a price variance value V[u] for the user “u”. Similar to the case of the price level value L[u], threshold values ε1, ε2, ε3, and ε(ε1<ε2<ε3<ε4) are prepared for the price variance value V[u] in advance. A function denoted by characters with a greater suffix number is selected as the price variance value V[u] is greater. Thus, the characteristic of the price influence function F(X) is varied so that the difference between the maximum output value and the minimum output value (the magnification of the maximum output value relative to the minimum output value) will increase as the price variance value V[u] is greater. The characteristic of the price influence function F(X) may be varied so that the output value for the minimum input value will decrease as the price variance value V[u] is greater.

One may be selected from the functions Fa1-Fa5 as follows. A function denoted by characters with a greater suffix number is selected as the price variance value V[u] is greater. Thereby, the characteristic of the price influence function F(X) may be varied so that an input value to obtain a prescribed output value will be greater as the price variance value V[u] is greater.

In general, a user corresponding to a small price variance value tends to use items in a limited price range. Regarding a user corresponding to a small price variance value, the total value of the prices of items used in each prescribed time interval tends to be stable. Such a user is said to be a user having one's own use pattern. There is a higher risk that such a user will refuse the recommendation of only high-price items. Accordingly, the function Fb1 or another is used so that the difference in price influence degree between a high-price item and a low-price item will be not so great, and hence low-price items (categories) will easily be in a recommendation result.

FIG. 25(c) shows five functions Fc1-Fc5. A function denoted by characters with a greater suffix number may be selected from the functions Fc1-Fc5 as the price level value L[u] for the user “u” is greater. Thus, the characteristic of the price influence function F(X) may be varied so that the degree of downward convex will increase as the price level value L[u] is greater. The characteristic of the price influence function F(X) may be varied so that the output value for the minimum input value will decrease as the price level value L[u] is greater. A function denoted by characters with a greater suffix number may be selected from the functions Fc1-Fc5 as the price variance value V[u] for the user “u” is greater.

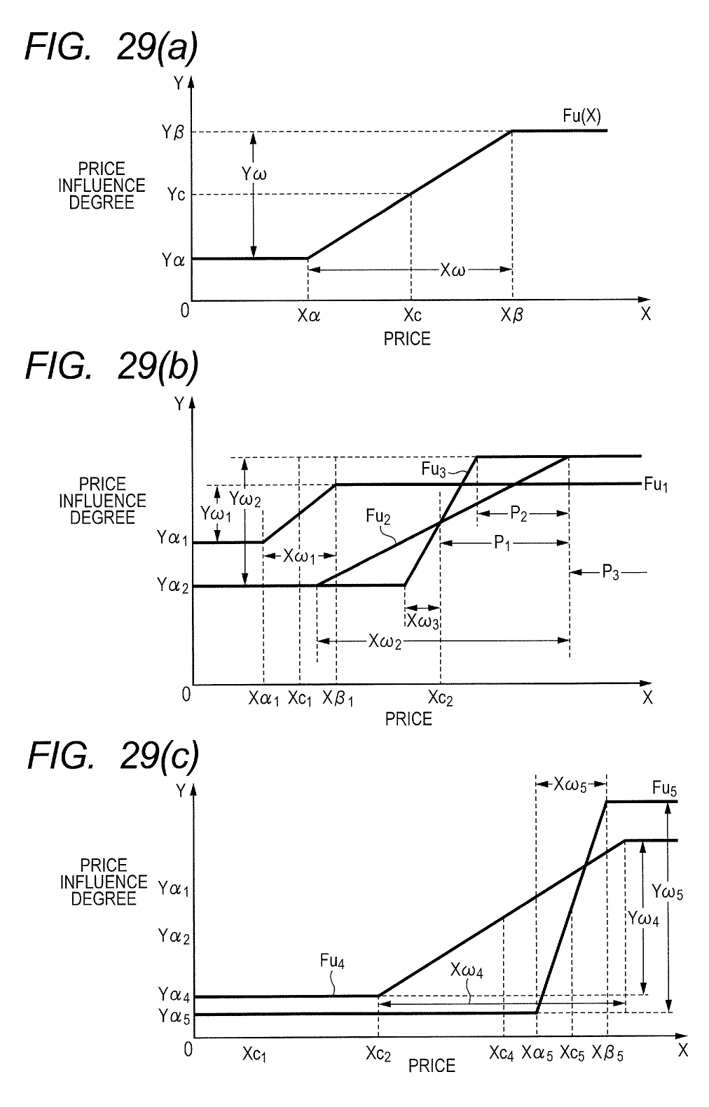

With reference to FIGS. 29(a), 29(b), and 29(c), a description will be given of a method of dynamically setting the characteristic of the function F(X) by using both the price level value L[u] and the price variance value V[u] for the user “u”. The price influence degree calculating section 106c has an internal memory area storing data representative of an equation of a model function Fu(X) having a characteristic shown in FIG. 29(a). The price influence degree calculating section 106c sets parameters Xc, Xω, Yα, and Yω of the model function Fu(X) in response to the price level value L[u] and the price variance value V[u], and then calculates the price influence degree. Here, Xc denotes the X-direction middle point in a monotonically increasing interval, and Xω denotes the X-direction width of the monotonically increasing interval. Furthermore, Yα denotes the minimum output value in the monotonically increasing interval, and Yω denotes the Y-direction width of the monotonically increasing interval.

First, the price influence degree calculating section 106c sets the parameter Xc greater as the price level value L[u] is greater. The price influence degree calculating section 106c sets the parameter Xω greater as the price variance value V[u] is greater. Consequently, the minimum input value Xα and the maximum input value Xβ in the monotonically increasing interval are set.

Next, the price influence degree calculating section 106c sets the parameter Yα greater as the price level value L[u] is smaller. The price influence degree calculating section 106c sets the parameter Yω greater as the price variance value V[u] is greater. Consequently, the maximum output value Yβ in the monotonically increasing interval is set.

FIGS. 29(b) and 29(c) show the characteristics of functions Fu1(X), Fu2(X), Fu3(X), Fu4(X), and Fu5(X) for users u1, u2, u3, u4, and u5 respectively. The function Fu1(X) is the model function Fu(X) having the above parameters set for the user u1. The function Fu2(X) is the model function Fu(X) having the above parameters set for the user u2. The function Fu3(X) is the model function Fu(X) having the above parameters set for the user u3. The function Fu4(X) is the model function Fu(X) having the above parameters set for the user u4. The function Fu5(X) is the model function Fu(X) having the above parameters set for the user u5.

The user u1 uses low-price items only, and hence corresponds to the smallest price level value L[u1] among those regarding the five users u1-u5 and corresponds to a small price variance value V[u1]. As shown in FIG. 29(b), concerning the function Fu1(X) corresponding to the user u1, the values Xc1, Xα1, Xβ1, Xω1, and Yω1 (Xc, Xα, Xβ, Xω, and Yω) are small while the value Yα1 (Yα) is great. Thus, the difference (magnification) in price influence degree between a high-price item and a low-price item is small so that low-price items are the most easily contained in a recommendation result for the user u1 among the five users u1-u5.

The user u2 uses low-price items more than high-price items, and hence corresponds to the second smallest price level value L[u2] among those regarding the five users u1-u5 and corresponds to a great price variance value V[u2]. As shown in FIG. 29(b), concerning the function Fu2(X) corresponding to the user u2, the parameters Xc2, Xω2, Yα2, and Yω2 (Xc, Xω, Yα, and Yω) satisfy conditions as Xc1<Xc2, Xω1<Xω2, Yα2<Yα1, and Yω1<Yω2. Thus, the difference (magnification) in price influence degree between a high-price item and a low-price item is greater than that regarding the function Fu1(X). Therefore, as compared with the user u1, low-price items are less contained in a recommendation result for the user u2.

The user u3 uses middle-price items only, and hence corresponds to a price level value L[u3] equal to the price level value L[u2] for the user u2 and corresponds to a price variance value V[u3] smaller than the price variance value V[u2] for the user u2. As shown in FIG. 29(b), concerning the function Fu3(X) corresponding to the user u3, the parameters Xc3, Xω3, Yα3, and Yω3 (Xc, Xω, Yα, and Yω) satisfy conditions as Xc2=Xc3, Xω3<Xω2, Yα2=Yα3, and Yω2=Yω3. Therefore, as compared with the user u2, items having prices in a range (the range P1 in FIG. 29(b)) corresponding to output values greater than those in the function Fu2 are more easily contained in a recommendation result for the user u3.

For the user u2, items having prices in a range (the range P2 in FIG. 29(b)) where the function Fu3 takes the maximum output value and the function Fu2 monotonically increases are less contained in a recommendation result than items having prices higher than the foregoing range are. On the other hand, for the user u3, items having prices in the foregoing range are contained in a recommendation result similarly to items having prices higher than the foregoing range.

The user u3 originally corresponds to a narrow range of the prices of used items. Thus, the user u3 may refuse the recommendation of items in a high price range only. There is a high possibility that the user u3 will accept a recommendation result having items including not only those in the high price range P3 but also those in the price range P2 slightly lower than the high price range P3. On the other hand, the user u2 originally uses items in a wide price range, and less sticks to items in a particular price range than the user u3 does. There is a high possibility that the user u2 will accept the recommendation of items in the high price range P3. Thus, a recommendation result containing items in the price range P3 more than items in the price range P2 is effective to the user u2 in a point of an increase in the sales of the item providing service.

In the third embodiment of this invention, the width of the monotonically increasing interval is varied in accordance with the price variance value. Therefore, the contents of recommendation information can be properly changed for users similar in price level value.

The user u4 uses not only low-price items but also high-price items. Specifically, the user u4 uses high-price items more than low-price items, and hence corresponds to the second greatest price level value L[u4] among those regarding the users u1-u5 and corresponds to a price variance value V[u4] similar to the price variance value V[u2] for the user u2. As shown in FIG. 29(c), concerning the function Fu4(X) corresponding to the user u4, the parameters Xc4, Xω4, Yα4, and Yω4 (Xc, Xω, Yα, and Yω) satisfy conditions as Xc2<Xc4, Xω1<Xω2≅Xω4, Yα4<Yα2, and Yω2<Yω4. Thus, the difference (magnification) in price influence degree between a high-price item and a low-price item is greater than that regarding the function Fu2(X). Therefore, as compared with the user u2, low-price items are less contained in a recommendation result for the user u4.

The user u5 uses high-price items only, and hence corresponds to the greatest price level value L[u5] among those regarding the five users u1-u5 and corresponds to a small price variance value V[u5] similar to the price variance value V[u1] for the user u1. As shown in FIG. 29(c), concerning the function Fu5(X) corresponding to the user u5, the parameters Xc5, Xω5, Yα5, and Yω5 (Xc, Xω, Yα, and Yω) satisfy conditions as Xc5<Xc4, Xω1≅Xω5<Xω4, Yα5<Yα4, and Yω4<Yω5. Thus, the difference (magnification) in price influence degree between a high-price item and a low-price item is very great. Therefore, among the five users u1-u5, low-price items are the least contained in a recommendation result for the user u5. The values in the function Fu5(X) and those in the function Fu1(X) for the user u1 are in a relation as Xα1<<Xα5, Xβ1<<Xβ5, Yα1>>Yα5, and Yβ1<<Xβ5. Therefore, as compared with a user corresponding to a small price level value, high-price items are easily contained in a recommendation result for the user u5.

In the third embodiment of this invention, the characteristic of the function F(X) is set on a user-by-user basis in response to the use price information. Thereby, high-price items can preferentially be contained in a recommendation result. For a user who mainly uses low-price items, low-price items can also be contained in a recommendation result. The functions Fu(X), and Fu1-Fu5 in FIGS. 29(a), 29(b), and 29(c) are merely examples. Functions having other characteristics may be used instead thereof.

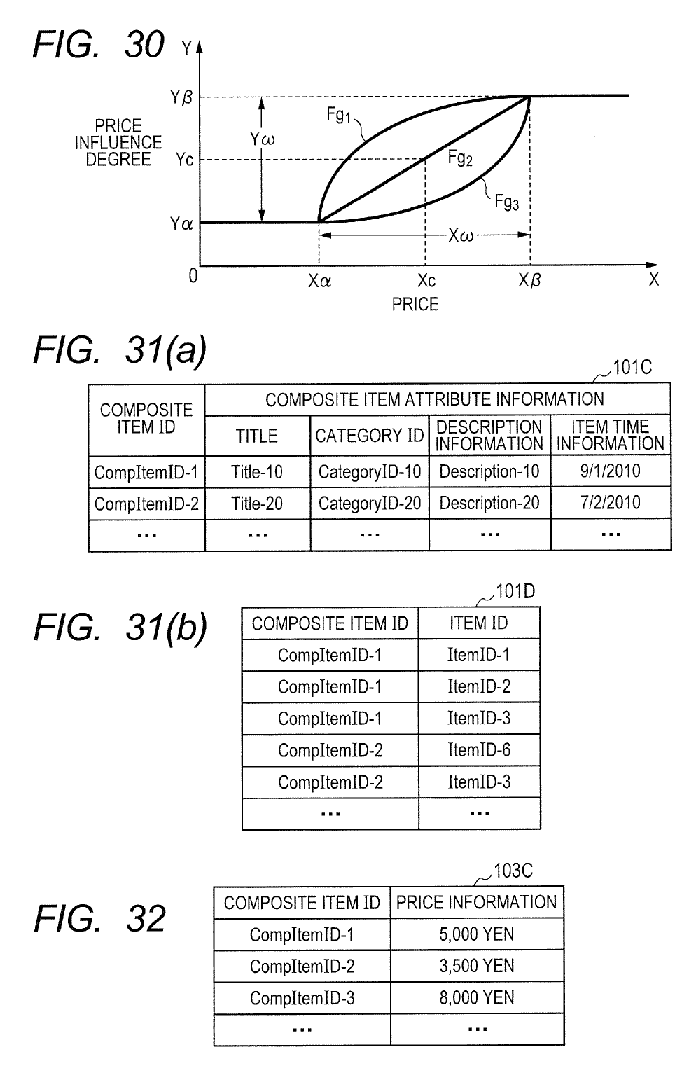

A model function Fg(X) may replace the model function Fu(X) for calculation of price influence degrees. In this case, parameters Xc, Xω, Yα, and Yω of the model function Fg(X) are set in response to the price level value L[u] and the price variance value V[u], and then the price influence degree is calculated according to the model function Fg(X) having the set parameters. Furthermore, when the price level value is small, the parameters Xc, Xω, Yα, and Yω are set so that the model function Fg(X) will be a function Fg1 in FIG. 30 which has a high degree of upward convex. When the price level value is intermediate, the parameters Xc, Xω, Yα, and Yω are set so that the model function Fg(X) will be a function Fg2 in FIG. 30 which has an linearly increasing interval. When the price level value is large, the parameters Xc, Xω, Yα, and Yω are set so that the model function Fg(X) will be a function Fg3 in FIG. 30 which has a high degree of downward convex.

As mentioned above, the characteristic of the function F(X) is set in response to one price level value and one price variance value. The characteristic of the function F(X) may be set in response to more types of use price information. Plural types of use price information may be made in correspondence with the parameters of the function F(X), respectively. Plural types of use price information may be made in correspondence with only one of the parameters of the function F(X). For example, a value (representative value) representing the price per item used by a user is labeled as second use price information, and a representative value relating to the total value of the prices of items used by a user is labeled as third use price information. In this case, one of the parameters of the function F(X) is decided in response to the second use price information and the third use price information.

In the case where each of the parameters of the function F(X) is decided in response to plural types of use price information, a multidimensional information space may be used in which the types of use price information are made in correspondence with the dimensions respectively. For example, the characteristic of the function F(X) may be set in a method of dividing the multidimensional information space into small spaces, and making values of the parameters of the function F(X) correspond to each of the small spaces. A one-dimensional value may be calculated by using a weighted average of plural types of use price information, and the parameters of the function F(X) may be decided on the basis of the calculated one-dimensional value.

In the third embodiment of this invention, the characteristic of the price influence function F(X) can be set in response to price information of the base ID as in the first embodiment thereof. For example, the characteristic of the function Fu(X) in FIG. 29(a) may be set according to a rule such that the value Xc will increase as the price level value L[u] increases and the price information (price) of the base ID increases. The characteristic of the function Fg(X) may be set according to a first rule such that the degree of downward convex will increase as the price level value L[u] increases and the price information (price) of the base ID increases, and a second rule such that the degree of upward convex will increase as the price level value L[u] decreases and the price information (price) of the base ID decreases.

The above description is of the price influence degree calculating process in the step S420.

The third embodiment of this invention provides advantages similar to those provided by the first embodiment thereof. One of the advantages is that high-price items and categories can be more contained in a recommendation result. In the third embodiment of this invention, since proper price influence degrees are calculated from use price information for each user, recommendation information easily acceptable by the user can be provided without requiring the user to do special action. For example, with respect to a user who uses low-price items only, high-price items and some low-price items can be contained in recommendation information. Thus, the user can easily agree to and accept the recommendation information. Accordingly, it can be expected that item use based on recommendation information will be brisk and the sales of the item providing service will increase.

The third embodiment of this invention may be combined with the second embodiment thereof so that the price influence function will be set in response to use price information for each user, and the characteristic of the price influence function will be varied in accordance with use's preference. In this case, it is possible to provide recommendation information more easily acceptable by the user.

### Fourth Embodiment

A network system in a fourth embodiment of this invention will be described with reference to drawings. The network system in the fourth embodiment of this invention is similar to that in the first embodiment thereof except for design changes mentioned hereafter. The network system in the fourth embodiment of this invention is effective to item providing service designed to provide items of two types, that is, stand-alone items and composite items. Each of the stand-alone items means a normal item. One composite item has a plurality of stand-alone items (normal items). When a user performs operation of using (purchasing) a composite item once, the contents of stand-alone items therein are provided to the user.

For example, in the case of providing music contents, music pieces are handled as stand-alone items while albums each consisting of music pieces are handled as composite items. A set of music pieces by a certain artist may be handled as a composite item. In the case of proving video contents, the episodes of a serial drama are handed as stand-alone items while the serial drama is handled as a composite item. In the case of providing books (paper books or electronic books), volumes of a corpus are handled as stand-alone items while the corpus is handled as a composite item.

An item providing server 20 and terminal devices 30 in the fourth embodiment of this invention may be similar to those in the first embodiment thereof. The item providing server 20 is designed to provide not only stand-alone items but also composite items. An information selecting device 10 in the fourth embodiment of this invention is similar to that in the first embodiment thereof except that an item attribute store section 101, an information selecting section 107, and a control section 110 (FIG. 3) are modified from those in the first embodiment.

The item attribute store section 101 stores an item information table 101A of FIG. 4(a), a category information table 101B of FIG. 4(b), a composite item information table 101C of FIG. 31(a), and an inter-item relation table 101D of FIG. 31(b). The inter-item relation table 101D indicates a correspondence (relation) between composite items and stand-alone items.

As shown in FIG. 31(a), the composite item information table 101C makes composite item identifiers (composite item IDs) and composite item attribute information in correspondence. The composite item attribute information is composed of “titles”, “category identifiers (category IDs)”, “description information”, “item time information”, and others of composite items.

The item information table 101A stores information about stand-alone items. The composite item information table 101C stores information about composite items. Thus, it is possible to easily determine which of a stand-alone item and a composite item an item ID corresponds to by judging whether the item ID is in the item information table 10A or the composite item information table 101C.

In the first to fourth embodiments of this invention, stand-alone items and composite items may be handled without being discriminated. The information selecting device 10, 10b, or 10c in each of the first to fourth embodiments of this invention may handle not only stand-alone items but also composite items. Alternatively, the information selecting device 10, 10b, or 10c may handle stand-alone items only. The information selecting device 10, 10b, or 10c may handle composite items only. The first to fourth embodiments of this invention may use the previously-mentioned examples of composite items and stand-alone items.

The inter-item relation table 101D indicates a correspondence (relation) between composite items and stand-alone items. The inter-item relation table 101D stores composite item IDs and stand-alone item IDs while making them in correspondence. In FIG. 31(a), a composite item having an ID of “CompItemID-1” corresponds to three stand-alone items, and a composite item having an ID of “CompItemID-2” corresponds to two stand-alone items. A stand-alone item having an ID of “ItemID-3” corresponds to both the composite item having an ID of “CompItemID-1” and the composite item having an ID of “CompItemID-2”. Thus, one stand-alone item may correspond to two or more composite items.

The price information store section 103 stores an item price information table 103A of FIG. 6(a), a category price information table 103B of FIG. 6(b), and a composite item price information table 103C of FIG. 32. As shown in FIG. 32, the composite item price information table 103C stores composite item IDs and price information while making them in correspondence.

Operation of the whole of the network system in the fourth embodiment of this invention is similar to that in FIG. 11 regarding a relation among processing steps. The control section 110 starts recommendation information making operation at a prescribed timing as that in the first embodiment of this invention does. The recommendation information making operation in the fourth embodiment of this invention is similar to that in FIG. 14 except that a step S430 is modified as will be made clear below.

In a step S420 (FIG. 14), the degree of influence of each “j” of associated IDs on the base ID “i” is calculated, and the calculated influence degree is labeled as Y[j]. In the step S430 following the step S420, the information selecting section 107 receiving a command from the control section 110 calculates a selection index S[i][j] from the association degree W[i][j] and the price information degree Y[j] for each associated ID “j”.

In the step S430, the information selecting section 107 determines whether the associated ID “j” is of a stand-alone item or a composite item by referring to the item information table 101A and the composite item information table 101C in the item attribute store section 101. When the associated ID “j” is of a stand-alone item, the information selecting section 107 calculates the selection index S[i][j] in one of the methods in the first embodiment of this invention. On the other hand, when the associated ID “j” is of a composite item, the information selecting section 107 calculates a selection index for the associated ID “j” (the composite item) in one of below-mentioned methods.

A first method of calculating a selection index for a composite item is to calculate the selection index by using the greatest one of the association degrees of stand-alone items corresponding to the composite item. Specifically, the information selecting section 107 identifies stand-alone items “k” (k=1˜Nk) corresponding to the associated ID “j” while referring to the inter-item correspondence table 101D in FIG. 31(b). Here, Nk denotes the number of the identified stand-alone items. Then, the information selecting section 107 reads out the degree W[i][k] of association between the base item “i” and each identified stand-alone item “k” from the association degree table 105A in the association set store section 105.

When only one of the Nk identified stand-alone items is assigned an association degree W[i][k] in the association degree table 105A, the information selecting section 107 labels the association degree W[i][k] as Wh[i][j]. When two or more of the Nk identified stand-alone items are assigned association degrees W[i][k] in the association degree table 105A, the information selecting section 107 selects the greatest one Wmax[i] from the association degrees W[i][k]. The information selecting section 107 labels the greater one of the association degree W[i][j] and the association degree Wmax[i] as Wh[i][j]. Then, the information selecting section 107 calculates a selection index from the association degree Wh[i][j]. Specifically, the information selecting section 107 replaces W[i][j] in the equations (7)-(9) by Wh[i][j] and calculates a selection index according to the resultant equations (7)-(9). When none of the Nk identified stand-alone items is assigned an association degree W[i][k] in the association degree table 105A, the information selecting section 107 calculates a selection index in a way similar to that for a stand-alone item.

A second method of calculating a selection index for a composite item is to calculate the selection index by using the summation of the association degrees of stand-alone items corresponding to the composite item. Specifically, the information selecting section 107 identifies stand-alone items “k” (k=1˜Nk) corresponding to the associated ID “j” while referring to the inter-item correspondence table 101D in FIG. 31(b). Then, the information selecting section 107 reads out the degree W[i][k] of association between the base item “i” and each identified stand-alone item “k” from the association degree table 105A in the association set store section 105.

When only one of the Nk identified stand-alone items is assigned an association degree W[i][k] in the association degree table 105A, the information selecting section 107 labels the association degree W[i][k] as Ws[i][j]. When two or more of the Nk identified stand-alone items are assigned association degrees W[i][k] in the association degree table 105A, the information selecting section 107 calculates the summation Wsum[i] of the association degrees W[i][k]. The information selecting section 107 labels the greater one of the association degree W[i][j] and the summation Wsum[i] as Ws[i][j]. Then, the information selecting section 107 calculates a selection index from the association degree Ws[i][j]. Specifically, the information selecting section 107 replaces W[i][j] in the equations (7)-(9) by Ws[i][j] and calculates a selection index according to the resultant equations (7)-(9). When none of the Nk identified stand-alone items is assigned an association degree W[i][k] in the association degree table 105A, the information selecting section 107 calculates a selection index in a way similar to that for a stand-alone item.

A third method of calculating a selection index for a composite item uses a modification of one of the equations (7)-(9) employed in the calculation of a selection index for a stand-alone item. For example, the constant “βc” in the equation (7) is set greater than that for a stand-alone item. The constants “βa” and “βb” in the equation (8) may be set greater than those for a stand-alone item. The constants “βd” and “βe” in the equation (9) may be set greater than those for a stand-alone item.

According to the above-mentioned first, second, and third methods, a process for a stand-alone item and a process for a composite item are performed in the step S430. Different processes for a stand-alone item and a composite item respectively may be performed in another step or other steps.

For example, in the step S420, the information selecting section 107 may determine whether the associated ID “j” is of a stand-alone item or a composite item. In this case, the information selecting section 107 sets the characteristic of the function F(X) in accordance with the result of the determination. For example, the resultant characteristic of the function F(X) is designed so that an output value for a composite item with respect to an input value will be greater than that for a stand-alone item. In the later step S430, the same processes as those in the first embodiment of this invention are performed. A step S440 following the step S430 is the same as that in the first embodiment of this invention.

According to calculation of a selection index in one of the above-mentioned methods, a selection index for a composite item under a certain condition is greater than that for a stand-alone index. Even in the case where price information of a stand-alone item and price information of a composite item are the same while an association degree of the stand-alone item and an association degree of the composite item are the same, a selection index for the composite item will be greater than that for the stand-alone index.

Generally, price information of a composite item is greater in price value than that of a stand-alone item. Thus, in the case where an association degree of a composite item and an association degree of a stand-alone item are the same, selection indexes calculated in one of the methods in the first embodiment of this invention cause the composite item to be more easily contained in a recommendation result than the stand-alone item is. According to the fourth embodiment of this invention, a composite item can more preferentially be contained in recommendation information.

Use price information similar to that in the third embodiment of this invention may be calculated from information about previous use of stand-alone items and composite items by each user. According to a first example, the total value of the prices of stand-alone items used by the user is labeled as first use price information (a first price level value) while the total value of the prices of composite items used by the user is labeled as second use price information (a second price level value) different from the first use price information. According to a second example, a first value (representative value) representing the price per stand-alone item used by the user is calculated, and a second value (representative value) representing the price per composite item used by the user is calculated before the calculated first value is labeled as first use price information and the calculated second value is labeled as second use price information different from the first use price information. According to a third example, a first representative value of the total value of the prices of stand-alone items used by the user is calculated, and a second representative value of the total value of the prices of composite items used by the user is calculated before the calculated first representative value is labeled as first use price information and the calculated second representative value is labeled as second use price information different from the first use price information. The ratio of the total value of the prices of composite items used by the user to the total value of the prices of the composite items plus stand-alone items used by the user may be labeled as use price information (a price level value). Generally, price information of a composite item is greater in price value than that of a stand-alone item. Accordingly, the ratio of the number of composite items used by the user to the number of the composite items plus stand-alone items used by the user may be labeled as use price information (a price level value).

According to a fourth example, the first degree of variations (such as the dispersion value) in the prices of stand-alone items used by the user is calculated, and the second degree of variations (such as the dispersion value) in the prices of composite items used by the user is calculated before the calculated first degree is labeled as first use price information (a price dispersion value) and the calculated second degree is labeled as second use price information (a price dispersion value) different from the first use price information. According to a fifth example, the first degree of variations in the total values of the prices of stand-alone items used by the user for respective time intervals (such as months) is calculated, and the second degree of variations in the total values of the prices of composite items used by the user for the respective time intervals is calculated before the calculated first degree is labeled as first use price information (a price dispersion value) and the calculated second degree is labeled as second use price information (a price dispersion value) different from the first use price information. The ratio of the total value of the prices of composite items used by the user to the total value of the prices of the composite items plus stand-alone items used by the user may be calculated for every prescribed time interval, and the degree of variations in the calculated ratios for the respective time intervals may be calculated before the calculated degree will be labeled as use price information (a price level value). The ratio of the total value of the prices of composite items used by the user to the total value of the prices of the composite items plus stand-alone items used by the user may be calculated for every purchase, and the degree of variations in the calculated ratios for the respective purchases may be calculated before the calculated degree will be labeled as use price information (a price level value). The ratio of the number of composite items used by the user to the number of the composite items plus stand-alone items used by the user may be calculated for every prescribed time interval, and the degree of variations in the calculated ratios for the respective time intervals may be calculated before the calculated degree will be labeled as use price information (a price level value). The ratio of the number of composite items used by the user to the number of the composite items plus stand-alone items used by the user may be calculated for every purchase, and the degree of variations in the calculated ratios for the respective purchases may be calculated before the calculated degree will be labeled as use price information (a price level value).

The characteristic of the price influence function F(x) can be varied depending on the above-mentioned use price information in a method similar to one of the methods in the third embodiment of this invention. For example, the function Fu(X) in FIG. 29(a) is adopted. The parameter Xc of the function Fu(X) is set greater as the price level value is greater. The parameter Xω of the function Fu(X) is set greater as the price dispersion value is greater. The parameter Yα of the function Fu(X) is set greater as the price level value is greater. The parameter Yω of the function Fu(X) is set greater as the price level value is greater.

The fourth embodiment of this invention may be combined with the third embodiment thereof so that the degree to which composite items are contained in a recommendation result will be adjusted in response to use price information of the user. For example, in each of the first and second methods of calculating a selection index for a composite item, an association degree corresponding to the composite item is further multiplied by a coefficient greater than 1. Thereby, the coefficient in question for a user corresponding to a large price level value is greater than that for a user corresponding to a small price level value. Thus, more composite items are contained in a recommendation result for a user corresponding to a greater price level value.

In the third method of calculating a selection index for a composite item, the constant “βc” in the equation (7) may be varied in accordance with use price information. For example, the constant “βc” for a user corresponding to a large price level value is greater than that for a user corresponding to a small price level value.

Since a user can use a composite item by one-time use operation with reference to recommendation information, convenience to the user can be improved as compared with the case where use of the composite item requires use operation to be done a plurality of times. Generally, the price of a composite item is relatively high. Thus, the sales of the item providing service can be raised by increasing the rate of use of composite items.

What is claimed is:

1. An information selecting apparatus comprising:
a price information store section storing identifiers and price information while making the identifiers and the price information in correspondence, the identifiers being of items or categories assigned to the respective items, the price information being about the items or the categories;
an association set store section storing identifiers of items or categories associated with a base identifier which is a base item or a base category together with association degrees representing strengths of association with the base item or the base category;
a price influence degree calculating section obtaining price information of each of identifiers associated with the base identifier from the price information store section, and calculating a price influence degree of each of the identifiers associated with the base identifier from the obtained price information through the use of a price influence function monotonically increasing in at least a partial interval and having no monotonically decreasing interval; and
an information selecting section calculating a selection index of each of the identifiers associated with the base identifier according to a rule such that the calculated selection index will increase as the association degree is greater and the price influence degree is greater, and preferentially selecting identifiers with great values in calculated selection index from the identifiers associated with the base identifier.

2. An information selecting apparatus as recited in claim 1, further comprising a use price information calculating section calculating, for each of use subject identifiers of users or terminal devices used by the users, use price information based on price information of items provided to the user relating to the use subject identifier, the price influence degree calculating section varying the price influence function in accordance with use price information of a use subject identifier in calculating the price influence degree, wherein the information selecting section selects identifiers with respect to said use subject identifier by using the calculated price influence degree.

3. An information selecting apparatus as recited in claim 2, wherein the use price information calculating section calculates a price level value as the use price information, the price level value being a value using a sum value of prices of items provided to a user relating to the use subject identifier or a representative value of the prices of items provided to the user relating to the use subject identifier, and wherein the price influence degree calculating section varies the price influence function in a manner such that a difference between a maximum output value and a minimum output value or a magnification of the maximum output value relative to the minimum output value will increase as the price level value is greater.

4. An information selecting apparatus as recited in claim 2, wherein the use price information calculating section calculates a price level value as the use price information, the price level value being a value using a sum value of prices of items provided to a user relating to the use subject identifier or a representative value of the prices of items provided to the user relating to the use subject identifier, and wherein the price influence degree calculating section varies the price influence function in a manner such that an input value to obtain a prescribed output value will increase as the price level value is greater.

5. An information selecting apparatus as recited in claim 2, wherein the use price information calculating section calculates a price level value as the use price information, the price level value being a value using a sum value of prices of items provided to a user relating to the use subject identifier or a representative value of the prices of items provided to the user relating to the use subject identifier, and wherein the price influence degree calculating section varies the price influence function in a manner such that an output value for a minimum input value will decrease as the price level value is greater.

6. An information selecting apparatus as recited in claim 2, wherein the use price information calculating section calculates a price dispersion value as the use price information, the price dispersion value representing a degree of variations in prices of items provided to a user relating to the use subject identifier or a sum value of the prices of items provided to the user relating to the use subject identifier, and wherein the price influence degree calculating section varies the price influence function in a manner such that a width of the interval of the monotonic increase will increase as the price dispersion value is greater, a manner such that a difference between a maximum output value and a minimum output value will increase as the price dispersion value is greater, a manner such that a magnification of the maximum output value relative to the minimum output value will increase as the price dispersion value is greater, or a manner such that an input value to obtain a prescribed output value will increase as the price dispersion value is greater.

7. An information selecting apparatus as recited in claim 2, wherein the use price information calculating section calculates the use price information on the basis of prices of items provided to a user relating to the use subject identifier and prices of items provided to a user or users relating to a use subject identifier or identifiers different from said use subject identifier.

8. An information selecting apparatus as recited in claim 2, further comprising an item class information store section storing the identifiers of the items or the categories and item classes while making the identifiers and the item classes in correspondence, wherein the use price information calculating section calculates the use price information for each of the item classes with respect to each of the use subject identifiers, and wherein the price influence degree calculating section identifies an item class corresponding to one of the identifiers associated with the base identifier by referring to the item class information store section and varies the price influence function in accordance with use price information calculated for the identified item class with respect to the use subject identifier relating to the base identifier.

9. An information selecting apparatus as recited in claim 1, wherein the price information store section stores identifiers of normal items, identifiers of composite items, price information of the normal items, and price information of the composite items in correspondence, and each of the composite items consists of plural normal items, and wherein the information selecting section calculates the selection index so that the calculated selection index will be greater for a composite item than a normal item even in cases where the composite item and the normal item are equal in degree of association with the base identifier and price information of the composite item and price information of the normal item are equal.

10. An information selecting apparatus as recited in claim 1, wherein the information selecting section selects, from the identifiers associated with the base identifier, identifiers corresponding to selection indexes equal to or greater than a first prescribed value or selects, from the identifiers associated with the base identifier, a number of identifiers in order of selection index from the greatest, said number being equal to or less than a second prescribed value, and outputs information about the selected identifiers in addition to information about the order of selection index.

11. An information selecting apparatus as recited in claim 1, further comprising:
a use history store section storing use histories which record, for each of use subject identifiers of users or terminal devices used by the users, identifiers of items provided to a user relating to the use subject identifier or categories of the items provided to the user relating to the use subject identifier; and
an association degree calculating section calculating a degree of association between the base identifier and each of other identifiers on the basis of the use histories, extracting identifiers corresponding to calculated association degrees equal to or greater than a third prescribed value or a number of identifiers in order of calculated association degree from the greatest, said number being equal to or less than a fourth prescribed value, and labeling the extracted identifiers as the identifiers associated with the base identifier.

12. An information selecting apparatus as recited in claim 1, further comprising:
an attribute information store section storing attribute information in which the identifiers of the items or the categories and attributes of the items or the categories are made in correspondence; and
an association degree calculating section calculating a degree of association between the base identifier and each of other identifiers on the basis of the attribute information, extracting identifiers corresponding to calculated association degrees equal to or greater than a fifth prescribed value or a number of identifiers in order of calculated association degree from the greatest, said number being equal to or less than a sixth prescribed value, and labeling the extracted identifiers as the identifiers associated with the base identifier.

13. An information selecting apparatus as recited in claim 1, further comprising a receiving section receiving control data concerning a price condition from an external, wherein the price influence degree calculating section varies the price influence function in response to the received control data.

14. An information selecting apparatus as recited in claim 1, wherein the price influence degree calculating section varies the price influence function in response to the price information of the base identifier.

15. A method of selecting information, comprising the steps of:
storing identifiers and price information while making the identifiers and the price information in correspondence, the identifiers being of items or categories assigned to the respective items, the price information being about the items or the categories;
storing identifiers of items or categories associated with a base identifier which is a base item or a base category together with association degrees representing strengths of association with the base item or the base category;
obtaining price information of each of identifiers associated with the base identifier from the price information store section, and calculating a price influence degree of each of the identifiers associated with the base identifier from the obtained price information through the use of a price influence function monotonically increasing in at least a partial interval and having no monotonically decreasing interval; and
calculating a selection index of each of the identifiers associated with the base identifier according to a rule such that the calculated selection index will increase as the association degree is greater and the price influence degree is greater, and preferentially selecting identifiers with great values in calculated selection index from the identifiers associated with the base identifier.

16. A method as recited in claim 15, further comprising the step of calculating, for each of use subject identifiers of users or terminal devices used by the users, use price information based on price information of items provided to the user relating to the use subject identifier, the price influence degree calculating step varying the price influence function in accordance with use price information of a use subject identifier in calculating the price influence degree, wherein the information selecting step selects identifiers with respect to said use subject identifier by using the calculated price influence degree.

17. A computer program for enabling a computer to function as:
a price information store section storing identifiers and price information while making the identifiers and the price information in correspondence, the identifiers being of items or categories assigned to the respective items, the price information being about the items or the categories;
an association set store section storing identifiers of items or categories associated with a base identifier which is a base item or a base category together with association degrees representing strengths of association with the base item or the base category;
a price influence degree calculating section obtaining price information of each of identifiers associated with the base identifier from the price information store section, and calculating a price influence degree of each of the identifiers associated with the base identifier from the obtained price information through the use of a price influence function monotonically increasing in at least a partial interval and having no monotonically decreasing interval; and
an information selecting section calculating a selection index of each of the identifiers associated with the base identifier according to a rule such that the calculated selection index will increase as the association degree is greater and the price influence degree is greater, and preferentially selecting identifiers with great values in calculated selection index from the identifiers associated with the base identifier.

18. A computer program as recited in claim 17, which enables the computer to further function as a use price information calculating section calculating, for each of use subject identifiers of users or terminal devices used by the users, use price information based on price information of items provided to the user relating to the use subject identifier, the price influence degree calculating section varying the price influence function in accordance with use price information of a use subject identifier in calculating the price influence degree, wherein the information selecting section selects identifiers with respect to said use subject identifier by using the calculated price influence degree.
